(19) United States
(12) Patent Application Publication
(10) Pub. No.: US 2008/0095368 A1
(43) Pub. Date: Apr. 24, 2008

(54) SYMMETRIC KEY GENERATION APPARATUS AND SYMMETRIC KEY GENERATION METHOD

(75) Inventors: Takamitsu Iida, Kawasaki (JP); Hideshi Sakurai, Kawasaki (JP); Satoshi Obara, Kawasaki (JP); Yukihiro Nakajima, Kawasaki (JP); Takayuki Sakuma, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/741,051

(22) Filed: Apr. 27, 2007

(30) Foreign Application Priority Data
Oct. 20, 2006 (JP) 2006-285874

(51) Int. Cl. H04L 9/00

(52) U.S. Cl. 380/259; 380/44

(57) ABSTRACT

Asymmetric key generation apparatus generates asymmetric key based on a different key material for each piece of data. The symmetric key generation apparatus is configured to generate a symmetric key of a practically different value for a key material of a different value. An encrypted piece of data has a part encrypted by a symmetric key and a part of a cleartext. The latter part includes a key material used by the symmetric key generation apparatus that uses it for generating a symmetric key.

### BACKGROUND OF THE INVENTION

1. Field of the Invention

The present invention relates to an apparatus and method for generating a symmetric key used for a symmetric key cryptographic system.

2. Description of the Related Art

A cryptographic system includes a symmetric key cryptographic system (also called as a secret key cryptographic system or a common key cryptographic system) using the same key for encryption and decryption, and a public key cryptographic system using different keys for encryption and decryption. Comparing with the public key cryptographic system, the symmetric key cryptographic system has an advantage of carrying out encryption and decryption in higher speed, and therefore it is used for various purposes. Representative standard of the symmetric key cryptographic system includes the Data Encryption Standard (DES) and Advanced Encryption Standard (AES). Note that the following description calls a symmetric key summarily for an encryption key and a decryption key used for the symmetric key cryptographic system.

For the symmetric key cryptographic system, maintaining secrecy of a symmetric key from a third party is very important because a leakage of a symmetric key to the third party brings forth a high risk of a ciphertext being broken. Specifically, the viewpoints as noted in the following paragraphs (1) and (2) must be considered:

(1) Before starting an encrypted communication, a transmitter and a recipient of a message (that is, an encrypting party and a decrypting party) need to share a symmetric key. A method for sharing a symmetric key includes a method, for example, for the transmitter of a message to generate a symmetric key and transmit it to the recipient by way of a telecommunication path. In this case, however, arising is a problem of how the symmetric key can be transmitted without a third party every knowing a content of the symmetric key.

(2) A repetition of a number of encrypted communications by using a single symmetric key increases a risk of a third party intercepting cipher texts to guess the symmetric key and resulting in the cipher texts sent there after being broken. It is necessary to devise so as to be difficult to guess the symmetric key even if the cipher texts are intercepted.

Various methods have been proposed for addressing the problems as noted in the above paragraphs (1) and (2), with some being actually put to use.

As an example, a cryptography apparatus noted in a patent document 1 prevents a regular pattern from appearing periodically in a ciphertext in order to reduce the risk as described in the above paragraph (2). Specifically, when encrypting a super frame constituted by a plurality of frames, a frame synchronization pattern is detected, thereby counting a frame number(s) within the super frame and each frame is encrypted by a cryptographic key which is different for each frame number. Then, the entirety of the super frame, except for a super frame synchronization pattern, is encrypted by using yet a different cryptographic key. By the configuration as described above, the cryptography apparatus noted in the patent document 1 prevents a regular pattern from appearing in a ciphertext in a frame cycle otherwise due to the frame synchronization pattern being encrypted by the same cryptographic key.

Alternatively, it is possible to reduce a risk noted in the above paragraph (2) by updating a symmetric key at every passage of a certain time. However, the problem of the above paragraph (1) arises again when sharing a new updated symmetric key between the transmitter and recipient.

If an encrypted communication is carried out between a specific pair of transmitter and recipient, the transmitter generates a symmetric key, writes a content thereof on a piece of paper and hands it to the recipient, thereby possibly solving the problem of the above paragraph (1). The method, however, has a shortfall of not being adequate in the case of carrying out an encrypted communication with many correspondents and of requiring a cumbersome work at every time of updating a symmetric key.

If a subject of encryption is an Internet Protocol (IP) packet, it is possible to solve the problems of both of the above paragraphs (1) and (2) by means of a Security Architecture for Internet protocol (IPsec) as noted in a non-patent document 1. The IPsec is a standard for encrypting an IP packet, adopting the symmetric key cryptographic system. The IPsec is a group of a plurality of protocols and encryption algorithms, one of which is Internet Key Exchange (IKE) of a key exchange protocol.

The IKE enables a transmitter and a recipient to exchange information required for generating a symmetric key safely (that is, without a third party ever knowing a content) by way of a telecommunication path and solve the problem of the above paragraph (1) without a need of a cumbersome manual operation. Updating a symmetric key is called a “rekey”. Carrying out a rekey automatically by using the IKE at every certain time period (or at every time a telecommunication volume exceeds a predefined number of bytes) makes it possible to solve the problem of the above paragraph (2).

However, there are problems with such a system of exchanging keys automatically and dynamically, as noted in the following paragraphs (3) through (5):

(3) An encrypted communication cannot be carried out in the midst of performing a rekey.

(4) The IKE is a relatively complex system, requiring complex implementation of an apparatus such as a router, and therefore a failure tends to occur when exchanging keys.

(5) If a failure occurs in either of the apparatuses of the transmitter or recipient, the step of sharing a symmetric key must be re-performed all over again. A failure may occur in the other apparatus in the course of a key exchange process required for the above step due to the reason noted in the above paragraph (4).

Meanwhile, there is a problem with the symmetric key cryptographic system as noted in the paragraph (6) below:

(6) A different symmetric key is required for each pair of the transmitter and recipient. That is, a symmetric key k_{AB} used between an A and a B must be different from a symmetric key k_{AC} used between the A and a C. If the k_{AB} is the same as the k_{AC}, an encrypted communication between the A and B is broken by the C, thus unable to keep secret. Therefore, in the case of carrying out encrypted communications in the relationship of N to N, the respective apparatuses need to manage a different symmetric key for each correspondent.

Such a configuration for managing a plurality of symmetric keys is found in a patent document 2 for example. The patent document 2 has disclosed a technique for encrypting an Ethernet frame transmitted to a downlink direction in a Passive Optical Network (PON) system.

The downlink direction is one from a parent station to a child station. In the system according to the patent document 2, child stations, that is, a plurality of Optical Network Terminals (ONT), is connected to a parent station, that is, an Optical Line Terminal (OLT), with a plurality of terminals (i.e., personal computers and the like) being connected to each ONT. The OLT retains a different cryptographic key for each ONT. An Ethernet frame of the downlink direction is broadcast from one OLT to a plurality of ONTs connected to the OLT in which event the OLT discerns as to which ONT the terminal of a destination address of the frame is connected to, and encrypts the Ethernet frame by using a cryptographic key corresponding to the discerned ONT. Therefore, even if another ONT receives the Ethernet frame, it cannot decrypt the frame and therefore it cannot know the content.

The problem of the above paragraph (6) is not merely the number of symmetric keys to be managed being large. In order to reduce a risk of the above paragraph (2) for example, it is desirable to perform a rekey at every certain time period for each of the large number of symmetric keys; however, the problems of the above paragraphs (3) through (5) becomes more serious with the number of symmetric keys. That is, there is a limitation in scalability.

Note that the A, B and C in the description for the above paragraph (6) are commonly relay apparatuses in a network, instead of being individual terminals. In the case of encrypting an IP packet by means of the IPsec for example, it is a relay apparatus in the network layer such as a router that carries out encryption. Accurately speaking, therefore, the above paragraph (6) means that a different symmetric key is required for each pair of routers.

In the case of carrying out an encrypted communication by means of the IPsec for example in the network configured as shown in FIG. 1, the routers 8a and 8b store respective symmetric keys kd and an IP packet is transmitted in a state of being encrypted by the symmetric key kd in the network 3b between the routers 8a and 8b. Referring to FIG. 1, the personal computers (PCs) 4a through 4c are connected to the router 8a by way of the network 3a, and the PCs 4d through 4f are connected to the router 8b by way of the network 3c.

Here, in the case of transmitting an IP packet 250a from the PC 4a to PC 4d, transmitting an IP packet 250b from the PC 4b to PC 4e, and transmitting an IP packet 250c from the PC 4c to PC 4f, all of the three IP packets 250a through 250c of which the transmission sources and destinations are all different are respectively changed to encrypted IP packets 260a through 260c by being encrypted by using the same symmetric key kd, followed by becoming decrypted IP packets 280a through 280c by being decrypted by using the same symmetric key kd. That is, the symmetric key kd is determined uniquely for a pair of the routers 8a and 8b and therefore the same symmetric key kd is always used independent of a combination of PCs at the source and destination. In summary, the granularity of encryption is coarse as compared to the case of encrypting by using a different symmetric key for each combination of PCs at the source and destination.

Patent document 1: Laid-Open Japanese Utility Patent Application Publication No. H05-85140

Non-patent document 1: RFC4301 Security Architecture for the Internet Protocol;

http://www.ietf.org/rfc/rfc4301.txt (Confirmed through access on Oct. 6, 2006)

Patent document 2: Laid-Open Japanese Patent Application Publication No. 2003-60633

From the considerations as described above, the following is a summary of general inclination related to the symmetric key cryptographic system. In the case of setting a symmetric key manually and using the same symmetric key for an extended period of time (i.e., a symmetric key is fixedly used), a system is relatively simple and a security of encryption is low. Contrarily, in the case of carrying out a rekey automatically and dynamically, by using the IKE and such, a complex system is required with a possibility of a problem arising due to the complexity, and yet a security of encryption is high.

However, a method for making both of the complexity of system and security of encryption maintained at a middle level is appropriate depending on the purpose of carrying out an encrypted communication and the usage.

Meanwhile, as for the problem of the above paragraph (6), an elimination of a necessity of managing symmetric keys equivalent to the number of correspondents being engaged in the encrypted communications makes it possible to expand the application range of the symmetric key cryptographic system.

### SUMMARY OF THE INVENTION

A purpose of the present invention is to provide a symmetric key generation apparatus which generates a symmetric key used for a symmetric key cryptographic system and which is capable of maintaining a degree of security of a encryption to an intermediate level by employing a relatively simple configuration of the apparatus while eliminating a need to manage the number of cryptographic keys equivalent to the number of correspondents of encrypted communications. Another purpose is to provide a symmetric key generation method by using such a symmetric key generation apparatus.

A symmetric key generation apparatus according to the present invention is one generating a symmetric key used for a symmetric key cryptographic system, comprising: a reception unit for receiving input data having a header part in a state of a cleartext and a payload part; a key material storage unit for storing a key material; a key material readout unit for reading the key material from the key material storage unit and updating the key material stored in the key material storage unit in a first stage of generating the symmetric key for encrypting the input data, and reading the key material from a predetermined part of the header part in a second stage of generating the symmetric key for decrypting the input data; and a symmetric key generation unit for generating the symmetric key based on the key material read by the key material readout unit.

A symmetric key generation method according to the present invention is a method carried out by the above noted symmetric key generation apparatus.

A utilization of the symmetric key generation apparatuses by comprising the one on both of an encryption side and of a decryption side of a telecommunication path enables both of the encryption and decryption sides to respectively generate symmetric keys of the same value without exchanging a key by means of a key exchange protocol. That is, if the encryption side generates data including a key material in a predetermined part of a header part, a symmetric key generation apparatus comprised on the decryption side generates a symmetric key of the same value as one used for the encryption by the operation in the above noted second stage. The symmetric key generation apparatus comprised on the encryption side is also configured to generate a symmetric key by the operation in the above noted first stage, thereby generating a symmetric key based on a key material of which a value is updated for each encryption, that is, for each piece of input data.

A configuration of the symmetric key generation unit so appropriately that a value of a symmetric key is practically different for a different value of a key material makes it possible to generate a practically different key for every event of encryption. Also configured is that the symmetric key generation apparatuses respectively comprised on the encryption and decryption sides on a telecommunication path generate the same symmetric key. Therefore, the present invention enables an apparatus on the encryption side and one on the decryption side to respectively carry out encryption and decryption of data by using a different key practically for each piece of input data without carrying out a rekey by exchanging a key in accordance with a key exchange protocol, thereby also making it possible to reduce a risk of a cipher being broken.

### BRIEF DESCRIPTION OF THE DRAWINGS

FIG. 1 is an illustration diagram showing a conventional encrypted communication by utilizing IPsec;

FIG. 2 is an illustration diagram showing an encrypted communication carried out in a network including a relay apparatus comprising a symmetric key generation apparatus;

FIG. 3 is a diagram exemplifying a combination between a source and a destination;

FIG. 4 is a diagram showing information used for generating a symmetric key;

FIG. 5 is a fundamental functional block diagram of a symmetric key generation apparatus;

FIG. 6 is an illustration diagram showing an encrypted communication carried out in a network including a relay apparatus comprising a symmetric key generation apparatus;

FIG. 7 is a configuration diagram of a Layer 2 relay apparatus applied by the present invention;

FIG. 8 is a functional block diagram describing a relationship between FIGS. 7 and 5;

FIG. 9 is a diagram exemplifying a modification of FIG. 7;

FIG. 10A is a diagram exemplifying a utilization of a Layer 2 relay apparatus including a symmetric key generation apparatus;

FIG. 10B is a diagram showing the apparatus in detail by excerpting a part of FIG. 10A and also a flow of a frame;

FIG. 11 is a diagram describing a format of a frame;

FIG. 12 is a diagram showing a cryptographic header in detail;

FIG. 13 is a diagram exemplifying a configuration of a network by using a Layer 2 relay apparatus equipped with a symmetric key generation apparatus;

FIG. 14 is a diagram exemplifying a configuration of a network by using a Layer 2 relay apparatus equipped with a symmetric key generation apparatus;

FIG. 15 is a diagram exemplifying a configuration of a network by using a Layer 2 relay apparatus equipped with a symmetric key generation apparatus;

FIG. 16 is a diagram showing a more specific example of various pieces of information shown in FIG. 4;

FIG. 17 is a diagram describing a method for generating a symmetric key by utilizing an array;

FIG. 18 is a diagram describing a format of a cryptographic header for implementing a division and reassembly of a frame;

FIG. 19 is a diagram showing an encrypted communication carried out in a network including a relay apparatus comprising a symmetric key generation apparatus and a format of an IP packet;

FIG. 20 is a configuration diagram of a router applied by the present invention;

FIG. 21 is a functional block diagram describing a relationship between FIGS. 20 and 5;

FIG. 22 is a diagram describing an operation of an IPsec process unit when an unencrypted IP packet is received;

FIG. 23 is a diagram describing an operation of an IPsec process unit when an encrypted IP packet is received;

FIG. 24 is a diagram showing a format of an IP header;

FIG. 25 is a diagram showing a format of an ESP packet;

FIG. 26 is a diagram describing a generation of a master key;

FIG. 27A is a diagram describing a correlation of FIGS. 24 through 26 with each piece of information shown in FIG. 4 in a transport mode;

FIG. 27B is a diagram describing a correlation of FIGS. 24 through 26 with each piece of information shown in FIG. 4 in a tunnel mode; and

FIG. 28 is a diagram showing an example of utilizing a router comprising a symmetric key generation apparatus for a multicast.

### DESCRIPTION OF THE PREFERRED EMBODIMENTS

The following is a detailed description of the preferred embodiment of the present invention by referring to the accompanying drawings. Note that the same component number or number with a different affix character is assigned to the materially same component and its description is omitted herein.

A symmetric key generation apparatus of the present invention is used for generating a symmetric key for both encrypting data and decrypting data. Accordingly, an example of a preferred embodiment is one in which the symmetric key generation apparatus according to the present invention is incorporated as a part of a relay apparatus in a network, and the following is mainly a description of such a preferred embodiment.

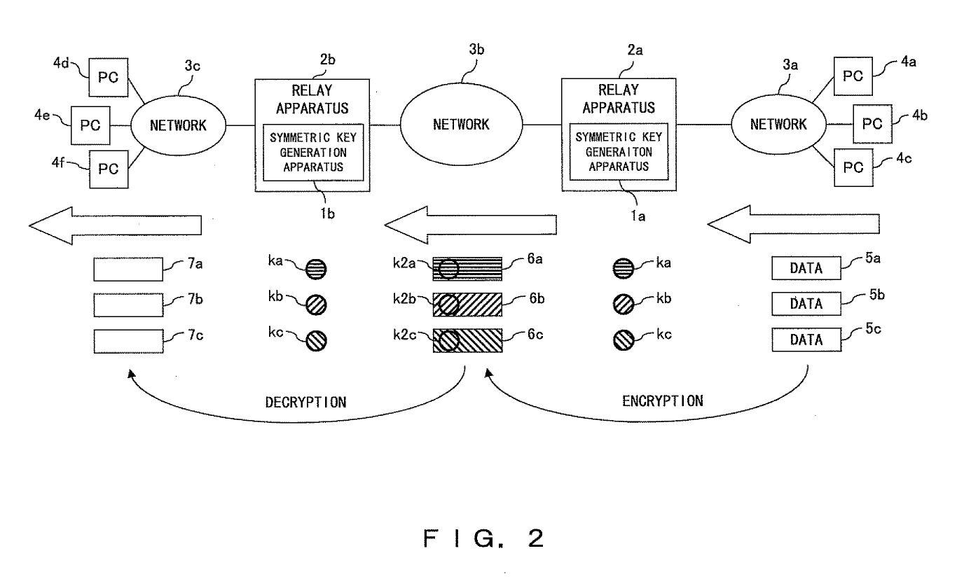

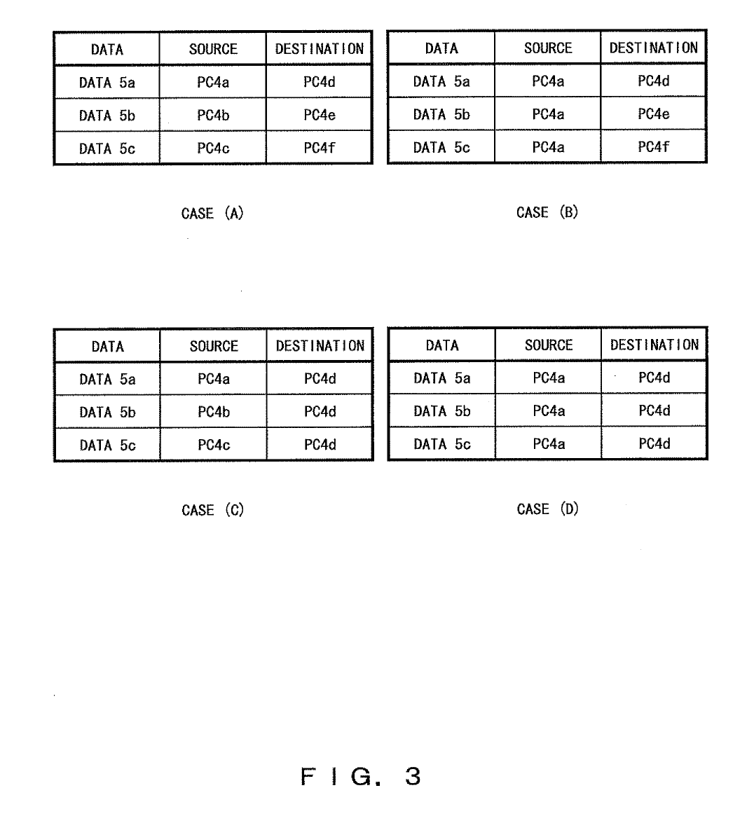

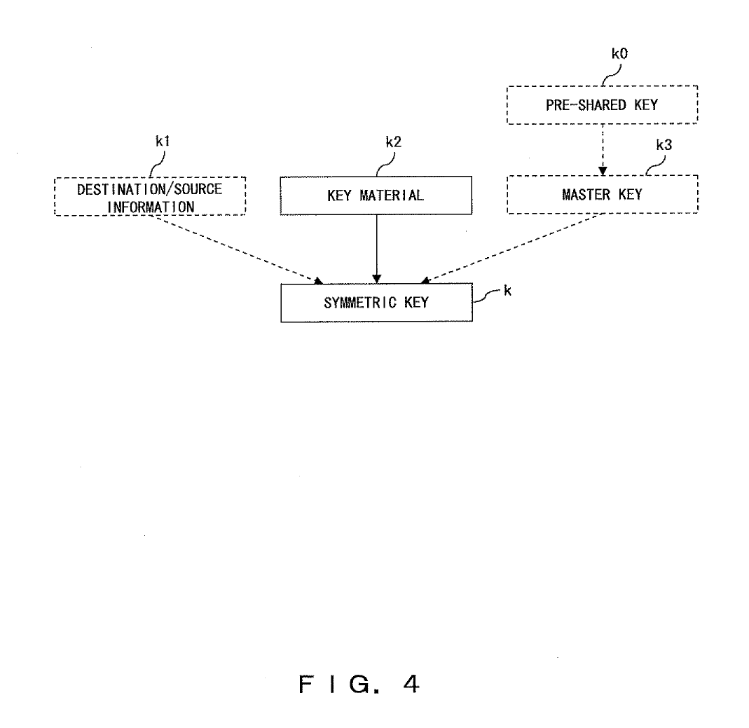

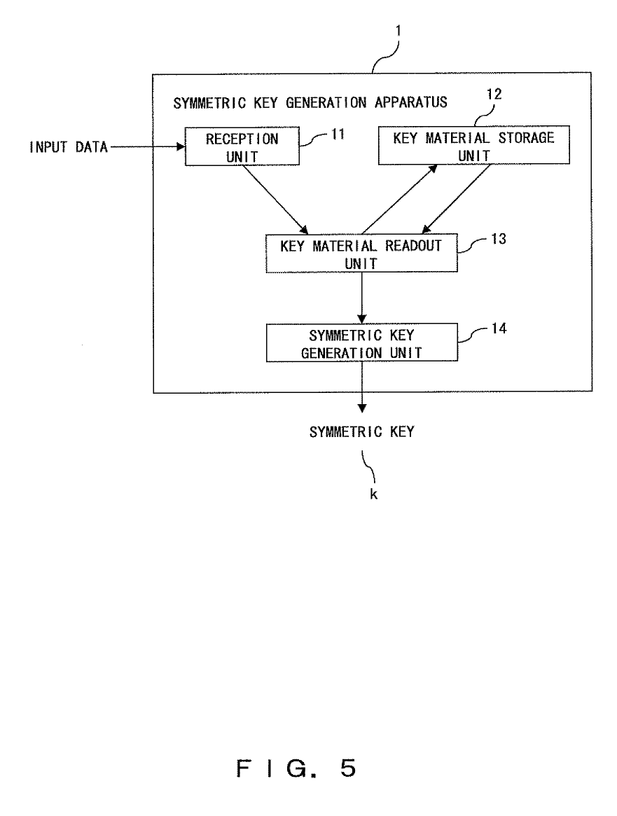

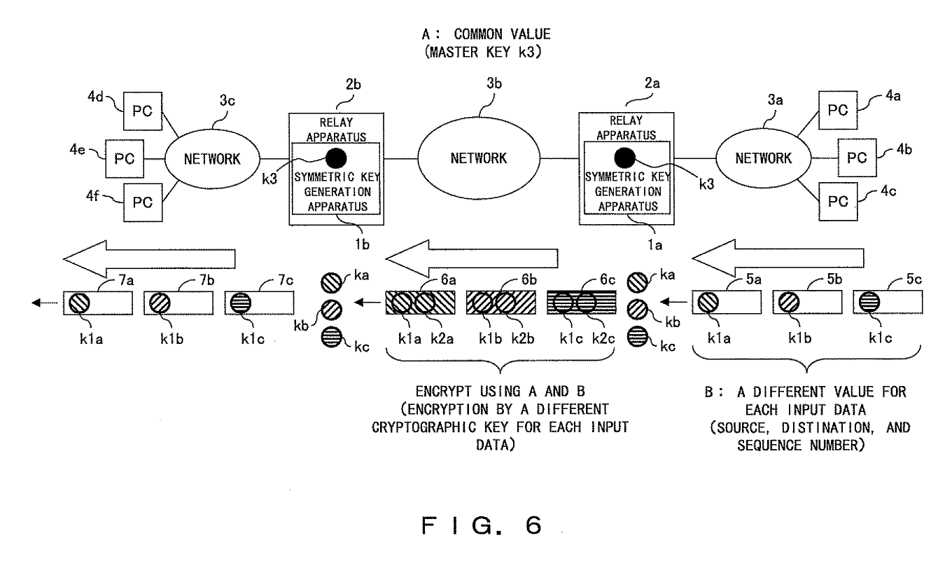

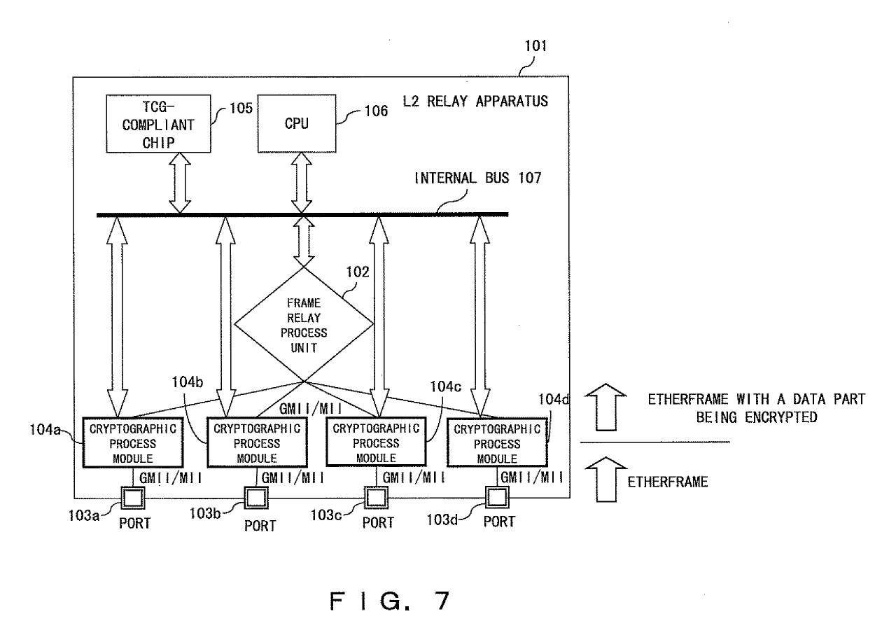

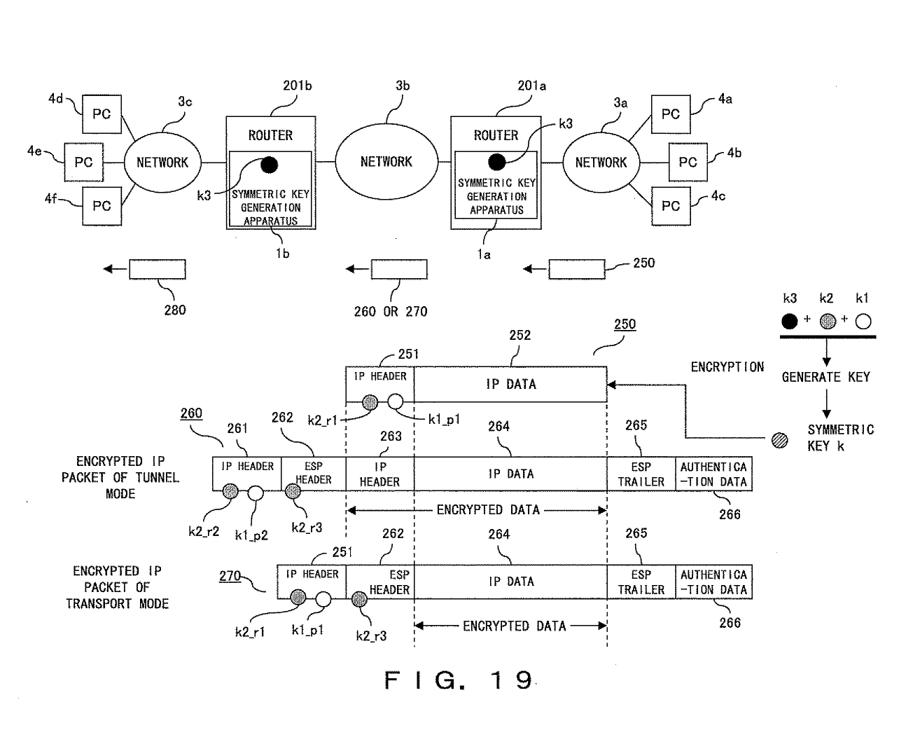

The first is a general description on a preferred embodiment in which the symmetric key generation apparatus according to the present invention is incorporated as a part of a relay apparatus in a network, by referring to FIGS. 2 and 3. Then described is information utilized for generating a symmetric key by the symmetric key generation apparatus according to the present invention by referring to FIG. 4, followed by describing a fundamental comprisal of the symmetric key generation apparatus by referring to FIG. 5 and describing a more preferred embodiment of FIG. 2 by referring to FIG. 6. Then, descriptions continue on a preferred embodiment in which the symmetric key generation apparatus according to the present invention is incorporated as a part of a relay apparatus for a data link layer (also named as “Layer 2”) in an OSI (Open Systems Interconnection) reference model by referring to FIGS. 7 through 18. Then, descriptions further continue on preferred embodiments in which the symmetric key generation apparatus according to the present invention is incorporated as a part of a relay apparatus for a network layer (also named as “Layer 3”) in the OSI reference model by referring to FIGS. 19 through 27B.

FIG. 2 is an illustration diagram showing an encrypted communication carried out in a network including a relay apparatus comprising a symmetric key generation apparatus according to the present invention.

Referring to FIG. 2, the relay apparatuses 2a and 2b, respectively comprising symmetric key generation apparatuses 1a and 1b, are connected to each other by way of a network 3b. Personal computers (PC) 4a through 4c are connected to the relay apparatus 2a by way of a network 3a, while PCs 4d through 4f are connected to the relay apparatus 2b by way of the network 3c. When sending data from the PC 4a to PC 4d for example, the data is led through the telecommunication path including the PC 4a, relay apparatus 2a, relay apparatus 2b and PC 4d.

While leaving a detail to a later description, the relay apparatuses 2a and 2b may be Layer 2 relay apparatuses or Layer 3 relay apparatuses. If they are the former, transmitted data (i.e., 5a through 5c, 6a through 6c, and 7a through 7c) is a MAC (Media Access Control) frame for example; and if they are the latter, transmitted data is an IP packet for example.

In the configuration of FIG. 2, when the data 5a is transmitted from a PC (either of 4a through 4c) of a transmission origin (named as “source” hereinafter) by way of the relay apparatus 2a, the symmetric key generation apparatus 1a comprised thereby generates a symmetric key ka based on a key material k2a. Then the data 5a is changed to encrypted data 6a by being encrypted by the symmetric key ka. While leaving a detail to a later description, the encrypted data 6a is constituted by a part encrypted by the symmetric key ka and by a cleartext part which includes the key material k2a. The encrypted data 6a is received at the relay apparatus 2b by way of the network 3b. After the reception, the symmetric key generation apparatus 1b comprised in the relay apparatus 2b generates a symmetric key ka based on the key material k2a. The symmetric key generation apparatuses 1a and 1b respectively generate symmetric keys by the same algorithm and therefore respectively generate the same symmetric key ka from the same key material k2a. Then the encrypted data 6a is changed to decrypted data 7a by being decrypted by the symmetric key ka and is transmitted to a PC (either of 4d through 4f) of a transmission destination (named as “destination” hereinafter).

Likewise, the data 5b is changed to encrypted data 6b (including a key material k2b) by being encrypted by a symmetric key kb generated based on the key material k2b, and the encrypted data 6b is then changed to decrypted data 7b by being decrypted by the symmetric key kb. Also, the data 5c is likewise changed to encrypted data 6c (including a key material k2c) by being encrypted by a symmetric key kc generated based on the key material k2c, and encrypted data 6c is then changed to decrypted data 7c by being decrypted by the symmetric key kc.

Here, the key materials k2a through k2c have mutually different values. That is, the key materials k2a through k2c of different values are used for each of the data 5a through 5c. And the symmetric key generation apparatuses 1a and 1b are so configured as to respectively generate symmetric keys ka through kc of different values from the key materials k2a through k2c of different values (the detail is described later). Accurately speaking, the configuration may be adequate to lower a ratio of generating a symmetric key of the same value from two key materials of different values to a negligible degree of not ill influencing an actual operation (that is, a theoretical possibility of generating symmetric keys of the same value from two key materials of different values is permissible). Such configuring the symmetric key generation apparatuses 1a and 1b practically makes the symmetric keys ka through kc mutually different values.

Note that the symmetric key generation apparatuses 1a and 1b respectively generate symmetric keys from a key material by the same algorithm. Provided that the algorithm is kept as secret from a third party, it is impossible for the third party to generate symmetric keys ka through kc from key materials k2a through k2c included in the encrypted data 6a through 6c even if the third party intercepts them. Alternatively, the symmetric key generation apparatuses 1a and 1b may share information secret to a third party in advance, followed by generating symmetric keys ka through kc based on both of the information and key materials k2a through k2c. This configuration prevents the third party from breaking encrypted data 6a through 6c by generating symmetric keys ka through kc from the key materials k2a through k2c.

In any event, the symmetric keys ka through kc are practically different values from one another. In other words, a symmetric key used for encryption is changed quite frequently in the telecommunication path between the relay apparatuses 2a and 2b. The fact of a high frequency of changing symmetric keys in the symmetric key cryptographic system contributes to an improvement of a security level. The system described above also has an advantage of not requiring an exchange of information by means of a complex protocol such as an Internet Key Exchange (IKE) between the symmetric key generation apparatuses 1a and 1b. Moreover, the key materials k2a through k2c having different values for each piece of data 5a through 5c may be a simple counter value for example and it is not necessary to manage a symmetric key for each pair of a source and a destination engaged in an encrypted communication.

FIG. 2 indicates the fact of symmetric keys ka through kc having mutually different values by changing orientations of hatching lines of the symmetric keys ka through kc. It also indicates the fact of the encrypted data 6a through 6d being encrypted by mutually different keys by changing orientations of hatching lines of the encrypted data 6a through 6c.

Also, the data 5a through 5c may be transmitted from either of the PCs 4a through 4c and transmitted to either of the PCs 4d through 4f. As shown in FIG. 3 for example, the sources and destinations of the data 5a through 5c may entirely be different (i.e., the case (A)), or it may be such that all of the sources may be the same and the destination may all be different (i.e., the case (B)); or that all of the sources may be different and all of the destinations are the same (i.e., the case (C)), or that all of the sources and destinations are the same (i.e., the case (D)).

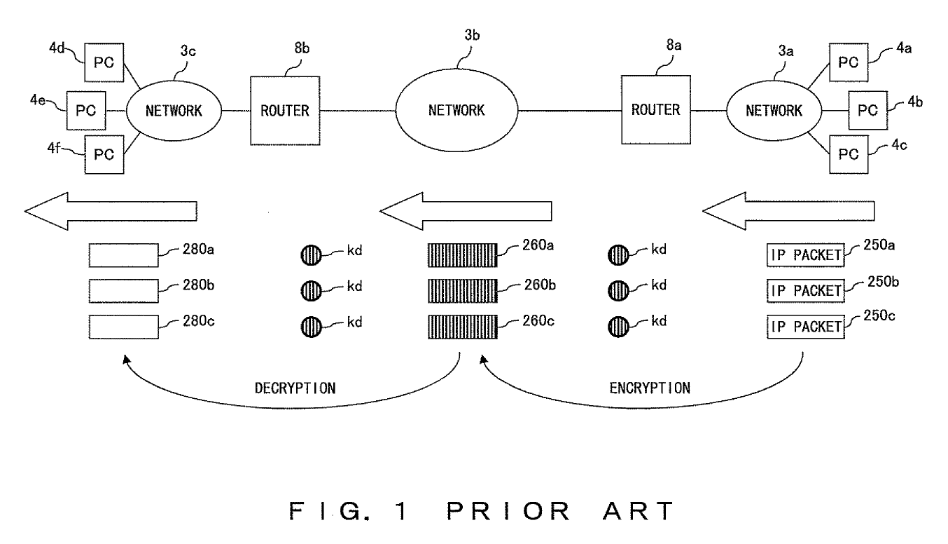

In either of the cases (A) through (D), the symmetric keys ka, kb and kc are of mutually different values and both of the symmetric key generation apparatuses 1a and 1b respectively generate symmetric keys of the same value. This is a characteristic of the present invention, which is totally different from the encrypted communication (refer to FIG. 1) by using a conventional IPsec for example. In FIG. 1, asymmetric key kd is fixed for a pair of routers 8a and 8b, and therefore a value of the symmetric key kd is not changed unless a rekey is carried out. Then, the same symmetric key kd is used for the encryption and decryption of three different IP packets 250a through 250c. This is also indicated in the drawing by hatching with the same pattern for all of the encrypted IP packets 260a through 260c.

FIG. 4 is a diagram showing information used by the symmetric key generation apparatus (equivalent to the symmetric key generation apparatuses 1a and 1b shown in FIG. 2) according to the present invention for generating a different symmetric key for each piece of data as described above. In the showing of FIG. 4, a solid line indicates a mandatory piece of information, and a dotted line indicates a utilization being not mandatory but preferable.

The symmetric key generation apparatus according to the present invention generates a symmetric key k for encryption and decryption. Mandatory information for generating a symmetric key k is a raw material of a key (noted as “key material” herein) k2. A key material generally means information required for generating a key; the key material k2 here is information meeting a specific condition, that is, “it is practically a different value for each piece of data as a subject of encryption”.

In a preferred embodiment for generating a symmetric key for encrypting a MAC frame for example, a sequence number having a different value for each MAC frame can be utilized as a key material k2. In a preferred embodiment for generating a symmetric key for encrypting an IP packet, a sequence number having a different value for each IP packet can be utilized as a key material k2. Details of these sequence numbers are described later.

As such, a generation of a symmetric key k based on a key material k2 of a practically different value for each piece of data as a subject of encryption makes the symmetric key k a practically different value for each piece of data as a subject of encryption.

Note that a bit length of a key material k2 is finite no matter what information is specifically used as the key material k2. Theoretically, therefore, the same key material k2 can possibly be utilized for different piece of data. A use of a key material k2 of an appropriate bit length can lower a frequency of a key material k2 of the same value being used for a different piece of data to a practically negligible degree without causing a problem. The following description regards as “a key material k2 is practically different value for each piece of data as a subject of encryption”.

A generation of a symmetric key k by using a key material k2 as described above increases a frequency of symmetric key k changing in great deal as compared to a conventional configuration of performing a rekey for every certain period of time by means of the IKE for example. As a result, a symmetric key k is very difficult to be guessed even if the encrypted data is intercepted by a third party.

In order to further increase cipher strength, a use of a master key k3 as well as destination/source information k1 is desirable. Especially desirable is a use of the destination/source information k1.

Here, the destination/source information k1 is information related to a destination and/or source of data (such as a MAC frame and IP packet) as a subject of encryption, and the information is a part or the entirety of addresses of the destination and/or source for example. The master key k3 is information that is preset within a symmetric key generation apparatus and is recorded within a security chip for example so as not to be leaked out or tampered with. A master key k3 may be generated in advance of a usage based on a pre-shared key k0 that is information set by a user of the symmetric key generation apparatus. The pre-shared key k3 is also recorded in the security chip as in the case of the master key k3.

The reason for the use of the destination/source information k1 and master key k3 in addition to the key material k2 being desirable for generating a symmetric key k is as follows:

In the case of utilizing a sequence number for example as a key material k2, generating a symmetric key k only from a key material k2 by certain generation algorithm creates a possibility of a regularity occurring in a plurality of symmetric keys k generated consecutively. Therefore, it is desirable to increase a randomness of the symmetric keys k by utilizing a destination/source information k1. A telecommunication in general is characterized to be irregular and difficult to predict as to when it occurs and who is engaged with whom. Therefore, the utilization of the irregularity of the destination/source information k1 is desirable for generating a symmetric key k. Also the use of the master key k3 which is information handled as a secret from a third party makes it possible to increase a difficulty of a symmetric key k being guessed.

FIG. 5 is a fundamental functional block diagram of a symmetric key generation apparatus according to the present invention. The symmetric key generation apparatus 1 shown in FIG. 5 comprises a reception unit 11, a key material storage unit 12, a key material readout unit 13 and a symmetric key generation unit 14. The symmetric key generation apparatus 1 generates a symmetric key k upon receiving a piece of input data.

Incidentally, a generation of a symmetric key k takes place in two stages, i.e., a stage (called as “first stage” hereinafter) of encrypting input data that is plain text data and in another stage (called as “second stage” hereinafter) of decrypting input data that is ciphertext data. The input data is premised as data in a prescribed format comprising a header part and a payload part.

A MAC frame or IP packet for example has a header part and a payload part, with the header part including information of a destination and a source, and the payload part including data of a subject of transmission. Note that the input data may have a trailer part. A MAC frame for example includes a Frame Check Sequence (FCS) as a trailer part. Meanwhile, the entirety of input data is not necessarily encrypted in the second stage, and that is, the header part is in a state of a cleartext, i.e., not encrypted.

The reception unit 11 receives input data.

The key material storage unit 12 has a key material k2 stored. If a key material k2 is a sequence number for example as described above, hardware implementing the key material storage unit 12 may be a counter.

The key material readout unit 13 operates differently in the first and second stages; the operation is the same, however, in terms of the key material readout unit 13 reading a key material k2.

In the first stage, the key material readout unit 13 reads a key material k2 from the key material storage unit 12 and updates a value of the key material k2 stored in the key material storage unit 12. If a key material k2 is a sequence number and the key material storage unit 12 is a counter for example, the key material readout unit 13 reads a value of the key material k2, followed by incrementing the counter.

In the second stage, the key material readout unit 13 reads a key material k2 from a prescribed part in the header part of the input data received by the reception unit 11.

The symmetric key generation unit 14 generates a symmetric key k based on the key material k2 read by the key material readout unit 13. A symmetric key k may be generated by further utilizing the destination/source information k1 and master key k3 shown in FIG. 4 in accordance with a preferred embodiment.

Incidentally, the above description premises that input data in the second stage includes a key material k2 as a condition. The next is a description of the premise condition by referring to FIGS. 2, 4 and 5.

The symmetric key generation apparatus 1 shown in FIG. 5 for example can be incorporated as apart of the relay apparatuses 2a and 2b as in the case of the symmetric key generation apparatuses 1a and 1b shown in FIG. 2. Either of the symmetric keys ka through kc shown in FIG. 2 corresponds to the symmetric key k, and either of the key materials k2a through k2c shown in FIG. 2 corresponds to the key material k2 shown in FIG. 4.

Referring to FIG. 2, the input data to the symmetric key generation apparatus 1a is for example the data 5a that is plaintext data to be encrypted. A key material readout unit (not shown herein) comprised by the symmetric key generation apparatus 1a accordingly carries out an operation for the first stage. And a symmetric key generation unit (not shown herein) comprised by the symmetric key generation apparatus 1a generates a symmetric key ka. Note that the data 5a is changed to encrypted data 6a by being encrypted by a symmetric key ka, and so the encrypted data 6a includes a key material k2a as described above.

Meanwhile, the input data to the symmetric key generation apparatus 1b shown in FIG. 2 is for example the encrypted data 6a that is the ciphertext data to be decrypted. A key material readout unit (not shown herein) comprised by the symmetric key generation apparatus 1b accordingly carries out an operation for the second stage, that is, reads the key material k2a from the encrypted data 6a.

As is apparent from the above description, when encrypting by using the symmetric key k generated in the first stage, a generation of encrypted data (i.e., the encrypted data 6a through 6c shown in FIG. 2) including the key material k2 in a prescribed part guarantees that the input data includes the key material k2 in the second stage. The symmetric key generation apparatus 1 according to the present invention is used in an environment in which a key material k2 and a symmetric key k are utilized as described above. FIG. 2 shows an example of such an environment.

FIG. 6 is an illustration diagram showing an encrypted communication carried out in a network including a relay apparatus comprising a symmetric key generation apparatus that uses also data other than the key material k2. FIG. 6 well resembles FIG. 2 and therefore the description here focuses on the difference.

FIG. 2 is a diagram corresponding to the case of generating a symmetric key k by using only a key material k2 from among the data shown in FIG. 4. Comparably, FIG. 6 is a diagram corresponding to the case of generating a symmetric key k by using all of the destination/source information k1, key material k2 and master key k3 of the data shown in FIG. 4. Therefore, FIGS. 2 and 6 are the same in terms of the point where different symmetric keys ka through kc for each of the input data 5a through 5c is generated, respectively, and the input data 5a through 5c are respectively encrypted by using different symmetric keys ka through kc.

Comparably with FIG. 2, the first characteristic of FIG. 6 lies where the fact that each of the input data 5a through 5c, encrypted data 6a through 6c and decrypted data 7a through 7c includes destination/source information k1a through k1c, respectively, is exhibited. The second characteristic lies where the symmetric key generation apparatuses 1a and 1b respectively store the master keys k3 of the same value. The third characteristic lies where the symmetric key generation apparatuses 1a and 1b respectively generate symmetric keys ka through kc based on the destination/source information k1a through k1c, key materials k2a through k2c and master key k3.

The data 5a, encrypted data 6a and decrypted data 7a as example respectively includes a destination/source information k1a. And the symmetric key generation apparatuses 1a and 1b respectively generate a symmetric key ka based on the destination/source information k1a, key material k2a and master key k3. The data 5a is changed to encrypted data 6a by being encrypted by using the symmetric key ka, and the encrypted data 6a is changed to decrypted data 7a by being decrypted by using the symmetric key ka. The symmetric key generation apparatuses 1a and 1b are capable of respectively generating the same symmetric key ka only provided that they respectively pre-store the master keys k3 of the same value, without exchanging a key in accordance with such as IKE.

Note that, while FIG. 6 shows the master keys k3 within the symmetric key generation apparatuses 1a and 1b, the master key k3 is generated from the pre-shared key k0 as shown in FIG. 4. Therefore, what the symmetric key generation apparatuses 1a and 1b pre-store respectively may be the master keys k3 of the same value or pre-shared keys k0 of the same value. If it is the latter, the symmetric key generation apparatuses 1a and 1b may respectively generate master keys k3 every time they generate symmetric keys ka through kc. Alternatively, they may respectively generate master keys k3 every time the power is turned on, store the generated master keys k3 in volatile memory (not shown herein) or a TCG-compliant chip 105 (which is described later) during the power-on state and read the master key k3 stored therein every time they respectively generate symmetric keys ka through kc. In either case, the symmetric key generation apparatuses 1a and 1b respectively store master keys k3 when generating the symmetric keys ka through kc. This is why FIG. 6 shows the master keys k3 within the symmetric key generation apparatuses 1a and 1b, respectively.

The next is a description on the case of utilizing the present invention for encrypting a Layer 2 communication as more specific example by referring to FIGS. 7 through 18.

FIG. 7 is a configuration diagram of a Layer 2 relay apparatus applied by the present invention. Let it be simply explained on a typical example of a Layer 2 communication before FIG. 7 is described.

A representative layer 2 communication includes an Ethernet communication, and the specification of the Ethernet specifies those of the physical layer (i.e., the Layer 1) and Layer 2 for an OSI reference model. Also, in accordance with the IEEE (Institute of Electrical and Electronics Engineers) 802.3 Standard in which the Ethernet has been standardized, the layer 2 is further divided into two sublayers, with one close to the layer 1 being the MAC (Media Access Control) sublayer and the one close to the layer 3 being the LLC (Logical Link Control) sublayer.

A relay apparatus of the layer 2 (abbreviated as “L2 relay apparatus” hereinafter; “L2” means the Layer 2) used for a layer 2 communication is also called an L2 switch, and a switching hub is its representative example. In the layer 2 communication, data is transmitted and received in a unit of a “frame”. There are plural formats varying in minute parts for a frame, such as a MAC frame of DIX Ethernet and a MAC frame of the IEEE 802.3, for example; such a difference is not important for the present invention. The following description accordingly uses the word “frame” as a generic terminology.

Incidentally, the conventional Ethernet communication is faced with the problems of not only the frame being transmitted and received without encryption, but also interception of the frame itself being easy. While it may be possible to communicate by encrypting a frame by combining a plurality of protocols, such a practice is faced with some problems such as a protocol stack becoming complex. Contrarily, a use of an L2 relay apparatus 101 (shown in FIG. 7) as a result of applying the present invention to a conventional L2 relay apparatus makes it possible to communicate by encrypting a frame by virtue of a simple configuration.

Referring to FIG. 7, the L2 relay apparatus 101 is an L2 relay apparatus for relaying a frame. It is the same as a conventional L2 relay apparatus where the L2 relay apparatus 101 comprises a plurality of physical ports for externally transmitting and receiving a frame (i.e., comprising four ports 103a through 103d according to the example shown in FIG. 7), and comprises a frame relay process unit 102 for relaying the frame.

The L2 relay apparatus 101 further comprises cryptographic process modules 104a through 104d corresponding to the respective ports 103a through 103d. Each of the cryptographic process modules 104a through 104d may be produced as a single chip. The cryptographic process modules 104a through 114d are respectively connected to the corresponding ports 103a through 103d and the frame relay process unit 102 by way of general-purpose interfaces such as GMII (Gigabit Medium Independent Interfaces) and MII (Medium Independent Interfaces). That is, both of the input and output of the cryptographic process modules 104a through 104d are frames. The GMII and MII are interfaces between the layer 1 and MAC sublayer, which are commonly used for the Ethernet.

Note that the cryptographic process performed by the cryptographic process modules 104a through 104d includes a generation of a symmetric key k, an encryption process and a decryption process while a detail is left to a later description. The following description uses a terminology “cryptographic process” for meaning an “encryption process and decryption process”. The symmetric key k is generated by utilizing the destination/source information k1, key material k2 and master key k3 in the preferred embodiment shown by FIG. 7. Specifically, MAC header information k1_f is utilized as destination/source information k1, and a sequence number k2_n as key material k2. Details of these pieces of information and a correlation of the cryptographic process modules 104a through 104d with the symmetric key generation apparatus 1 (shown in FIG. 5) are described later.

The L2 relay apparatus 101 is equipped with a TCG-compliant chip 105 which is a security chip in compliance with the TCG (Trusted Computing Group) specification. The TCG-compliant chip 105 stores the data such as a pre-shared key k0 (shown in FIG. 4) that is utilized by the cryptographic process modules 104a through 104d. Since the data stored in the TCG-compliant chip 105 cannot be taken out by an external fraudulent operation, the use of the TCG-compliant chip 105 enables a secure storage of the data.

The L2 relay apparatus 101 also comprises a Central Processing Unit (CPU) 106. The CPU 106 operates in accordance with a program stored in Read Only Memory (ROM; not shown herein) for example, and uses Random Access Memory (RAM; not shown herein), as work memory. As described later, the CPU 106 issues such as instructions to the cryptographic process modules 104a through 104d to generate data required for the cryptographic process.

The frame relay process unit 102, cryptographic process modules 104a through 104d, TCG-compliant chip 105, CPU 106, ROM, and RAM are connected to an internal bus 107.

In the L2 relay apparatus 101, the cryptographic process modules 104a through 104d are equipped in correspondence with the respective physical ports 103a through 103d, and a cryptographic process is performed separately from a frame relay process performed by the frame relay process unit 102. That is, the frame relay process unit 102 has no need to consider cryptography and therefore a frame relay process unit of a conventional relay apparatus that carries out absolutely no cryptographic process can be utilized as a frame relay process unit 102 without modification.

In order to separate the relay process and cryptographic process as described above, the interface between the frame relay process unit 102 and the cryptographic process modules 104a through 104d is an interface such as GMII, MII or the like. In the case of a conventional relay apparatus that performs absolutely no cryptographic process, the frame relay process unit is connected to the port by way of an interface such as GMII or MII, and performs a frame relay process via the interface. In the same manner, the frame relay process unit 102 of FIG. 7 also performs only the frame relay process via an interface such as CMII or MII.

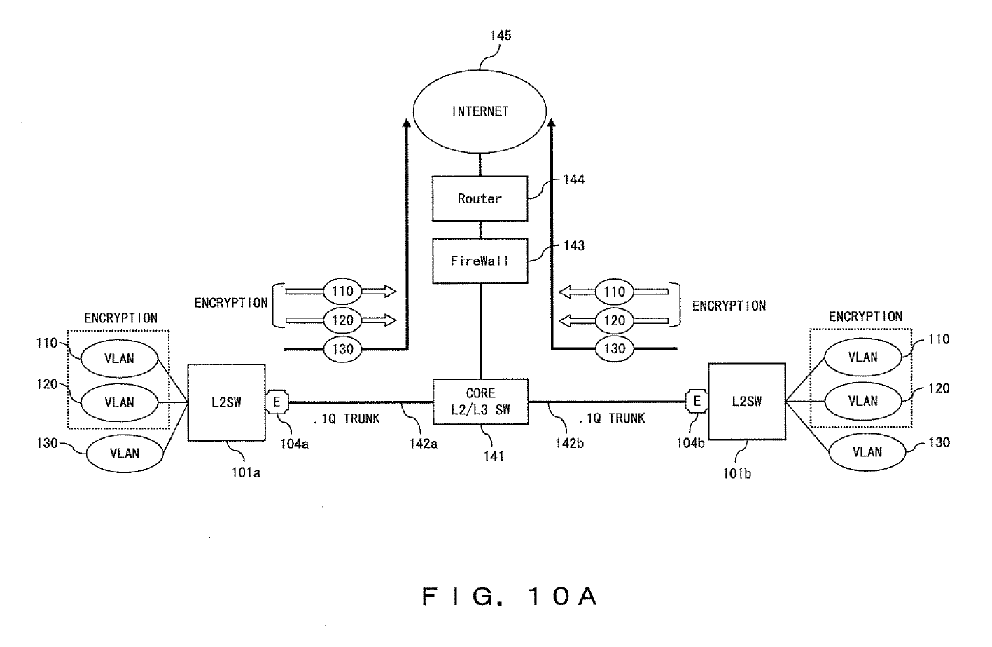

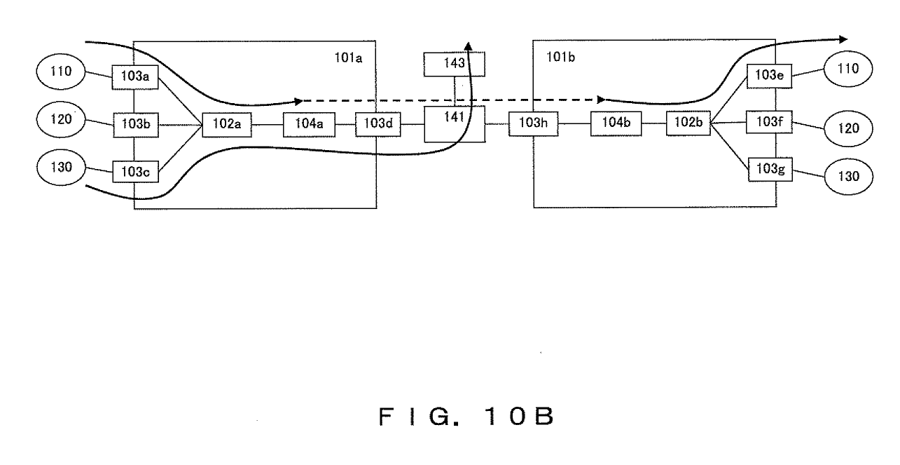

Meanwhile, the L2 relay apparatus 101 comprises the cryptographic process modules 104a through 104d corresponding to the respective ports 103a through 103d, and therefore is capable of encrypting an Ethernet communication in an N-to-N topology commonly employed in general office environments. Note that the “N-to-N topology” mentioned here does not represent physical cable wiring but represents a situation in which a plurality of relay apparatuses performs encrypted communications respectively with a plurality of relay apparatuses. This aspect is described later by referring to FIGS. 10A, 10B and FIGS. 13 through 15.

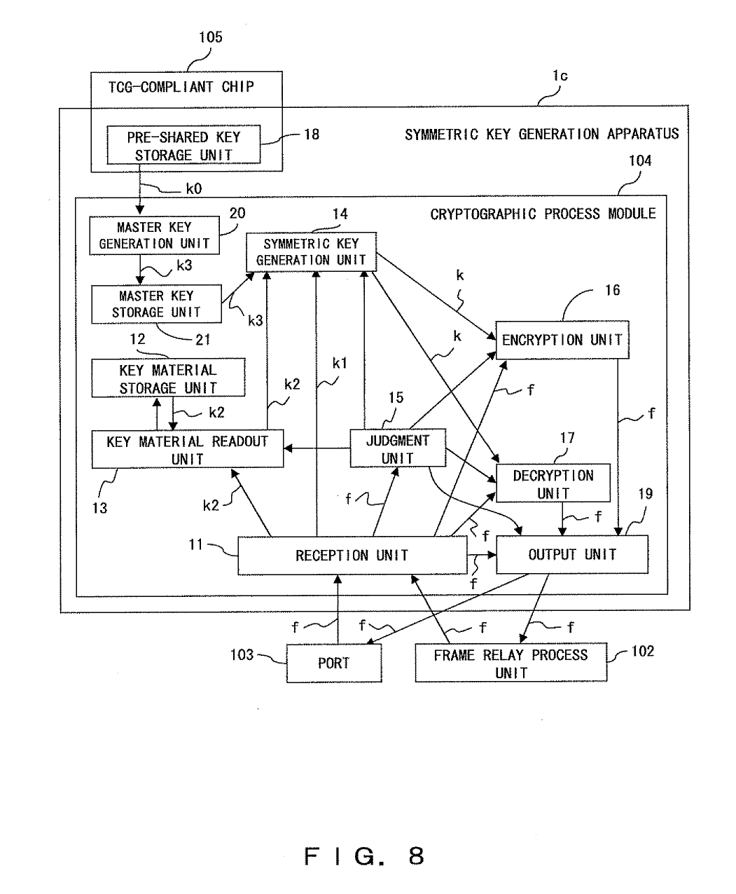

FIG. 8 is a functional block diagram describing a relationship between FIGS. 7 and 5. Note that an arrow attached with a sign indicates that the following information is sent in the arrow direction, i.e., “f”: frame, “k0”: pre-shared key k0, “k1”: MAC header information k1_f as a destination/source information k1, “k2”: sequence number k2_n as a key material k2, “k3”: master key k3 and “k”: symmetric key k. An arrow without a sign represents a control flow. The specific contents of the signs “k1_f” and “k2_n” are described later.

Each of the cryptographic process modules 104a through 104d shown in FIG. 7 approximately corresponds to the symmetric key generation apparatus 1 shown in FIG. 5. That is, the L2 relay apparatus 101 includes four of the symmetric key generation apparatus. Accurately speaking, however, these four symmetric key generation apparatuses share a single TCG-compliant chip 105, utilizing it as a part of each symmetric key generation apparatus. FIG. 8 is a diagram describing the correlation. Incidentally, the configuration of the cryptographic process modules 104a through 104d is the same in the example of FIG. 7, and therefore FIG. 8 simply uses “104”. And the ports corresponding to the cryptographic process modules 104 are simply indicated by the sign “103”.

The symmetric key generation apparatus 1c shown in FIG. 8 comprises a reception unit 11, a key material storage unit 12, a key material readout unit 13 and a symmetric key generation unit 14 as in the case of the symmetric key generation apparatus 1 shown in FIG. 5. Specifically, these four constituent components are incorporated in the cryptographic process module 104.

As described above, the cryptographic process module 104 is connected to the corresponding port 103 and frame relay process unit 102 by way of the interface such as GMII and MII. The reception unit 11 carries out an interface process and buffers a frame. That is, the reception unit 11 comprises buffer memory. Incidentally, the reception unit 11 comprises, physically speaking, a plurality of interfaces (i.e., an interface with the port 103 and one with the frame relay process unit 102) in the configuration shown in FIG. 8.

The cryptographic process module 104 also performs a cryptographic process by using a generated symmetric key k in addition to generating it as described above, and therefore further comprises a judgment unit 15, an encryption unit 16, a decryption unit 17 and an output unit 19. These four constituent components are also included in the symmetric key generation apparatus 1c in the configuration shown in FIG. 8.

The judgment unit 15 judges whether the first stage (i.e., the stage in which a symmetric key k is to be generated for encryption) or the second stage (i.e., the stage in which a symmetric key k is to be generated for decryption). The judgment unit 15 may be configured to judge as a third stage (i.e., a stage in which there is no necessity of generating a symmetric key k because there is no need to perform encryption or decryption) depending on a preferred embodiment. Then the judgment unit 15 notifies the key material readout unit 13, symmetric key generation unit 14, encryption unit 16, decryption unit 17 and output unit 19 properly of the judgment result.

If the judgment unit 15 judges as the first stage, the encryption unit 16 performs an encryption process of a frame received by the reception unit 11 by using the symmetric key k generated by the symmetric key generation unit 14 and output the encrypted frame to the output unit 19. If the judgment unit 15 judges as the second stage, the decryption unit 17 performs a decryption process of a frame received by the reception unit 11 by using the symmetric key k generated by the symmetric key generation unit 14 and outputs the decrypted frame to the output unit 19.

Having received an input of either of the frame encrypted by the encryption unit 16 in the first stage, one decrypted by the decryption unit 17 in the second stage or one without being applied to a process after the reception unit 11 has received it in the third stage, then the output unit 19 has the function of outputting the input frame to an outside of the symmetric key generation apparatus 1c (i.e. external to the cryptographic process module 104). Specifically, it outputs either of the above frames to the port 103 or frame relay process unit 102 by way of an interface such as the GMII and MII. FIG. 8, being a functional block configuration diagram, shows the reception unit 11 and output unit 19 by separate blocks; the hardware such as a wiring between them and the port 103, however, may be shared between the reception unit 11 and output unit 19.

The symmetric key generation apparatus 1c shown in FIG. 8 generates a symmetric key k by utilizing also the destination/source information k1 and master key k3 shown in FIG. 4. That is, the symmetric key generation unit 14 extracts the destination/source information k1 from the frame received by the reception unit 11, reads the master key k3 from a master key storage unit 21 and utilizes them. As described above, the L2 relay apparatus 101 includes four of the symmetric key generation apparatus. In the present embodiment, each of the four symmetric key generation apparatus is one with a sign “1c” shown in FIG. 8. The present embodiment is also configured in a manner that a master key generation unit 20 in each of the four symmetric key generation apparatuses 1c generates a master key k3 from the pre-shared key k0 stored in a pre-shared key storage unit 18 every time the power to the L2 relay apparatus 101 is turned on and stores it in the master key storage unit 21. A pre-shared key k0 must be pre-stored within the symmetric key generation apparatus 1c safely (that is, so as not to be read fraudulently). A part of the TCG-compliant chip 105 is utilized as the pre-shared key storage unit 18 according to the configuration shown in FIG. 8.

That is, the symmetric key generation apparatus 1c shown in FIG. 8 comprises the single cryptographic process module 104 and the pre-shared key storage unit 18 as a part of the TCG-compliant chip 105. Note that, if there are four cryptographic process modules 104a through 104d as in the case of FIG. 7, the TCG-compliant chip 105 is shared by four of the symmetric key generation apparatuses 1c, four different zones of the TCG-compliant chip 105 may be respectively used as constituent components of the four of the symmetric key generation apparatuses 1c, or a certain zone of the TCG-compliant chip 105 may be shared as a constituent component of the four of the symmetric key generation apparatuses 1c.

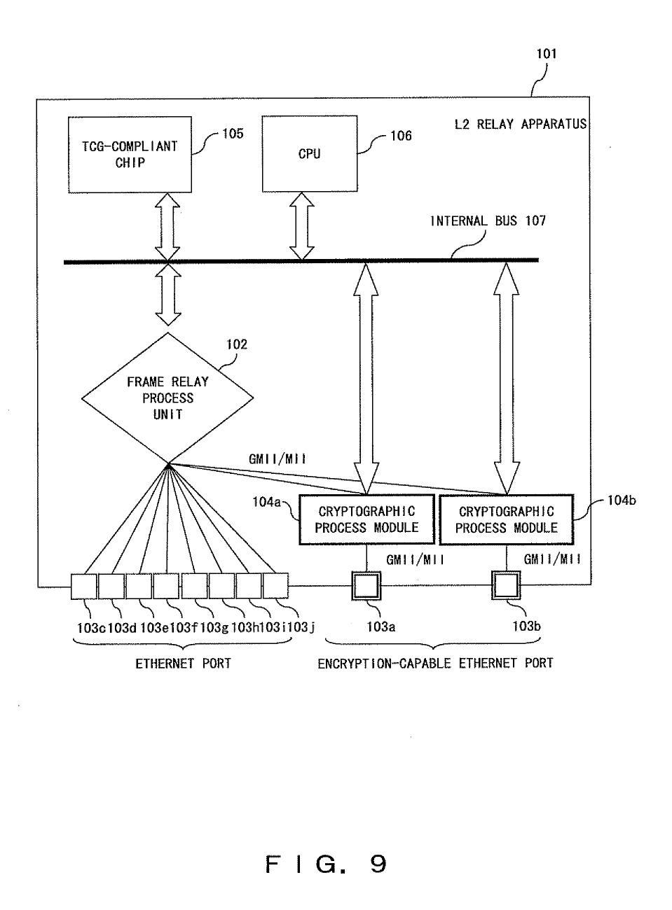

FIG. 9 is a diagram exemplifying a modification of the L2 relay apparatus 101 shown in FIG. 7. The difference between FIGS. 9 and 7 lies where only a part of the ports (i.e., 103a and 103b) are equipped with the cryptographic process modules 104a and 104b for the configuration of FIG. 9. The other ports (i.e., 103c through 103j) are directly connected to the frame relay process unit 102 by way of the interfaces such as GMII and MII, without equipped with a cryptographic process module. That is, the L2 relay apparatus 101 may comprise a cryptographic process module(s) on a part of ports or the entirety thereof based on a necessity of an encrypted communication.

In the frame relay process unit 102, the interface with the cryptographic process modules 104a and 104b, and the one with the ports 103c through 103j not equipped with a cryptographic process module, are all the same interfaces (e.g., GMII and MII). Therefore, the frame relay process unit 102 can concentrate on relaying a frame without distinguishing between a port equipped with a cryptographic process module and one not equipped with it.

Note that the cryptographic process modules 104a and 104b of FIG. 9 are also configured as one shown in FIG. 8.

FIG. 10A is a diagram exemplifying a utilization of a Layer 2 relay apparatus including a symmetric key generation apparatus, indicating a network configuration including three virtual local area networks (VLANs), i.e., VLANs 110, 120 and 130.

Referring to FIG. 10A, L2 relay apparatuses 101a and 101b are similar to the L2 relay apparatus 101 shown in FIG. 7 or FIG. 9. The L2 relay apparatus 101 according to the present invention, being a switch apparatus having the function of relaying a Layer 2 frame, may be sometimes noted as “L2SW” in FIG. 10A and thereafter. Terminals (i.e., computers) belonging to VLANs 110, 120 and 130 are respectively connected to the L2 relay apparatuses 101a and 101b. That is, the L2 relay apparatuses 101a and 101b are edge switches connected to the terminals.

The L2 relay apparatuses 101a and 101b, and a firewall 143 are connected to a core L2/L3 switch 141 (i.e., a conventional switch apparatus having a layer 2 or layer 3 relay function, but no function related to a cryptographic process) that is a conventional relay apparatus. That is, the core L2/L3 switch 141 is a core switch relaying between switches. The firewall 143 is connected to a router 144 which is then connected to the Internet 145.

Incidentally, one usage of a VLAN is to overlap a plurality of systems in the same physical network. For example, the apparatuses, i.e., the L2 relay apparatus 101a, core L2/L3 switch 141 and L2 relay apparatus 101b, and cables connecting these components are physical existence. And a physical network connecting these physical existences is shared by three different VLANS, i.e., VLANs 110, 120 and 130. That is, a plurality of systems is overlapped on the same physical network.

These plural systems may possibly include a system for primarily handling classified information and one for primarily handling Web browsing requiring no security protection. Requirements for secrecy of communication are naturally different between the former and latter. Therefore, if a VLAN is utilized, performing a cryptographic process in the unit of a physical port (e.g., a practice of the cryptographic process module 104a encrypting all frames transmitted from the L2 relay apparatus 101a to the core L2/L3 switch 141) is not preferable because an extraneous process is carried out such as encrypting even a communication including no secret data.

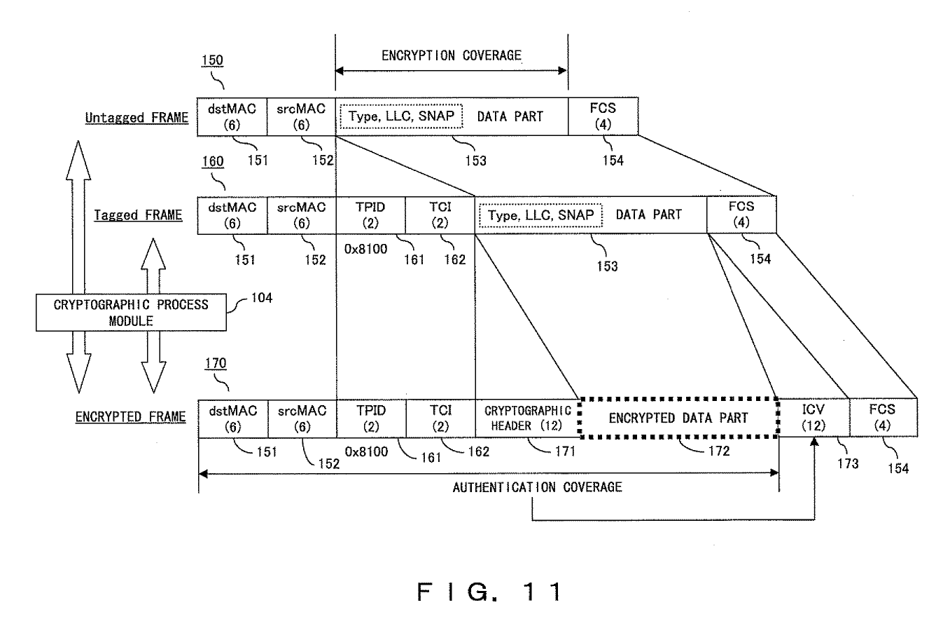

There are sections A, B and C in a business entity as an example. The sections A and B handle classified data, hence requiring an encrypted communication and also prohibiting a communication by way of the Internet 145 for maintaining a security. The section C on the other hand handles no classified data and primarily carries out e-mail exchanges and Web browsing (requiring a communication with the Internet 145). In this case, the individual sections are sometimes divided into separate VLANs to configure as shown in FIG. 11A. That is, the sections A, B and C respectively correspond to the VLANs 110, 120 and 130.

The present invention enables a selection of whether or not encrypting for each VLAN and an avoidance of an unnecessary cryptographic process. That is, it makes it possible to select the VLANs 110 and 120 as subject of encryption and the VLAN 130 as the outside of a subject thereof. Also enabled is to configure a network by the L2 relay apparatuses 101a and 101b according to the present invention intermingling with the core L2/L3 switch 141 that is a conventional relay apparatus as shown in FIG. 10A. This practice is described in the following.

As shown by an excerpt in FIG. 10B, the L2 relay apparatus 101a has ports 103a through 103d, with the ports 103a, 103b and 103c being assigned to the VLANs 110, 120 and 130, respectively. This assignment is preset by a network administrator. The port 103d is one connected to the core L2/L3 switch 141. On the inside of the L2 relay apparatus 101a, the port 103d is connected to the cryptographic process module 104a by way of the interface such as the GMII and MII. The ports 103a through 103c and cryptographic process module 104a are respectively connected to the frame relay process unit 102a by way of the interface such as the GMII and MII.

Likewise, the L2 relay apparatus 101b comprises ports 103e through 103h, with the ports 103e, 103f and 103g being assigned to the VLANs 110, 120 and 130, respectively. And the port 103h is one connected to the core L2/L3 switch 141.

Note that FIG. 10A shows cryptographic process modules 104a and 104b on the outside of rectangles indicating the L2 relay apparatuses 101a and 101b for convenience of display; the cryptographic process modules, however, are respectively on the inside of the relay apparatuses in the actual configuration as shown in FIGS. 7, 9 and 10B. The drawings hereafter may represent in the similar manner. Also note that FIG. 10B omits such as TCG-compliant chip among the constituent components of the L2 relay apparatuses 101a and 101b.

When transmitting a frame within the same VLAN from the left to right in the delineation of FIG. 10A, the frame travels by way of the L2 relay apparatus 101a, core L2/L3 switch 141 and L2 relay apparatus 101b in any VLAN. Describing in more detail by referring to FIG. 10B, the frame travels by way of the frame relay process unit 102a, cryptographic process module 104a, port 103d, core L2/L3 switch 141, port 103h, cryptographic process module 104b and frame relay process unit 102b in any VLAN. Of the path in which the frame travels, the parts which differ for each VLAN are a part on the left side of the frame relay process unit 102a and a part on the right side of the frame relay process unit 102b in the delineation of FIG. 10B.

In FIGS. 10A and 10B, the terminals belonging to the VLAN 130 are assumed to communicate with the Internet 145 as described above. The communication with the Internet 145 is indicated by two bold line arrows (i.e., one arrow starting at the L2 relay apparatus 101a, traveling by way of the core L2/L3 switch 141, firewall 143 and router 144, and reaching the Internet 145; and the other starting at the L2 relay apparatus 101b, traveling by way of the core L2/L3 switch 141, firewall 143 and router 144, and reaching the Internet 145) in the delineation of FIG. 10A.

As such, in the case of communicating within any VLAN or with an external network such as the Internet 145, a frame travels between the port 103d and core L2/L3 switch 141, and/or between the port 103h and core L2/L3 switch 141. That is, the physical communication paths (i.e., a cable) between the port 103d and core L2/L3 switch 141, and between the port 103h and core L2/L3 switch 141 are shared among a plurality of VLANs. Such communication paths (142a and 142b) are called “0.1Q trunk” named after the IEEE 802.1Q that is a standard for VLAN.

The port 103a and such are fixedly assigned to a single VLAN, while the ports 103d and 103h are shared among a plurality of VLANs. The port 103d or 103h is called a “tagged VLAN port”. The administrator presets the ports 103d and 103h as the tagged VLAN ports. A corresponding VLAN cannot be uniquely determined for the tagged VLAN port, and therefore a frame transmitted and received between the ports 103d and 103h (more accurately describing, between the frame relay process units 102a and 102b) is attached with a VLAN-ID that is information for identifying a VLAN (which is described later in association with FIG. 11).

As described above, the VLAN 110 and VLAN 120 are subjects of encryption and the VLAN 130 is not in the example shown in FIG. 10A. The administrator inputs, in the L2 relay apparatus 101a, a setup as to which VLAN is to be a subject of encryption. Then, a CPU (corresponding to the CPU 106 shown in FIG. 7) (not shown in FIG. 10B) instructs the cryptographic process module 104a to set the input content. The same process is performed on the L2 relay apparatus 101b. As a result, the cryptographic process modules 104a and 104b apply a cryptographic process only to a frame requiring the cryptographic process based on the setup input by the administrator.

When transmitting a frame within the VLAN 110 from the left to right in the delineation of FIG. 10B for example, a frame received at the port 103a (i.e., the frame transmitted from a terminal connected to the port 103a) is transmitted to the cryptographic process module 104a by way of the frame relay process unit 102a. This prompts the respective constituent components, which are shown in FIG. 8, of the cryptographic process module 104a to operate as follows:

First, the reception unit 11 receives the frame.

The judgment unit 15 judges as the first stage (i.e., the stage in which a symmetric key k is to be generated for encrypting the frame) based on the fact of receiving the frame from the frame relay process unit 102a in place of the port 103d, the VLAN-ID included in the frame and the above described setup content.

Then, in accordance with the judgment of the judgment unit 15, the key material readout unit 13 reads a sequence number k2_s as a key material k2 from the key material storage unit 12 and updates a value stored in the key material storage unit 12.

The symmetric key generation unit 14 obtains MAC header information k1_f, the sequence number k2_s and a master key k3 for generating a symmetric key k based on the judgment of the judgment unit 15. The MAC header information k1_f is extracted from the frame received by the reception unit 11. The sequence number k2_s is the value read by the key material readout unit 13. The master key k3 is stored in the master key storage unit 21. The symmetric key generation unit 14 generates a symmetric key k based on the obtained three pieces of data.

The encryption unit 16 receives the symmetric key k from the symmetric key generation unit 14 based on the judgment of the judgment unit 15, reads the frame buffered at the reception unit 11 and encrypts the frame by using the symmetric key k.

The encrypted frame is output to the port 103d shown in FIG. 10B by way of the output unit 19. Returning to FIG. 10B here, the encrypted frame is transmitted to the cryptographic process module 104b by way of the port 103d, core L2/L3 switch 141 and port 103h. This prompts the respective constituent components, which are shown in FIG. 8, of the cryptographic process module 104b to operate as follows:

First, the reception unit 11 receives the frame.

The judgment unit 15 judges as the second stage (i.e., the stage in which a symmetric key k is to be generated for decrypting the frame) based on the fact of receiving the frame from the port 103h in place of frame relay process unit 102b, the VLAN-ID included in the frame and the above described setup content. Or it judges as the frame being a subject of decryption based on the fact of the frame including a cryptographic header 171 that is described later.

Then, in accordance with the judgment of the judgment unit 15, the key material readout unit 13 reads a sequence number k2_r as a key material k2 from the received frame. The operation of the symmetric key generation unit 14 is a similar to that of the symmetric key generation unit 14 of the cryptographic process module 104a.

The decryption unit 17 receives the symmetric key k from the symmetric key generation unit 14 based on the judgment of the judgment unit 15, reads the frame buffered at the reception unit 11 and decrypts the frame by using the symmetric key k.

The decrypted frame is transmitted to the frame relay process unit 102b shown in FIG. 10B by way of the output unit 19 and relayed to the port 103e, followed by being transmitted therefrom to a terminal connected to the port 103e.

That is, the frame is transmitted in a state of plaintext (i.e., the state of not being encrypted) in the paths from the terminal to the cryptographic process module 104a by way of the port 103a and from the cryptographic process module 104b to the terminal by way of the port 103e. Contrarily, the frame is transmitted in a state of being encrypted between the cryptographic process module 104a and cryptographic process module 104b. It is the same when transmitting a frame within the VLAN 120.

A frame in the state of a plaintext is named as “plaintext frame” and one in the state of being encrypted is named as “encrypted frame” hereinafter. A transmission of a plaintext frame is indicated by a solid line arrow and that of an encrypted frame is indicated by a dotted line arrow according to the delineation of FIG. 10B.

When transmitting a frame within the VLAN 130 from the left to right according to the delineation of FIG. 10B, the cryptographic process module 104a judges that the frame is other than a subject of encryption based on the VLAN-ID included in the frame and the above-described setup content and that an encryption process is unnecessary, followed by transmitting the frame to the port 103d in the same state of the plaintext. That is, the judgment unit 15 (of FIG. 8) judges as the third stage (i.e., an encryption process is unnecessary, not requiring a generation of a symmetric key k) within the cryptographic process module 104a, and the cryptographic process module 104a outputs the frame, as is, buffered at the reception unit 11 to the port 103d by way of the output unit 19 in accordance with the judgment.

Meanwhile, in the cryptographic process module 104b the judgment is that the frame is other than a subject of encryption and therefore decryption process is unnecessary based on the VLAN-ID included in the frame and the above-described setup content (or, a cryptographic header 171 is not included in the received frame and therefore a decryption process is unnecessary), followed by transmitting the received plaintext frame, as is, to the frame relay process unit 102b. That is, the judgment unit 15 (shown in FIG. 8) judges as the third stage within the cryptographic process module 104b, and the cryptographic process module 104b outputs the frame, as is, buffered at the reception unit 11 to the frame relay process unit 102b by way of the output unit 19 in accordance with the judgment.

When a computer belonging to the VLAN 130 transmits an IP packet to the Internet 145, a frame corresponding to the IP packet is transmitted by way of the port 103d or port 103h. In the L2 relay apparatus 101a for example, the port 103c assigned to the VLAN 130 is connected to the frame relay process unit 102a that is connected to the cryptographic process module 104a that is then connected to the port 103d, and therefore a frame not requiring a cryptographic process is also transmitted via the cryptographic process module 104a without an exception.

When relaying, to the port 103d, a frame received at the port 103c assigned to the VLAN 130, the cryptographic process module 104a judges as a cryptographic process being unnecessary and accordingly transmits the plaintext frame as is to the port 103d likewise the case of transmitting a frame within the VLAN 130. This practice corresponds to the fact of the solid line arrow (indicating a transmission of a plaintext frame) heading from the L2 relay apparatus 101a toward the firewall 143 by way of the core L2/L3 switch 141 in FIG. 10B.

As described above, the configuration shown in FIG. 10A sets whether or not a subject of encryption for each VLAN. That is, FIG. 10A makes the granularity of encryption finer than the case of encrypting all frames being transmitted along the 0.1Q trunk 142a between the port 103d and core L2/L3 switch 141 for example. Fine granularity is advantageous in avoiding an extraneous encryption of a communication not including classified data.

Such capability of setting for the cryptographic process modules 104a and 104b as to whether or not to make a subject of encryption selectively for each VLAN makes it possible to have the core L2/L3 switch 141 that is a conventional relay apparatus intervene between the L2 relay apparatuses 101a and 101b so as to connect the core L2/L3 switch 141 directly to the firewall 143.

Assuming an incapability of setting for each VLAN in FIG. 10A, a frame will be encrypted by the cryptographic process module 104a even when a terminal belonging to the VLAN 130 communicates with the Internet 145. Therefore, it is necessary to make the L2 relay apparatus 101 that comprises a cryptographic process module intervene between the core L2/L3 switch 141 and firewall 143 in order to decrypt the encrypted frame and transmit the decrypted frame to the outside of the firewall 143.

That is, enabling a setup for each VLAN makes it possible to reduce the number of required apparatuses. In other words, a limitation can be reduced when configuring a network. In brief, the present invention is applicable to various configurations.

FIG. 11 is a diagram describing a format of a frame utilized for the present invention. The present invention is contrived to encrypt only the data part of a frame.

A frame 150 shown in the upper row of FIG. 11 is a common frame transmitted and received in the Layer 2. The frame 150 is constituted by a 6-byte of a destination MAC address 151, a 6-byte of source MAC address 152, a data part 153 and a 4-byte of error detection-use FCS 154.

In the case of a MAC frame of DIX Ethernet, the head of the data part 153 is a type expressed by 2 bytes followed by data of between 46 and 1500 bytes. Therefore, a frame is a maximum of 1518 bytes (i.e., 6+6+2+1500+4=1518). In the case of the MAC frame according to the IEEE 802.3 Standard, the head of a data part 153 is a length/type expressed by 2 bytes. It is followed, although different for a specific frame format, by a 3-byte of LLC header and/or a 5-byte of SNAP (Sub NetworkAccess Protocol) header and further followed by data. The length of the data part 153 is between 46 and 1500 bytes including the LLC header and/or SNAP header. The maximum length of one frame is therefore 1518 bytes.

As described before, while the premise is that a piece of input data to the symmetric key generation apparatus 1 is constituted by the header part and payload part, if input data is a frame 150, the header part is constituted by the destination MAC address 151 and source MAC address 152, and the payload part is the data part 153.

A tagged frame 160 shown in the middle row of FIG. 11 is a result of inserting a VLAN tag into a frame 150. The tagged frame 160 is similar to the frame 150 except for a 2-byte of TPID (Tag Protocol Identifier) 161 and a 2-byte of TCI (Tag Control Information) 162 being inserted between the source MAC address 152 and data part 153. In the case of the Ethernet, a value of the TPID 161 indicating a VLAN is a 0x8100 (meaning 8100 in a hexadecimal notation). The TCI 162 includes a 12-bit of VLAN-ID for identifying a VLAN. The TPID 161 and TCI 162 are sometimes added at a source terminal of a frame; they are more commonly added at a relay apparatus, however. In the latter case, a recalculation of an FCS 154 is also performed at the relay apparatus.

In the case of setting whether or not to perform a cryptographic process for each VLAN as in FIG. 10A, the cryptographic process module 104 judges a necessity or not of the cryptographic process based on a value of the VLAN-ID included in the TCI 162.

If input data to the symmetric key generation apparatus 1 is a tagged frame 160, the header part is a part between the destination MAC address 151 and TCI 162, the payload part is the data part 153 and the trailer part is the FCS 154.

An encrypted frame 170 shown in the lower row of FIG. 11 is one obtained by encrypting a tagged frame 160 and contains a field unique to the present invention. Comparing the encrypted frame 170 with the tagged frame 160, the difference lies where a cryptographic header 171 is inserted immediately after the TCI 162, the data part 153 is encrypted to be an encrypted data part 172, and an ICV (Integrity Check Value) 173 is inserted immediately after the encrypted data part 172. The cryptographic header 171 includes a key material k2 necessary for decryption. The ICV 173 is a type of a check sum calculated based on a range between the destination MAC address 151 and the encrypted data part 172. In addition, the cryptographic process module 104 also performs a recalculation of the FCS 154 when encrypting a frame.

If input data to the symmetric key generation apparatus 1 is an encrypted frame 170, the header part is a part between the destination MAC address 151 and the cryptographic header 171, the payload part is the encrypted data part 172, and the trailer part is the ICV 173 and FCS 154.

The first characteristic of the encrypted frame 170 lies where only the data part 153 is encrypted, whereas the MAC header (i.e., the part constituted by the destination MAC address 151 and source MAC address 152) is not encrypted. The second characteristic lies where the cryptographic header 171 is placed posterior to the TCI 162.

The first characteristic leads to an advantage that an increase in size of the frame or in a complexity of the process can be avoided as described below.

The method of encrypting a frame including the MAC header provides a higher degree of security because the information as to which terminals are engaged in a communication can also be concealed. When transmitting a frame from a terminal Xt connected to a switch Xs (that is a relay apparatus) to a terminal Yt connected to a switch Ys for example, the MAC address of the terminal Yt is written on the destination MAC address 151 of the frame and the MAC address of the terminal Xt is written on the source MAC address 152. In the case of encrypting the frame including the MAC header, the post-encryption frame is an encapsulated frame prefixed with another MAC header. That is, the MAC address of the switch Ys is written as the destination MAC address 151 for an outer frame, and the MAC address of the switch Xs is written as the source MAC address 152 for an outer frame.

In the encapsulated frame, the information of the terminal Xt and the terminal Yt being engaged in a communication is encrypted, thereby providing a high level of security. However, the size of the frame is increased by the size of the added MAC header, which leads to an occurrence of an overhead. In addition, for the encapsulation as described above, the frame relay process unit of the switch must determine a switch as a relay destination for each frame and add the MAC header based on the determination (in the present example, the switch Xs needs to identify the MAC address of the switch Ys from the MAC address of the destination terminal Yt). Thus, the relay process is complicated.

By contrast, in the encrypted frame 170, neither the destination MAC address 151 nor source MAC address 152 is encrypted, providing a slightly lower level of security than the above described method. However, since there is no need to add another MAC header to the frame, the size of the frame can be suppressed to be smaller than the above described method.

Also, the frame relay process unit 102 is only required to perform the normal relay process (e.g., there is not need to identify the MAC address of the switch Ys from the MAC address of the destination terminal Yt). Therefore, the present invention can utilize a frame relay process unit 102 similar to one in a conventional switch apparatus that does not perform a cryptographic process as shown in FIGS. 7 and 9. And, the function related to encryption/decryption can be off-loaded onto a cryptographic process modules (104a and such) equipped corresponding to the respective ports equipped on an as required basis.

The next is a description on the second characteristic of the cryptographic header 171 being placed posterior to the TCI 162. The second characteristic leads to an advantage that the L2 relay apparatus 101 of the present invention and a normal Layer 2 relay apparatus without a cryptographic process function can be intermingled for configuring a network.

Assuming an adoption of a method for encryption including the TPID 161 and TCI 162, it is natural to insert a cryptographic header 171 immediately after the MAC header (that is, immediately after the source MAC address 152) and continue with the encrypted TPID 161 and TCI 162 thereafter. This method, however, negates a discernment of a VLAN to which a pre-encryption original tagged frame 160 belongs unless the encrypted frame is decrypted. Consequently, making a normal Layer 2 relay apparatus not comprising a cryptographic process function mingle in the middle of a telecommunication path of a network, the aforementioned relay apparatus is unable to judge as for which VLAN the frame corresponds to, thus unable to relay the frame appropriately. Therefore, if this method is adopted, it is not possible to make the normal Layer 2 relay apparatus not comprising a cryptographic process function mingle.

Contrarily, in the encrypted frame 170 of FIG. 11, the cryptographic header 171 and encrypted data part 172 are placed following the TPID 161 and TCI 162 which are in a cleartext state. Therefore, the normal Layer 2 relay apparatus without the cryptographic process function can also judge as for which VLAN the frame corresponds to, and relay the frame appropriately. In this case, the normal Layer 2 relay apparatus recognizes the encrypted frame 170 simply as a tagged frame. Therefore, according to the present invention, the normal Layer 2 relay apparatus can be mingled in configuring a network, enabling an efficient utilization of the existing apparatus. In addition, the L2 relay apparatus 101 comprising the symmetric key generation apparatus 1 can be utilized in various network configurations.

Meanwhile, focusing attention on the fact that also the frame relay process unit 102 comprised by the L2 relay apparatus 101 shown in FIGS. 7 and 9 does not have a cryptographic process function, the second characteristic leads to the following advantage. That is, the frame relay process unit 102 simply recognizes the encrypted frame 170 of FIG. 11 similar to the tagged frame 160 and can perform a relay process without any consideration of encryption. That is, the frame relay process unit 102 is required to merely perform the identical process to the frame relay process unit comprised by a conventional Layer 2 relay apparatus without a cryptographic process function. Also, as shown in FIG. 9, there is no need to equip all ports with the cryptographic process modules.

Meanwhile, in an environment not using a VLAN, encryption is performed not for a tagged frame 160 but for a frame 150. Therefore, an encrypted frame in such a case is in the form of the encrypted frame 170 of FIG. 11 with the TPID 161 and TCI 162 being removed.

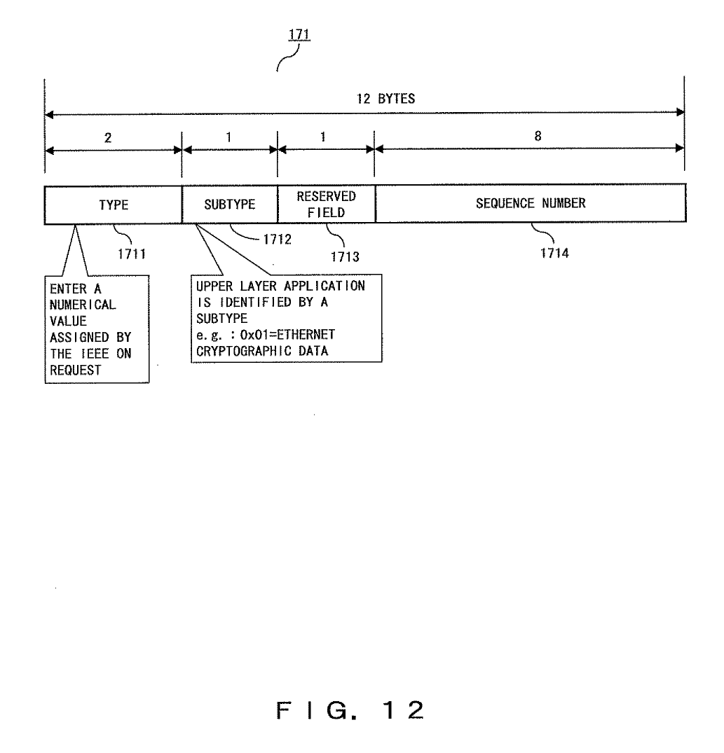

FIG. 12 shows details of the cryptographic header 171. The length of the cryptographic header 171 is 12 bytes as shown in FIG. 12. The cryptographic header 171 is constituted by a 2-byte of type 1711, a 1-byte of subtype 1712, a 1-byte of reserved field 1713, and an 8-byte of sequence number 1714 as shown in FIG. 12 in the described order.

The type 1711 is the field storing a global unique value representing the type of the frame. In order to make the type 1711 a global unique value, a request for the assignment of a value to the IEEE and the assignment of the value by the IEEE are necessary. The reason that the type 1711 must be a global unique value is as follows.

As is apparent from FIG. 11 and FIG. 12, the type 1711 is placed immediately following the TCI 162 in an environment using a VLAN; and the type 1711 is placed immediately following the source MAC address 152 in an environment not using a VLAN. Therefore, the type (placed at the head of the data part 153) in the frame 150 or in the tagged frame 160 is in the same position as the type 1711 in the encrypted frame 170. Accordingly, it is necessary to discern a presence or absence of the cryptographic header 171 based on a value of the type 1711.

The type placed at the head of the data part 153 in the frame 150 and the tagged frame 160 is a global unique value for identifying a protocol used by the upper layer, that is, Layer 3. For example, 0x0800 represents the IP. If the value of the type is 0x0800, the data part 153 is data in accordance with the IP format.

Therefore, the assignment of a specific global unique value (assumed as Z) to the type 1711 enables a discernment of a presence or absence of the cryptographic header 171. That is, if the value of 2 bytes immediately following the TCI 162 is Z, the presence of the cryptographic header 171 can be determined in the environment using a VLAN; and, if the value of 2 bytes immediately following the source MAC address 152 is Z, the presence of the cryptographic header 171 can be determined in the environment not using a VLAN.

Thus enabling the determination of the presence or absence of the cryptographic header 171 enables the cryptographic process module 104b for example, having received a frame from the port 103h shown in FIG. 10B, to judge whether the received frame is an encrypted frame or a plaintext frame on the basis of the presence or absence of the cryptographic header 171.

The subtype 1712 is the field for utilizing the single value (i.e., the Z mentioned above) assigned by the IEEE for various purposes. The type 1711 and subtype 1712 are required to merely indicate what the data in the upper layer represents, and their numerical values per se are meaning less. It is possible to define such as “if the type 1711 is a Z and the value of the subtype 1712 is 0x01, it represents that an encrypted Ethernet communication is performed and the fact that the cryptographic header 171 is followed by the encrypted data part 172”, for example.

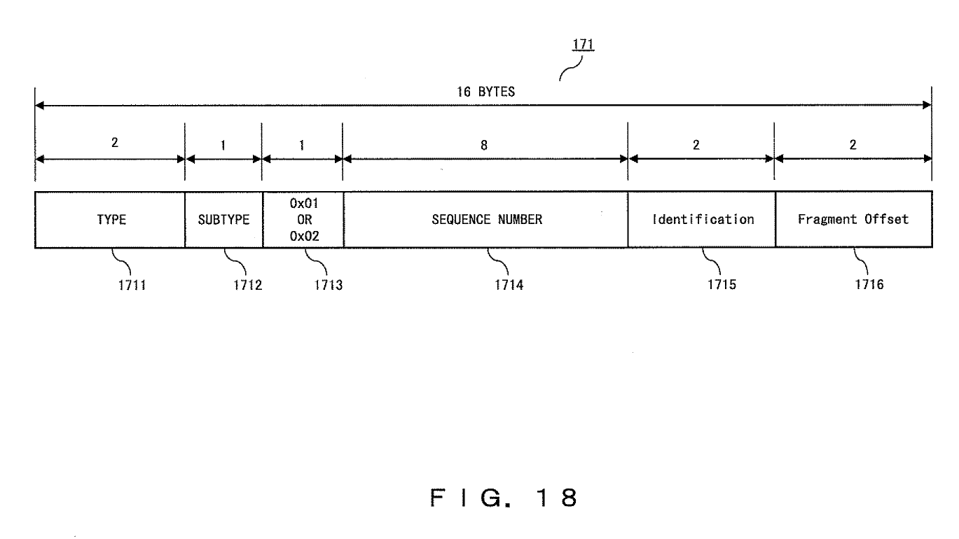

The reserved field 1713 consists of 1 byte reserved for a future use. A usage example is described later in association with FIG. 18.

The sequence number 1714 is the field for storing a sequence number k2_r as a key material. Since the field length of the sequence number 1714 is 8 bytes, i.e., 64 bits, 2⁶⁴ sequence numbers are available. Therefore, even with high-speed lines such as 1 Gbps or 10 Gbps, it takes a tremendously long time for the same sequence number is to be used.

For example, when a cryptographic process module encrypts 1 G pieces of frames per second, it takes,
2⁶⁴/10⁹=1.84×10¹⁰ seconds≅585 years

to return to the same sequence number. Therefore, the sequence number 1714 can be regarded to be essentially unique.

However, it is possible for two or more cryptographic process modules 104 to accidentally use the same value. Given this possibility, it is desirable to set a start value (i.e., an initial value of the key material storage unit 12) of the sequence number randomly in each cryptographic process module 104 to reduce a possibility of two or more cryptographic process modules 104 using the same value accidentally.

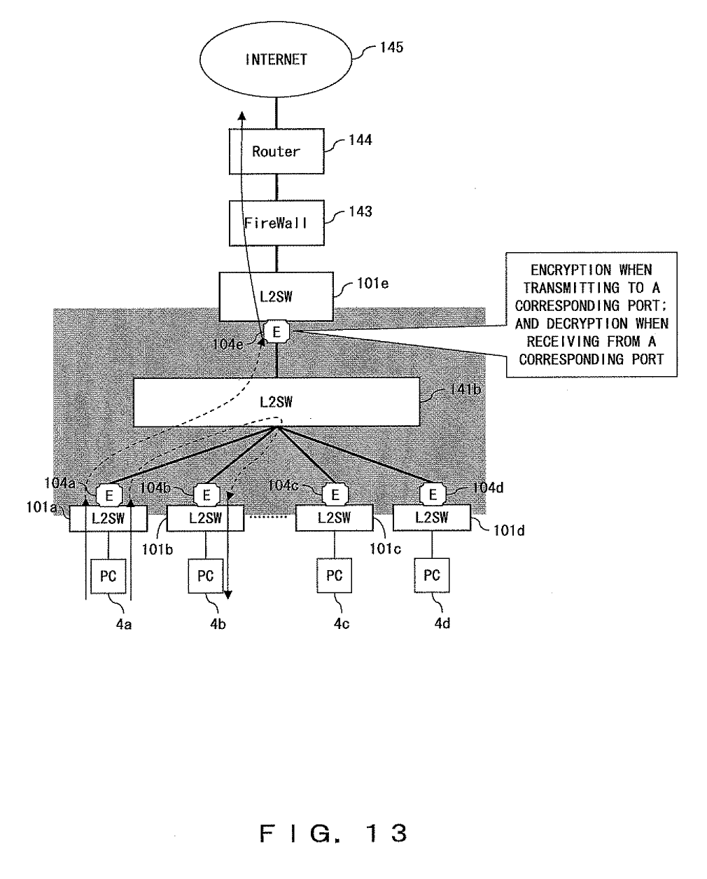

FIGS. 13 through 15 each is a diagram exemplifying a configuration of a network by using the L2 relay apparatus 101 equipped with the symmetric key generation apparatus 1. The L2 relay apparatus 101 is variously different depending on an embodiment where with which port a cryptographic process module (such as 104a) is to be equipped, as shown in FIGS. 7 and 9. Moreover, each cryptographic process module is different depending on a preferred embodiment where the module performs either of encryption or decryption in accordance with the direction of transmitting a frame.

A price of the L2 relay apparatus 101 and a method for configuring a network to accomplish an encrypted communication in Layer 2 differ with a combination of the above variations. That is, the present invention is contrived to enable preferred embodiments in various configurations suitable to a convenience of the user, and therefore is highly flexible.

Note that FIGS. 13 through 15 each omits some constituent components such as a TCG-compliant chip. Also, a plaintext frame and an encrypted frame respectively correspond to the solid line arrow and dotted line arrow. And the range of carrying out an encrypted communication is indicated by mesh shading.

The network configuration shown in FIG. 13 only employs a conventional L2 switch 141b and a low cost L2 relay apparatuses 101a through 101e comprising a cryptographic process module at only one port.

Four PCs 4a through 4d are respectively connected to L2 relay apparatuses 101a through 101d in the configuration shown in FIG. 13. All of the L2 relay apparatuses 101a through 101d are connected to a conventional L2 switch 141b not performing a cryptographic process. And the L2 switch 141b is connected to the L2 relay apparatus 101e. That is, the topology of FIG. 13 is very similar to a one-to-N star switch topology in a physical sense, i.e., the wiring of cables; it is, however, a topology of N-to-N relationship in a logical sense, i.e., a pair carrying out an encrypted communication. That is, since the encrypted communications are carried out in combinations such as a pair of L2 relay apparatuses 101a and 101b a pair of L2 relay apparatuses 101a and 101c, a pair of L2 relay apparatuses 101a and 101d, a pair of L2 relay apparatuses 101b and 110c, a pair of L2 relay apparatuses 101b and 101d and so on, and therefore the relationship is N-to-N.

The L2 relay apparatuses 101a through 101d are respectively equipped with cryptographic process modules 104a through 104d corresponding to the ports connected to the L2 switch 141b. The other ports are not equipped with a cryptographic process module. The L2 relay apparatus 101e is equipped with a cryptographic process module 104e corresponding to the port connected to the L2 switch 141b, and the other ports of the L2 relay apparatus 101e are not equipped with a cryptographic process module. The L2 relay apparatus 101e is also connected to the firewall 143, and the firewall 143 is connected to a router 144. A communication with an external network such as the Internet 145 is carried out via the router 144.

The L2 relay apparatuses 101a through 101e shown in FIG. 13 can be produced inexpensively since the cryptographic process module is provided only for one port in each of them. In addition, the cryptographic process modules 104a through 104e each encrypts a frame when transmitting it to the corresponding port and decrypts a frame when receiving it from the corresponding port.

Describing it in relation with FIG. 8, if the reception unit 11 receives a frame from the frame relay process unit 102, the judgment unit 15 judges as the first stage (i.e., a stage for encryption), the symmetric key generation unit 14 generates a symmetric key k and the encryption unit 16 encrypts the frame. On the other hand, if the reception unit 11 receives a frame from the corresponding port 103, the judgment unit 15 judges as the second stage (i.e., a stage for decryption), the symmetric key generation unit 14 generates a symmetric key k and the decryption unit 17 decrypts the frame.

The next is a description of an example of communication in the case of configuring as described above. Referring to FIG. 13r when transmitting a frame 150 shown in FIG. 11 from the PC 4a to PC 4b, the frame 150 is encrypted when it is transmitted via the cryptographic process module 104a. The example shown in FIG. 13 does not utilize a VLAN and therefore an encrypted frame is in the form of the TPID 161 and TCI 162 having been deleted from the encrypted frame 170 shown in FIG. 11.

The encrypted frame is transmitted from the L2 relay apparatus 101a to the L2 switch 141b and relayed to the L2 relay apparatus 101b connected to the PC 4b. The MAC header of the encrypted frame is not encrypted, and therefore the L2 switch 141b can relay it in the same manner as a normal frame 150 without carrying out a process related to cryptography.

The encrypted frame is received at the L2 relay apparatus 101b and decrypted when the encrypted frame is transmitted via the cryptographic process module 104b comprised by the L2 relay apparatus 101b. The decrypted frame is relayed by a frame relay process unit comprised by the L2 relay apparatus 101b to a port that is connected to the PC 4b, followed by being transmitted to the PC 4b from the port.

The next is a description of an example of transmitting an IP packet from the PC 4a to the Internet 145 in the configuration of FIG. 13. A frame corresponding to the IP packet is transmitted from the PC 4a to the L2 relay apparatus 101e by way of the L2 relay apparatus 101a and L2 switch 141b.

The path from the PC 4a to the L2 switch 141b is exactly the same as the above example. The L2 switch 141b relays the received encrypted frame in a similar manner as the normal frame and transmits the encrypted frame to the L2 relay apparatus 101e which comprises a cryptographic process module 104e corresponding to a port that is connected to the L2 switch 141b. The encrypted frame is decrypted to be a plaintext frame when it is transmitted via the cryptographic process module 104e, and the plaintext frame is transmitted to the firewall 143 by way of a frame relay process unit (not shown herein).

As described above, the configuration of FIG. 13 enables encryption of a communication on the Ethernet. Also enabled is that there is no need to change a configuration of an existing firewall 143 or router 144 because the frame transmitted from the L2 relay apparatus 101e to the firewall 143 is a decrypted plaintext frame.

Incidentally, the cryptographic process modules 104a through 104e in the configuration of FIG. 13 are premised to be configured to invariably perform either of an encryption process or a decryption process. That is, the judgment unit 15 (refer to FIG. 8) judges as either of the first stage or second stage and never judges as any other stage. Comparably, the cryptographic process modules 104a and 104b in the configuration of FIGS. 10A and 10B are configured to judge a necessity or not of a cryptographic process and carry out no process for a frame corresponding to the VLAN 130 as described above. That is, the judgment unit 15 judges to be either of the first, second or third stage. Although the present invention can be embodied by either configuration, an embodiment not judging for the necessity or not of cryptographic process as FIG. 13 simplifies and speeds up the process, and it makes implementation by hardware easier.

In FIG. 13, if the cryptographic process module 104a through 104d (particularly the judgment units 15 therein) are configured to judge a necessity or not of cryptographic process, the L2 relay apparatus 101e is not necessary because there is no need to perform a decryption process at the cryptographic process module 104e for a communication with the Internet 145. In this case, however, if a VLAN is not used, an operation is necessary such as the cryptographic process module 104a or the like judging a necessity or not of a cryptographic process based on a destination MAC address 151 for example.

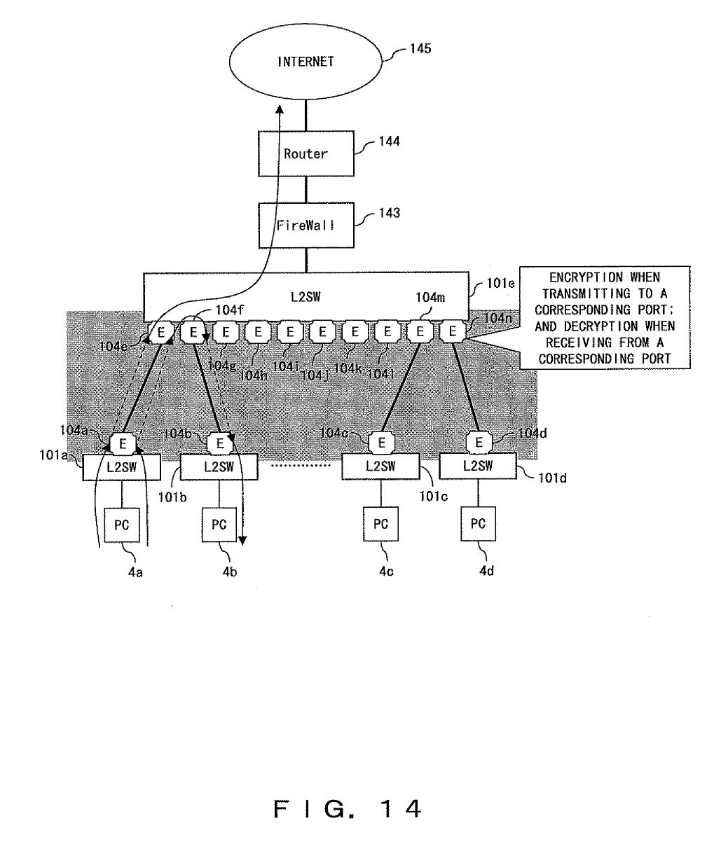

A network configuration shown in FIG. 14 employs inexpensive L2 relay apparatuses 101a through 101d each of which comprises a cryptographic process module at one port and an expensive L2 relay apparatus 101e comprising cryptographic process modules at a plurality of ports.

Major difference between FIGS. 13 and 14 is that the L2 switch 141b that is necessary for FIG. 13 is now not necessary for FIG. 14. Instead, the configuration of FIG. 14 requires an expensive L2 relay apparatus 101e comprising cryptographic process modules at a plurality of ports.

Likewise FIG. 13, the network configuration of FIG. 14 is also a 1-to-N star switch topology in a physical sense, i.e., the cable wiring; it is, however, a topology of N-to-N relationship in a logical sense, i.e., pairs engaged in encrypted communications.

Referring to FIG. 14, four PCs 4a through 4d are respectively connected to the L2 relay apparatuses 101a through 101d. The L2 relay apparatuses 101a through 101d are all connected to the L2 relay apparatus 101e. The L2 relay apparatuses 101a through 101d are respectively equipped with the cryptographic process modules 104a through 104d corresponding to the ports connected to the L2 relay apparatus 101e. The other ports are not equipped with a cryptographic process module. The L2 relay apparatus 101e is equipped with cryptographic process modules for a plurality of ports. Specifically, the cryptographic process modules 104e through 104n are respectively provided corresponding to a plurality of ports connected to the L2 relay apparatuses 101a through 101d as shown in FIG. 14. The L2 relay apparatus 101e is also connected to the firewall 143 that is in turn connected to the router 144. A communication with an external network such as the Internet 145 is carried out via the router 144.

Each of the cryptographic process modules 104a through 104n shown in FIG. 14 encrypts a frame when transmitting it to the corresponding port and decrypts a frame when receiving it from the corresponding port.

That is, describing in correspondence with FIG. 8, if the reception unit 11 receives a frame from the frame relay process unit 102, the judgment unit 15 judges as the first stage (i.e., the stage for encryption), the symmetric key generation unit 14 generates a symmetric key k, and the encryption unit 16 encrypts the frame. Contrarily, if the reception unit 11 receives a frame from the corresponding port 103, the judgment unit 15 judges as the second stage (i.e., the stage for decryption), the symmetric key generation unit 14 generates a symmetric key k, and the decryption unit 17 decrypts the frame.

The next is a description of the case of transmitting a frame from the PC 4a to PC 4b by referring to FIG. 14. The L2 relay apparatus 101a shown in FIG. 14 is configured similar to the L2 relay apparatus 101a of FIG. 13.

First, a frame 150 of FIG. 11 is transmitted from the PC 4a. The frame 150 is encrypted when it is transmitted via the cryptographic process module 104a of the L2 relay apparatus 101a. The encrypted frame is transmitted from the L2 relay apparatus 101a to the L2 relay apparatuses 101e and decrypted when it is transmitted via the cryptographic process module 104e. The decrypted frame is relayed from the cryptographic process module 104e to the cryptographic process module 104f by way of a frame relay process unit (not shown herein), and once again encrypted in the cryptographic process module 104f. The encrypted frame is transmitted from a port corresponding to the cryptographic process module 104f to the L2 relay apparatus 101b. The frame received at the L2 relay apparatus 101b is decrypted when it is transmitted via the cryptographic process module 104b and transmitted to the PC 4b.

The next is a description of an example of transmitting an IP packet from the PC 4a to the Internet 145 in the configuration of FIG. 14. A frame corresponding to the IP packet is transmitted from the PC 4a to the L2 relay apparatus 101e by way of the L2 relay apparatus 101a.

The path from the PC 4a to the L2 relay apparatus 101e and the fact of the frame being decrypted when it is transmitted via the cryptographic process module 104e are exactly the same as the example described above. After that, the decrypted frame is relayed to a port 103 connected to the firewall 143 by way of a frame relay process unit (not shown herein) and transmitted to the firewall 143.

The configuration shown in FIG. 14, while requiring an expensive apparatus such as the L2 relay apparatus 101e, makes it possible to configure a network by a smaller number of apparatus than the number for FIG. 13 and encrypt a communication on the Ethernet. Besides, the frame transmitted from the L2 relay apparatus 101e to the fire wall 143 is a decrypted plaintext frame, and therefore a change in a configuration of an existing firewall 143 or router 144 is not necessary.

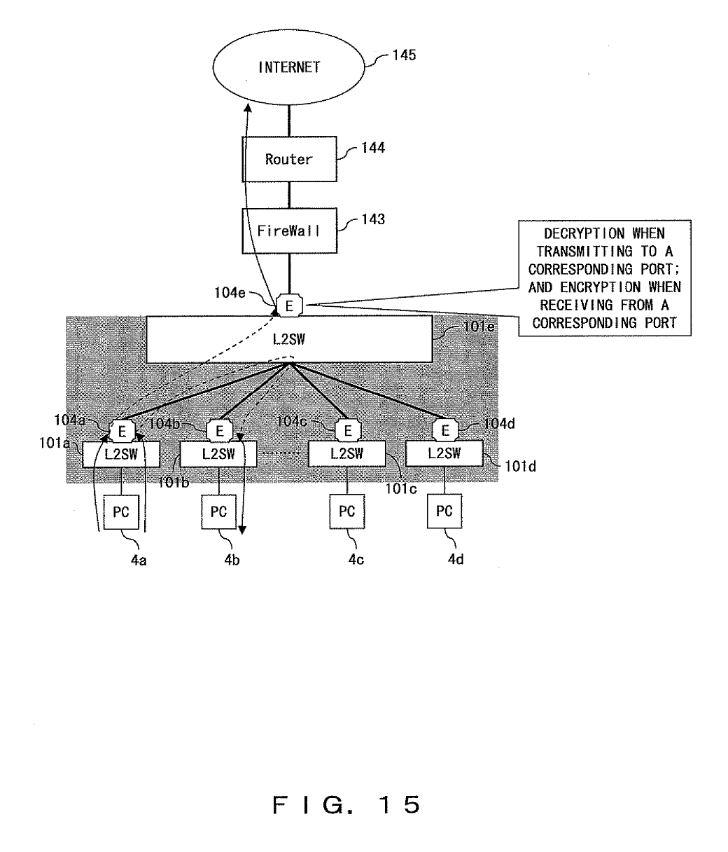

A network configuration shown in FIG. 15 uses only inexpensive L2 relay apparatuses 101a through 101e comprising a cryptographic process module only at one port. FIG. 15 is similar to FIG. 14 except where the specific configuration of the L2 relay apparatuses 101e is different from that of FIG. 14.

The configuration of FIG. 15 provides the advantages of one less apparatus than the configuration of FIG. 13 (that is, L2 switch 141b is not necessary) and inexpensive apparatus than that of FIG. 14 (that is, while the L2 relay apparatus 101e of FIG. 14 is expensive, that of FIG. 15 is inexpensive). The reason for such a configuration being possible is that the configuration employs a cryptographic process module 104e decrypting a frame when transmitting it to a corresponding port and encrypting a frame when receiving it from a corresponding port, unlike the configurations shown in FIGS. 13 and 14.

That is, describing it in correlation with FIG. 8, if the reception unit 11 receives a frame from the frame relay process unit 102, the judgment unit 15 judges as the second stage (i.e., the stage for decryption), the symmetric key generation unit 14 generates a symmetric key k, and the decryption unit 17 decrypts the frame at the cryptographic process module 104e. Contrarily, if the reception unit 11 receives a frame from a corresponding port 103, the judgment unit 15 judges as the first stage (i.e., the stage for encryption), the symmetric key generation unit 14 generates asymmetric key k, and the encryption unit 16 encrypts the frame.

The next is a description of the case of transmitting a frame from the PC 4a to PC 4b for example by referring to FIG. 15. The event that a frame 150 transmitted from the PC 4a is encrypted by the cryptographic process module 104a of the L2 relay apparatus 101a and a transmission of the encrypted frame to the L2 relay apparatus 101e are the same as in the case of FIG. 14.

The encrypted frame is relayed in the state of being encrypted in the inside of the L2 relay apparatus 101e and then transmitted to the L2 relay apparatus 101b. Then the encrypted frame is received at the L2 relay apparatus 101b and decrypted when it is transmitted via the cryptographic process module 104b. The decrypted frame is relayed by a frame relay process unit (not shown herein) and transmitted to the PC 4b. The difference between FIG. 15 and FIG. 14 is that the L2 relay apparatus 101e does not perform any process related to cryptography when transmitting a frame from the PC 4a to PC 4b in the configuration of FIG. 15.

The next is a description of an example of transmitting an IP packet from the PC 4a to the Internet 145 in the configuration of FIG. 15. A frame corresponding to the IP packet is transmitted from the PC 4a to the L2 relay apparatus 101e by way of the L2 relay apparatus 101a.

The path from the PC 4a to L2 relay apparatus 101e is exactly the same as the example described above. After that, the encrypted frame received by the L2 relay apparatus 101e is relayed by way of a frame relay process unit (not shown herein) in the state of being encrypted, followed by being transmitted via the cryptographic process module 104e that decrypts the encrypted frame in this event, and transmits the decrypted plaintext frame to the firewall 143.

The configuration shown in FIG. 15 enables a configuration of a network by employing a fewer number of apparatuses than the configuration of FIG. 13 and also only inexpensive apparatuses than that of FIG. 14, and encryption of a communication on the Ethernet. Since the configuration of FIG. 15 employs a fewer number of apparatuses than that of FIG. 13, it provides not only a superior cost performance but also a lower occurrence rate of failures. The reason is that a failure of the L2 switch 141b brings about a failure of the entirety of the network in the configuration of FIG. 13; whereas that of FIG. 15 does not employ an L2 switch 141b. Besides, the frame transmitted from the L1 relay apparatus 101e of FIG. 15 to the firewall 143 is a decrypted plaintext frame, and therefore a change in a configuration of an existing firewall 143 or router 144 is not necessary.

As described above, there are two kinds of cryptographic process modules in terms of carrying out either of an encryption process or decryption process depending on the direction of transmitting and receiving a frame. In other words, in the symmetric key generation apparatus 1c shown in FIG. 8, the aspect of the judgment unit 15 judging as the first stage or second stage based on what condition is different in accordance with a preferred embodiment. That is, the aspect of the judgment unit 15 judging as either of the first stage or second stage when the reception unit 11 receives a frame from the port 103 in FIG. 8 is different in accordance with a preferred embodiment.

Meanwhile, the examples shown by FIGS. 13, 14 and 15 do not consider a use of a VLAN, and therefore the judgment unit 15 judges as one of the first stage or second stage without an exception. Depending on an environment utilizing a VLAN, however, the judgment unit 15 may sometimes judges as the third stage (i.e., the stage not requiring encryption or decryption and hence not needing to generate a symmetric key k). Therefore, various preferred embodiments are possible in the aspect of what condition the judgment unit 15 judges a stage based on and how many stages it judges by selecting one.

The aspect of an individual cryptographic process module performing either of an encryption process or decryption process depending on the direction of transmission and reception of a frame is discretionarily selectable. A configuration may be in a manner that an administrator for example inputs a setup to a L2 relay apparatus 101 so that the CPU 106 sets the content in an individual cryptographic process module 104. Therefore, a user is enabled to select an appropriate configuration in accordance with individual embodiment from various configurations as described for FIGS. 13 through 15 and set the operations of the cryptographic process modules 104 suitable to the selection.

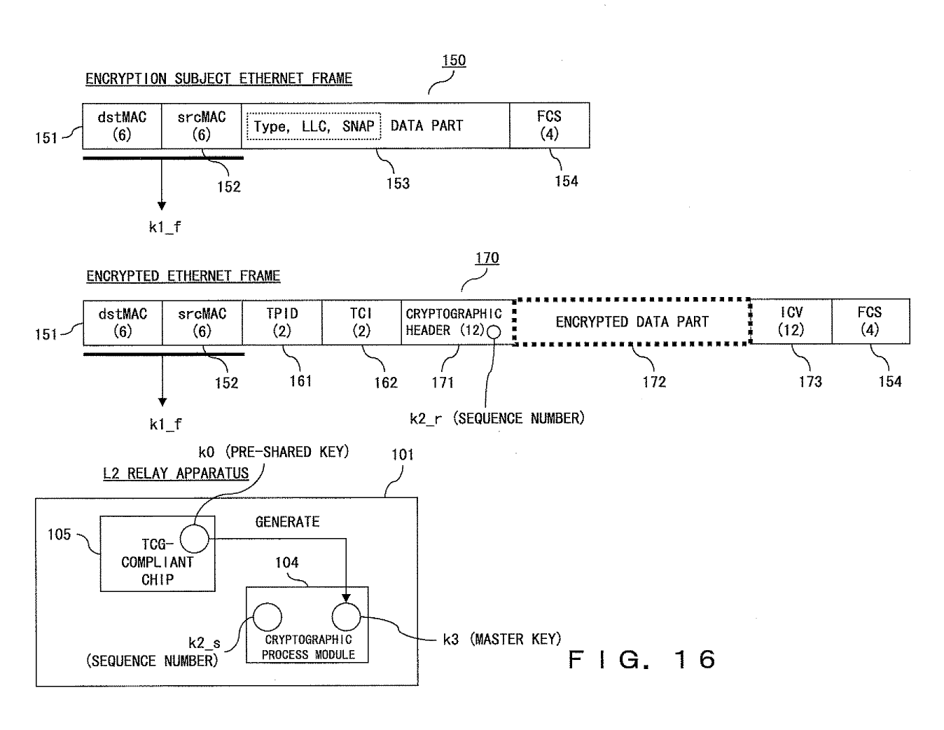

FIG. 16 is a diagram showing a more specific example of various pieces of information utilized for generating a symmetric key k shown in FIG. 4. FIG. 16 shows an event of generating a symmetric key k by utilizing three kinds of information, i.e., MAC header information k1_f, the sequence number k2_n and a master key k3. Note that the example shown in FIG. 16 is applied to the symmetric key generation apparatuses provided in the L2 relay apparatuses shown in FIGS. 7 through 15.

FIG. 16 shows the frame 150 and encrypted frame 170 that are similar to FIG. 11 and also an excerpt of a particular part, of the L2 relay apparatus 101, related to the information utilized for generating a symmetric key k.

Referring to FIG. 16, a pre-shared key k0 is preset in the L2 relay apparatus 101 by an administrator for example. A password consisting of alpha-numeric within eight characters may be used as a pre-shared key k0 so as to make it easy for a manual setup.

Comparing FIGS. 6 and 16, each of the relay apparatuses 2a and 2b in FIG. 6 is embodied as the L2 relay apparatus 101 in FIG. 16. As described in association with FIG. 6, a pre-shared key k0 of the same value must be set in two relay apparatuses 2a and 2b because the master key k3 must be the same value in the two relay apparatuses 2a and 2b carrying out an encrypted communication. An algorithm for generating the master key k3 from the pre-shared key k0 must be apparently the same between the two relay apparatuses 2a and 2b, That is, the same master key k3 must be uniquely generated from the same pre-shared key k0 regardless of a difference between the individual relay apparatuses 2a and 2b.

The set pre-shared key k0 is stored in the TCG-compliant chip 105 as shown in FIG. 16. This makes it impossible to read the pre-shared key k0 fraudulently from the outside.

Note that a combination of relay apparatuses in which pre-shared keys k0 of the same value are to respectively be set is different with preferred embodiment. In a certain preferred embodiment, the same value is set as the pre-shared key k0 in all of the L2 relay apparatuses 101 included in an area in which encrypted communications are carried out. In the example of FIG. 10A, the pre-shared key k0 of the same value is set in both of the L2 relay apparatuses 101a and 101b for example, and in the example of FIG. 15, the pre-shared key k0 of the same value is set in all of the L2 relay apparatuses 101a through 101e.

In another embodiment using VLANs, a different pre-shared key k0 may be set for each of the VLANs. In the example of FIG. 10A, both of the pre-shared key k0 for the VLAN 110 and the pre-shared key k0′ for the VLAN 120 may be set in both of the L2 relay apparatuses 101a and 101b, respectively, for example. Even in this case, it is still the same as in the above embodiment that the same values are set in both of the L2 relay apparatuses 101a and 101b.

MAC header information k1-f is a specific example of the destination/source information k1. In FIG. 16, the MAC header information k1-f is information comprising a destination MAC address 151 and a source MAC address 152. In another embodiment, a MAC header information k1_f may be information based on at least either of the destination MAC address 151 or source MAC address 152. Also possible is to utilize only a part of the destination MAC address 151 and source MAC address 152, in place of the entirety of the two respective addresses.

As is apparently from FIGS. 16 and 11, the MAC header information k1_f can be obtained from the frame 150 or tagged frame 160 that are subject of encryption, or from the encrypted frame 170 as a subject of decryption.

The sequence numbers k2_s and k2_r are specific example of a key material k2. A method for obtaining the key material k2 is different between the first and second stages as described above, the sequence number k2_s corresponds to the first stage and the sequence number k2_r corresponds to the second stage. As is comprehensible from FIGS. 2 and 6, a value of the sequence number k2_s is included in input data (i.e., encrypted frame 170) as a sequence number k2_r. Therefore, when indicating both of the sequence numbers k2_s and k2_r, a sign of “k2_n” is used as a generic term.

The sequence number k2_s is a number managed for each cryptographic process module 104, that is, for each symmetric key generation apparatus 1c of FIG. 8. The sequence number k2_s is stored in the key material storage unit 12 and incremented by one (“1”) by the key material readout unit 13 every time the judgment unit 15 judges as the first stage. The sequence number 1714 shown in FIG. 12 is the sequence number k2_r written to the encrypted frame 170 as input data to the symmetric key generation apparatus 1, and has a data length of 8 bytes.

Therefore, the key material storage unit 12 according to the present embodiment is an 8-byte counter. Note that an initial value of the counter is desirably set up with a random different number for each of the cryptographic process modules 104 as described before.

The master key k3 is generated by the cryptographic process module 104 based on the pre-shared key k0. The master key k3 desirably possesses a longer data length than the pre-shared key k0.

A generation of the master key k3 is carried out for example as follows. When the administrator sets the pre-shared key k0 in the L2 relay apparatus 101, the CPU 106 instructs the cryptographic process module 104 to generate a master key k3, and the master key generation unit 20 comprised by the cryptographic process module 104 generates the master key k3 in accordance with the instruction and stores it in the master key storage unit 21. Alternatively, the cryptographic process module 104 may generate, on the basis of the pre-shared key k0, a master key array C that is the array of candidate values from which a master key k3 is generated. In this case, the master key array C is stored inside the cryptographic process module 104, and the master key k3 is selected from the stored master key array C (to be described in more detail later). In either way, the master key k3 is generated based on the pre-shared key k0. There are several methods for generating the master key k3 from the pre-shared key k0, as described later.

In the example shown in FIG. 16, a symmetric key k is generated based on the MAC header information k1_f, the sequence number k2_n and master key k3. This can be expressed as follows by using a certain function f:

$$\begin{matrix}k = f ( k1\_f , k2\_s , k 3 ) \\ = f ( k1\_f , k2\_r , k 3 ) \\ = f ( k1\_f , k2\_n , k 3 )\end{matrix} \qquad ( 1 )$$

As shown in the expression (1), the first stage (the stage in which a symmetric key k is generated for encryption) and the second stage (the stage in which a symmetric key k is generated for decryption) use the same function f.

Meanwhile, the master key k3 is generated based on the pre-shared key k0 and therefore the following expression is also possible by using certain functions g and f2:

$$\begin{matrix}k = f ( k1\_f , k2\_n , g ( k 0 ) ) \\ = f 2 ( k1\_f , k2\_n , k 0 ) \end{matrix} \qquad ( 2 )$$

That is, the example of FIG. 16 can also be expressed as “a symmetric key k is generated based on the destination/source information k1, key material k2 and pre-shared key k0”. Note that a specific content of the function f is variously different depending on a preferred embodiment as described later.

An operation of the cryptographic process module 104 in the first stage (in which a symmetric key k is generated for encryption) is as described in the following steps s1 through s7.

(s1) The cryptographic process module 104 receives a plaintext frame as a subject of encryption from a corresponding port or frame relay process unit 102. That is, the reception unit 11 within the cryptographic process module 104 receives the plaintext frame as input data;

(s2) The judgment unit 15 judges as the first stage and notifies the key material readout unit 13 and symmetric key generation unit 14 of the fact of being the first stage. Note that a specific condition utilized for the judgment differs with preferred embodiment as described in association with FIGS. 10A, 10B, 13 through 15. The judgment unit 15 makes the judgment by combining one piece or more of information such as from where a frame is received in the step s1, whether the received frame includes a cryptographic header 171, whether an environment uses a VLAN, what a value of the TCI 162 is if a VLAN is utilized;

(s3) The symmetric key generation unit 14 within the cryptographic process module 104 reads MAC header information k1_f from the frame;

(s4) The key material readout unit 13 within the cryptographic process module 104 reads the current sequence number k2_s from the counter (i.e., the key material storage unit 12) and increments a value of the counter by “1”;

(s5) The symmetric key generation unit 14 within the cryptographic process module 104 reads the stored master key k3, or generates a master key k3 based on the pre-shared key k0;

(s6) The symmetric key generation unit 14 within the cryptographic process module 104 generates a symmetric key k, that is:
k=f(k1_{—}f,k2_{—}s,k3)
by using the above described function f; and

(s7) The encryption unit 16 within the cryptographic process module 104 encrypts the frame by using the symmetric key k and writes the readout value in the step s4 as the sequence number k2_r to the cryptographic header 171.

An operation of the cryptographic process module 104 in the second stage (in which a symmetric key k is generated for decryption) is as described in the following steps r1 through r7:

(r1) The cryptographic process module 104 receives an encrypted frame as a subject of decryption from a corresponding port or frame relay process unit 102. That is, the reception unit 11 within the cryptographic process module 104 receives the encrypted frame as input data;

(r2) The judgment unit 15 judges as the second stage. The judgment unit 15 notifies the key material readout unit 13 and symmetric key generation unit 14 of the fact of being the second stage. The aspect of a specific condition utilized for the judgment differing with preferred embodiment is as described for the step s2 above;

(r3) The symmetric key generation unit 14 within the cryptographic process module 104 reads MAC header information k1_f from the frame;

(r4) The key material readout unit 13 within the cryptographic process module 104 reads the sequence number k2_r from a predefined part (i.e., the sequence number 1714) within the cryptographic header 171 of the frame;

(r5) The symmetric key generation unit 14 within the cryptographic process module 104 reads the stored master key k3, or generates a master key k3 based on the pre-shared key k0;

(r6) The symmetric key generation unit 14 within the cryptographic process module 104 generates a symmetric key k, that is:
k=f(k1_{—}f,k2_{—}r,k3)

by using the above described function f. Note that the function f is one in the above step s6; and

(r7) The decryption unit 17 within the cryptographic process module 104 decrypts the frame by using the symmetric key k.

According to FIG. 10A, a k0 of the same value is set for both of the L2 relay apparatuses 101a and 101b for example, the MAC header information k1_f is the same content at the time of transmission and reception of a frame, and a value of the sequence number k2_s stored in the counter (i.e., the key material storage unit 12) is included as the sequence number k2_r in the encrypted frame 170. Therefore the expressions (1) and (2) make it comprehensible that both of the L2 relay apparatuses 101a and 101b respectively generate symmetric keys k of the same value.

The function f is desirably determined appropriately by considering the following points.

The MAC header information k1_f is different for each pair of the source and destination of a frame transmission. Therefore, the MAC header information k1_f is different for communications performed by different pairs of nodes. By using the function f with which a different symmetric key k is generated for a different piece of MAC header information k1_f, the different symmetric key k can be used for the communications between different pairs of nodes, accomplishing a high level of security.

In addition, the sequence number k2_n is a number that increases by one (“1”) with each event of encryption of a frame performed by the cryptographic process module 104 following a judgment as the first stage by the judgment unit 15, and has a sufficient length of data. Therefore, a value of the sequence number k2_n is different for each frame used for communications even between the same pair of nodes. Accordingly, by utilizing the function f with which a different symmetric key k is generated for a different sequence number k2_n, the different symmetric key k is used for each frame, accomplishing a high level of security.

The generation of the symmetric key k as described above results in a different value of the symmetric key k depending on the MAC header information k1_f and the sequence number k2_n. Therefore, a practically different symmetric key k is used for each frame without carrying out a rekey by dynamically exchanging key information in accordance with the IKE or such.

The present invention eliminates a need for dynamically exchanging key information, and therefore an incorporation of a complex protocol is not required. Also, when dynamically exchanging key information, a failure in a single relay apparatus affects the entire network and cuts off the communication, whereas a failure in an L2 relay apparatus 101 does not affect another L2 relay apparatus 101 according to the present invention. Therefore, the use of the symmetric key k generated in the manner described above has the effect of satisfying all of security, scalability and reliability requirements.

Several specific methods for generating the symmetric key k are described below.

The first method for generating the symmetric key k is to use a hash function h as a function f. That is, to apply the expression (3) to the above expression (1).
f(x1,x2,x3)≡h(x1+x2+x3). (3)

In this method, general-purpose fast hash functions such as MD5 (Message Digest Algorithm 5) and SHA-1 (Secure Hash Algorithm-1) can be used as the hash function h. Provided that both of a pair of the cryptographic process modules 104 at the source and destination of an encrypted communication uses the same hash function, any hash function can be used as a hash function h.

The use of the hash function reduces a probability of the same symmetric key k being generated from two different pairs of combinations of (k1_f, k2_n, k3) to a negligible degree. In addition, a distribution of values of the symmetric key k is expected to be uniform and random. That is, the values of the symmetric key k for two consecutive frames are expected to differ greatly from each other. Therefore, even if an encrypted frame is intercepted, it is very difficult to guess the symmetric key k. Moreover, the implementation is easy since the general-purpose hash function that enables a fast calculation can be used.

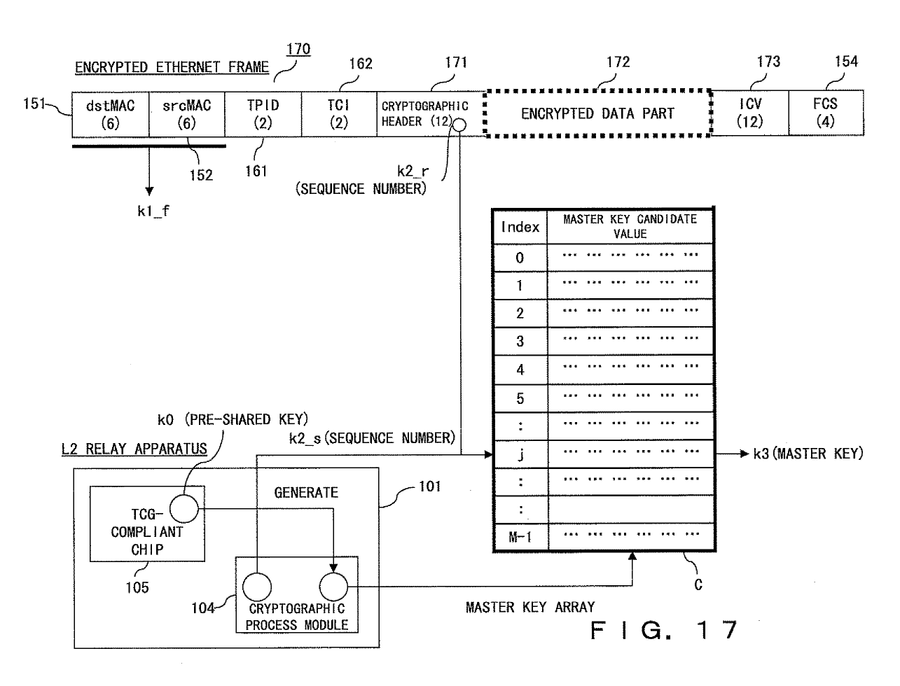

The second method for generating a symmetric key k is to use an array. FIG. 17 is a diagram describing the method in which the above steps s5, s6, r5 and r6 are respectively replaced by the following steps s5-2, s6-2, r5-2 and r6-2:

(s5-2) The symmetric key generation unit 14 within the cryptographic process module 104 reads a master key k3 from the master key array C based on the sequence number k2_s that is read in the step s4.

(s6-2) The symmetric key generation unit 14 within the cryptographic process module 104 generates a symmetric key k as follows:
k=k3XOR(k1+k2_{—}s);

(where “XOR” is an operator expressing an exclusive logical sum).

(r5-2) The symmetric key generation unit 14 within the cryptographic process module 104 reads a master key k3 from the master key array C based on the sequence number k2_r that is read in the step r4.

(r6-2) The symmetric key generation unit 14 within the cryptographic process module 104 generates a symmetric key k as follows:
k=k3XOR(k1+k2_{—}r)

That is, the second method applies the following expression (4) to the expression (1).
f(x1,x2,x3)−x3XOR(x1+x2). (4)

The next is a description on the above step by referring to FIG. 17. In the configuration of FIG. 16, one master key k3 is generated based on the pre-shared key k0, whereas M pieces of values are generated from the pre-shared key k0 and an array of these values is stored as a master key array C in the cryptographic process module 104 according to the configuration of FIG. 17. An alternative configuration may equip a master key array storage unit in place of the master key storage unit 21 and store the master key array C therein.

The following description expresses a value stored with the subscript j in the master key array C as C[j] and refers to a value of each C[0] as a candidate value. That is, the master key array C is an array constituted by M pieces of candidate values C[0] through C[M−1], and an individual candidate value can be represented by the following expression (5):
C[j]=g2(k0,j)(0≦j≦M−1) (5)

In the step s5-2, the remainder j may be calculated as a result of the sequence number k2_s divided by M and a value of C[0] may be read out as a master key k3. The master key k3 can be read in the step r5-2 in the same manner. In this case, the M is a predetermined constant in accordance with a preferred embodiment, and therefore the master key k3 can be expressed as follows, where “mod” is an operator for calculating the remainder:

$$\begin{matrix}k 3 = C [ j ] \\ = C [ k2\_n mod M ] \\ = g 2 ( k 0 , k2\_n mod M ) \\ = g 3 ( k 0 , k2\_n )\end{matrix} \qquad ( 6 )$$

It may of course be appropriate to determine the j by using another method depending on a preferred embodiment so as to read a master key k3 (=C[j]) from the master key array C.

In the steps s5-2 and r5-2, a master key k3 is calculated based on the sequence number k2_n (i.e., k2_s or k2_r), resulting in using different master keys k3 for two consecutive encrypted frame, and therefore different symmetric keys k are used. Also, in order to make it difficult to guess the symmetric key k even if an encrypted frame is intercepted, the master key array C is desirably to be generated by using a method in which the generated bit strings of C[i] and C [i+1] are not similar to each other, and an M is desirably to be given an adequately large value (e.g., 256).

The second method uses, as the function f, a simple function that enables a faster calculation than the hash function. That is, the calculation of the function f only requires operations of an arithmetic addition and exclusive logical sum as shown in the steps s6-2 and r6-2.

Therefore, the second method takes both the security and the calculation speed of the symmetric key k into consideration, and is suitable to a Gbps-class high-speed communications.

In an environment using the VLANs as shown in FIG. 10A, a variation of the above first and second methods can be adopted. In the example of FIG. 10A, the same master key k3 may be used in the VLAN 110 and VLAN 120 for example, or different master keys k3 and k3′ may also be used. In the latter case, an administrator sets, in the L2 relay apparatus 101a, pre-shared keys k0 and k0′ respectively corresponding to the VLAN 110 and VLAN 120 which are subjects of encryption so that the cryptographic process module 104a generates a master key k3 from the pre-shared key k0 and generates a master key k3′ from the pre-shared key k0′. The administrator sets the pre-shared keys k0 and k0′ also in the L2 relay apparatus 101b in the same manner for instructing the cryptographic process module 104b to generate the master keys k3 and k3′. This is the variation of the first method. The second method can be modified in the same manner. That is, the cryptographic process modules 104a and 104b respectively generate two sets of the master key arrays C and C′ from the two pre-shared keys k0 and k0′ corresponding to the VLAN 110 and VLAN 120 respectively. A cryptographic process of a frame corresponding to the VLAN 110 uses the master key array C, and the cryptographic process of a frame corresponding to the VLAN 120 uses the master key array C′.

The next is a description on several methods for generating a master key k3 from the pre-shared key k0. Different methods for generating the master key k3 from the pre-shared key k0 generate different symmetric keys k from the same pre-shared key k0, MAC header information k1_f, and sequence number k2_n.

The first method for generating a master key k3 from the pre-shared key k0 is to use a function r that generates a random byte string. The function r is provided with a seed as an argument. The function r returns the same result for the same seed.

In a preferred embodiment according to the first method, firmware in the L2 relay apparatus 101 defines a unique character string (named as “firm character string” and represented by the symbol “fs” hereinafter), and the cryptographic process module 104 (which is more specifically the master key generation unit 20 comprised therein) is enabled to refer to the firm character string fs. That is, all the cryptographic process modules 104 comprised in a plurality of L2 relay apparatuses 101 in which the same firmware is incorporated are enabled to refer to the same firm character string fs. The firm character string fs is only known by, for example, the manufacturer who designed the firmware and built it into the L2 relay apparatus 101, and is kept secret from the user of the L2 relay apparatus 101.

In addition, the premise is that the cryptographic process modules (e.g., 104a and 104b shown in FIG. 10A) used at the source and destination of an encrypted frame are equipped with the same firmware and are capable of using the same function r according to the present embodiment.

The seed to be given to the function r is calculated on the basis of the firm character string fs and pre-shared key k0. The seed may be a concatenation of the firm character string fs and pre-shared key k0 as a character string for example, or the exclusive logical sum may be calculated as the seed from the bit strings of the firm character string fs and pre-shared key k0. That is, it is possible to generate the master key k3 based on the following expressions (7) or (8) (where “&” is an operator concatenating a bit string):
k3=g(k0)=r(fs&k0). (7)
k3=g(k0)=r(fs XOR k0). (8)

For example, suppose that the length of a master key k3 to be calculated is defined as N bytes. If the function r is the one that returns a value that is N-byte long, then the master key k3 can be obtained by giving, as the argument of the function r, the seed that is calculated in the above described manner on the basis of the firm character string fs and pre-shared key k0.

Alternatively, if the function r is defined as the one returning a value that is a 1-byte long, N pieces of random byte values may be generated and concatenated in order to obtain a master key k3 of N bytes. In this case, N pieces of seeds are generated using the N pieces of different values (named as “index values” hereinafter) and the N pieces of random byte values are generated using the N pieces of seeds. The index value may be, for example, either an integer between 1 and N, or another number. If the index value is an integer between 1 and N, the j-th seed is generated on the basis of the firm character string fs, pre-shared key k0, and j (where 1≦j≦N). A master key k3 can be represented by the following expression (9) by using, for example, an appropriate function s for generating a seed:
k3=r(s(fs,k0,1))&r(s(fs,k0,2))& . . . &r(s(fs,k0,N)) (9)

As has been described including several modified examples, the first method enables a generation of the same master key k3 by setting the same pre-shared key k0 at the source and destination of an encrypted frame. The seed used for generating the master key k3 is calculated on the basis of the firm character string fs that is kept secret from the users of the L2 relay apparatus 101 and the pre-shared key k0 that is only known to the administrator. Therefore, even if a general-purpose library function is used as the function r, it is very difficult to guess the master key k3 from the outside, and the master key k3 can be securely generated.

The second method for generating a master key k3 from the pre-shared key k0 is to use a hash function h. The hash function h always produces the same hash value for the same argument.

The second method is similar to the first method except that the hash function h is used in place of the function r. In the second method, the argument of the hash function h is a value calculated on the basis of the firm character string fs and pre-shared key k0, and the hash value obtained as a result is the master key k3. A master key k3 may also be generated by using the following expression (10) or (11) for example:
k3=g(k0)=h(fs&k0) (10)
k3=g(k0)=h(fs XOR k0) (11)

The bit arrangement of the master key k3 is irregular due to the use of a hash function in the second method. Also, the master key k3 is calculated on the basis of the firm character string fs and pre-shared key k0. Therefore, even if a general-purpose library function (such as MD5 and SHA-1) is used as the hash function h, it is very difficult to guess the master key k3 from outside, and the master key k3 can be securely generated.

Incidentally, the first and second methods for generating a master key k3 from the pre-shared key k0 can also be applied to an embodiment that uses the master key array C as shown in FIG. 17 by modifying the first and second methods.

The first method for generating a master key array C from the pre-shared key k0 is similar to the first method f or generating a master key k3 from the pre-shared key k0. However, the former differs in which when the length of a master key k3 is defined as N bytes, a single master key k3 of the N-byte long is not generated but an M-piece of candidate values with each being the N-byte long is generated and stored as C[G] through C[M−1].

If the function r is for example defined as the one returning a value that is N-byte long, an M-piece of random values may be generated and stored as candidate values. In this case, the above expression (5) is modified as follows:

$$\begin{matrix}C [ j ] = g 2 ( k 0 , j ) \\ = r ( s ( fs , k 0 , j ) ) ( where 0 \leq j \leq M - 1 )\end{matrix} \qquad ( 12 )$$

Alternatively, if the function r is defined as the one returning a value that is 1-byte long, N×M pieces of random byte values are generated. Then, an M-piece of the candidate values may be obtained by concatenating N pieces of the generated random byte values to generate each candidate value of the N-byte long. And then, the candidate values are stored as C[0] through C[M−1]. In this case, N×M pieces of seeds are generated by using N×M pieces of index values and the seeds are used as the argument of the function r. If for example an integer between 1 and N×M is used as an index value, the above expression (5) is modified as follows:

$$\begin{matrix}C [ j ] = g 2 ( k 0 , j ) \\ = r ( s ( fs , k 0 , N \times j + 1 ) ) \& \\ r ( s ( fs , k 0 , N \times j + 2 ) ) \& ... \& \\ r ( s ( fs , k 0 , N \times j + N ) )\end{matrix} \qquad ( 13 )$$

According to this method, even if a general-purpose library function is used as the function r, it is very difficult to guess the content of the master key array C from outside. Therefore, the security of the master key k3 that is selected from the master key array C is also maintained.

The second method for generating a master key array C from the pre-shared key k0 is similar to the second method for generating a master key k3 from the pre-shared key k0. However, the former differs in which one master key k3 is not generated but M pieces of candidate values are generated and stored as C[0] through C[M−1].

In this method, M pieces of index values are used to generate M pieces of candidate values. If the index values are integers between 1 and M for example, the j-th candidate value, that is, C[j−1], is a hash value obtained by using the value calculated on the basis of the firm character string fs, pre-shared key k0, and j as the argument of the hash function h (where 1≦j≦M). A master key array C may be generated by substituting the following expression (14) or (15) for the expression (5), or the master key array C may be generated by another method:

$$\begin{matrix}\begin{matrix}C [ j - 1 ] = g 2 ( k 0 , j - 1 ) \\ = h ( fs \& k 0 \& ( j - 1 ) )\end{matrix} & ( 14 ) \\ \begin{matrix}C [ j - 1 ] = g 2 ( k 0 , j - 1 ) \\ = h ( fs XOR k 0 XOR ( j - 1 ) )\end{matrix} & ( 15 )\end{matrix}$$

According to this method, even if a general-purpose library function is used as the hash function h, it is very difficult to guess the content of the master key array C from outside. Therefore, the security of the master key k3 that is selected from the master key array C is also maintained. Also, each candidate value stored as C[0] through C[M−1] has an irregular bit arrangement due to the use of the hash function. Accordingly, it is difficult to guess the master key k3 even if an encrypted frame is intercepted. The security of the master key k3 is thus maintained.

The next is a description on division and reassembly of a frame by referring to FIG. 18. The L2 relay apparatus 101 in a preferred embodiment comprises the function of dividing an encrypted frame 170 and reassembling the original single frame from a plurality of divided frames. This function is referred to as the “fragmentation function” and the divided encrypted frame 170 is referred to as a “fragment frame” hereinafter. FIG. 18 describes the format of the cryptographic header 171 for implementing the fragmentation function.

Generally, the maximum frame length defined by the Ethernet standard is 1518 bytes, and the maximum frame length of the tagged frame defined by the IEEE 802.1Q (VLAN) standard is 1522 bytes, as described above. Also, a data size of encrypted data is generally larger than plaintext data. Moreover, an encrypted frame 170 comprises a cryptographic header 171. Therefore, if the data part 153 of a frame 150 or of a tagged frame 160 is encrypted, the size of the encrypted frame 170 can possibly exceed the maximum frame length mentioned above.

Many of the commercially available Layer 2 relay apparatuses are capable of setting the maximum frame length to more than 1518 bytes or 1522 bytes. Therefore, in a network with a mingling of the L2 relay apparatus 101 and a conventional relay apparatus, an encrypted frame 170 exceeding the length of 1522 bytes can be transmitted and received by modifying the setting of the conventional relay apparatus. In the example of FIG. 10A, when an encrypted frame 170 exceeding the length of 1522 bytes is transmitted from the L2 relay apparatus 101a to the L2 relay apparatus 101b, the encrypted frame 170 reaches the L2 relay apparatus 101b via the core L2/L3 switch 141 provided that the maximum frame length is appropriately set in the core L2/L3 switch 141.

Therefore, in the case in which settings of a relay apparatus can be discretionarily modified, such as the case where a company uses a network independently configured by the company as an office LAN for its own use, the use of the L2 relay apparatus 101 is faced with few problems. However, if an Ethernet network provided by a telecommunication carrier is used, users are not always enabled to modify the settings of the relay apparatuses as they like. In such a case, an encrypted frame 170 cannot possibly be transmitted using the L2 relay apparatus 101 due to a limitation of the maximum frame length.

Accordingly, it is desirable for the L2 relay apparatus 101 to comprise a fragmentation function. In the embodiment shown in FIG. 18, the L2 relay apparatus 101 comprises the fragmentation function, and the cryptographic header 171 is in the format in accordance with the function. By using the L2 relay apparatus 101 having the fragmentation function, an encrypted frame 170 exceeding a maximum frame length specified for a conventional relay apparatus can be transmitted and received even if a network path includes such a conventional relay apparatus.

The cryptographic process module 104 specifically operates as follows in order to implement the fragmentation function. First, an encrypted frame 170 of which the size is increased as a result of encryption is divided into a plurality of fragment frames. Second, whether the received frame is a fragment frame or an undivided encrypted frame 170 is judged. Third, if the frame is judged to be a fragment frame, all fragment frames are received and restored to a single encrypted frame 170, and the restored encrypted frame 170 is decrypted.

Comparing between the cryptographic headers 171 shown in FIGS. 18 and 12, the difference is that the value of the reserved field 1713 is specified as 0x01 or 0x02, and the two fields, namely, a 2-byte of ID (Identification) 1715 and a 2-byte of fragment offset 1716 are added for the configuration of FIG. 18.

In the present embodiment, the value of the reserved field 1713 being 0x01 or 0x02 indicates that the cryptographic header 171 is extended to 16 bytes, as in FIG. 18. And the value of the reserved field 1713 being 0x00 indicates that the cryptographic header 171 is 12 bytes, as shown in FIG. 12. Therefore, the cryptographic process module 104 can judge the range of the cryptographic header 171 by the value of the reserved field 1713 in a received encrypted frame.

The value of the reserved field 1713 in an undivided encrypted frame 170 is 0x00. If a single encrypted frame 170 is divided into n pieces of fragment frames, the value of the reserved field 1713 is 0x01 in the first to (n−1)-th fragment frames, and the value is 0x02 in the n-th fragment frame.

The ID 1715 is the field indicating an identification number that is assigned to each undivided encrypted frame 170. In the present embodiment, a random value is generated to be used as the ID 1715. If a single encrypted frame 170 is divided into n pieces of fragment frames, the value of the ID 1715 is the same among the n pieces of fragment frames.

The fragment offset 1716 is provided with a value indicating what number a fragment frame is in the order of bytes from the head.

The next is a description on an operation of the cryptographic process module 104 for implementing the fragmentation function by using such a cryptographic header 171.

The cryptographic process module 104 operates as follows when performing encryption. First, it judges whether or not the data length of the encrypted frame 170 exceeds the maximum frame length (1518 bytes in a common Ethernet; 1522 bytes in a VLAN environment). If it exceeds the maximum frame length, the encrypted frame 170 is divided into a plurality of fragment frames. In this event, a random value is generated and copied to the ID 1715 of each fragment frame. Also, the values of fragment offset 1716, ICV 173 and FCS 154 are calculated for each fragment frame.

The cryptographic process module 104 operates as follows when it receives a frame containing the cryptographic header 171. First, the value of the reserved field 1713 is checked. If the value is 0x00, the received frame is determined to be an undivided encrypted frame, and the encrypted frame is decrypted. If the value of the reserved field 1713 is 0x01, the received frame is determined to be either of the first, the second through the (n−1)-th fragment frame from among the divided n pieces thereof, and the contents of the fragment frame are temporarily stored in a buffer. If the value of the reserved field 1713 is 0x02, the received frame is determined to be the n-th fragment frame from among the divided n pieces of fragment frames and is combined with the first through (n−1)-th fragment frames stored in the buffer to reassemble the original encrypted frame, and the reassembled encrypted frame is decrypted. The reassembly is performed while checking whether or not the ID 1715 is the same value in all of the n pieces of fragment frames, and whether or not the reassembly can be carried out compatibly with the values of the fragment offset 1716. Also, not all of the fragment frames may be received, depending on the condition of the communication path. If all the fragment frames cannot be collected for the reassembly within a predetermined time period, the buffer is cleared.

The next is a description on the case of applying the present invention to the IPsec by referring to FIGS. 19 through 28. Note that the fundamental principle of generating a symmetric key is similar to the case of encrypting a Layer 2 communication and therefore the description is properly omitted.

FIG. 19 is a diagram showing an encrypted communication carried out in a network including a relay apparatus comprising a symmetric key generation apparatus according to the present invention and a format of an IP packet. In the configuration of FIG. 19, the symmetric key generation apparatuses 1a and 1b according to the present invention are incorporated as respective parts of routers 201a and 201b that are Layer 3 relay apparatuses for utilizing in order to encrypt an IP packet by means of the IPsec. The present embodiment is configured to utilize a large part of the mechanism of the existing IPsec.

The next is a brief description on the IP and IPsec prior to a description of FIG. 19.

The IP is a representative protocol of Layer 3 and widely used for the Internet along with TCP (Transmission Control Protocol) that is a protocol for a transport layer (Layer 4). Relay apparatuses used for the Layer 3 communication by the Layer 3 protocol such as IP include L3 (Layer 3) switch and router. Data is transmitted and received by the unit of “packet” (also called a datagram) in the Layer 3 communication.

In order to transmit an IP packet 250 on a physical medium, a frame must be formed by encapsulating the packet. That is, necessary to add the destination MAC address 151, source MAC address 152 and the length/type of a part of the data part 153 which are shown in FIG. 11 (and adding the LLC header and/or SNAP header in some cases) as a frame header at the head of the IP packet 250, and also the FCS 154 of FIG. 11 as a frame trailer at the end of the IP packet 250. Therefore a specific example of the data part 153 (i.e., a part excluding the length/type and such, to be precise) of the frame 150 is an IP packet 250 for example. Since FIGS. 19 through 28 focus on a Layer 3 communication, the description here concentrates on a pre-encapsulation IP packet 250.

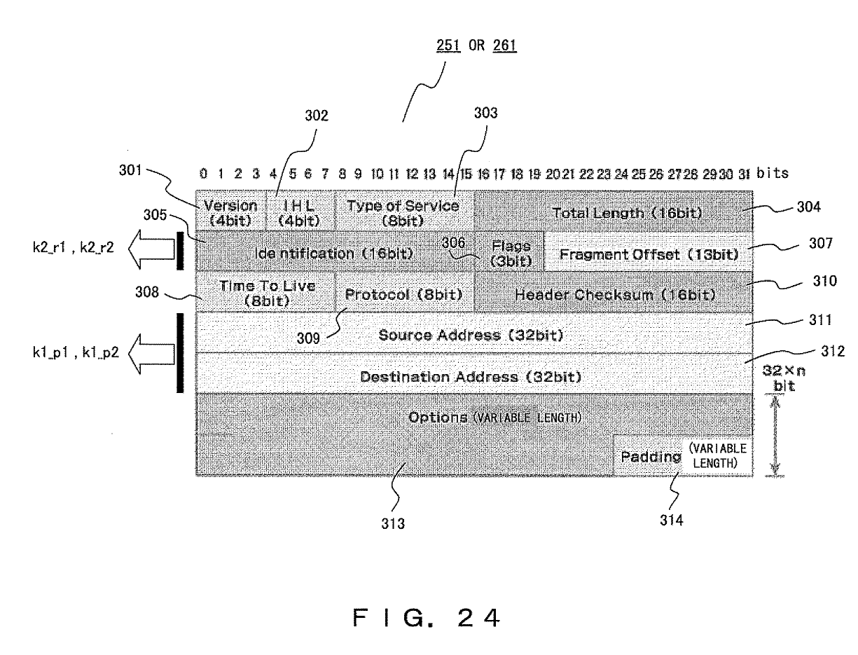

The IP packet 250 is constituted by an IP header 251 and IP data 252 that is data to be transmitted. A format of the IP header 251 is described later in association with FIG. 24.

The IP packet 250 is transmitted within a network as a result of a router and such applying a process called a “routing”, thereby being transmitted from a source to a destination. That is, a transmission path is determined by the routing process and an IP packet is transmitted along the path.

The IPsec is a technique for transmitting and receiving the IP packet 250 securely, and comprises various functions such as encryption, authentication, integrity check and key exchange. Therefore, it is utilized for a VPN (Virtual Private Network) and such. The IPsec adopts the symmetric key system as described above, and therefore an encryption side and a decryption side must pre-share a symmetric key. A protocol for securely accomplishing such a sharing of a symmetric key is the IKE described above.

In the meantime, since the standard of the IPsec is a collection of a plurality of protocols, a replacement of the key exchange and rekey based on the IKE with a utilization of the present invention while continuing to utilize the remainder of the mechanisms makes it possible to transmit and receive an IP packets 250 securely. FIGS. 19 through 28 shows such preferred embodiments. FIGS. 19 through 28 are diagrams describing mechanisms for encrypting by using a practically different symmetric key for each IP packet 250 without exchanging a key.

Incidentally, an encrypted communication in accordance with the IPsec includes two modes, i.e., a tunnel mode and a transport mode, with a range of subject of encryption differing with mode. The range of subject of encryption is also called as “encryption coverage”. In the tunnel mode, the original IP packet 250 is encrypted with the IP header 251 included in the encryption coverage and therefore the tunnel mode is suitable to an encrypted communication across networks and often used in a VPN. In the transport mode, only the IP data 252 of the original IP packet 250 is encrypted and therefore the transport mode is suitable to an encrypted communication between terminals.

The difference between the modes is also related to an aspect of utilizing information of which part of an encrypted IP packet for generating a symmetric key k when applying the present invention to the IPsec, which is described in detail later.

In either mode, however, what is eventually generated by encryption is provided in an IP packet format (named as “encrypted IP packet” hereinafter). That is, despite that a range of subject of encryption differs with mode; data obtained by encrypting the subject range is attached with a header and such properly, thereby making it an ESP (Encapsulating Security Payload) packet 400 (described in detail later), followed by attaching an IP header (261 or 251) in front of the ESP packet 400, thereby eventually generating data in accordance with an IP packet format That is, the ESP packet 400 for an encrypted IP packet (260 or 270) is the IP data 252 for an IP packet 250.

Also in either mode, the aspect is the same, of which an IP packet 250 is transmitted in a telecommunication path constituted by PC 4a, network 3a, router 201a, network 3b, router 201b, network 3c and PC 4d, and of which an encrypted communication is carried out between the routers 201a and 201b of the telecommunication path when the PC 4a transmits an IP packet 250 to the PC 4d for example. That is, the IP packet 250 is encrypted at the router 201a in the telecommunication path to be an encrypted IP packet (260 or 270), followed by being decrypted at the router 201b to be a decrypted IP packet 280.

An encrypted IP packet 260 of the tunnel mode is specifically constituted by a new IP header 261 and an ESP packet 400 as shown in FIG. 19. The ESP packet 400 is a result of encrypting the entirety of an original IP packet (both of the IP header 251 and IP data 252), followed by prefixing an ESP header 262, and suffixing an ESP trailer 265 and authentication data 266.

As shown in FIG. 24, the IP header 251 includes the destination IP address 312 and source IP address 311 of the IP packet 250. Therefore, both of the destination and source are kept secret in the tunnel mode.

When the PC 4a transmits the IP packet 250 to the PC 4d for example as shown in FIG. 19, the IP header 251 includes respective IP addresses of the PC 4a and PC 4d. The IP addresses of the PC 4a and PC 4d, however, are kept secret within the encrypted IP packet 260 because the IP header 251 is changed to an encrypted IP header 263 within the encrypted IP packet 260. Meanwhile, the IP header 261 prefixed anew includes the IP address of the router 201b as the destination IP address and includes the IP address of the router 201a as the source IP address. The IP header 261 is in a cleartext state and therefore it can be read if the encrypted IP packet 260 is intercepted.

An encrypted IP packet 270 of the transport mode uses an IP header 251 of an original IP packet 250 as is, instead of encrypting it, and therefore the source IP address and the destination IP address (e.g., the IP addresses of the PC 4a and PC 4d) that are included in the IP header 251 is in a cleartext state. The encrypted IP packet 270 is constituted by the IP header 251 and ESP packet 400 that is a result of prefixing the ESP header 262 to the encrypted IP data 264 (which is a result of encrypting IP data 252) and suffixing the ESP trailer 265 and authentication data 266 thereto.

In a description of FIG. 5, it has been stated that input data to the symmetric key generation apparatus 1 comprises a header part and a payload part, of which the correlation with FIG. 19 is as follows. For the IP packet 250, the IP header 251 corresponds to the header part and the IP data 252 corresponds to the payload part. For the encrypted IP packet 260 of the tunnel mode, the IP header 261 and ESP header 262 correspond to the header part, and the encrypted IP header 263 and encrypted IP data 264 correspond to the payload part. For the encrypted IP packet 270 of the transport mode, the IP header 251 and ESP header 262 correspond to the head part, and the encrypted IP data 264 corresponds to the payload part.

That is, the partition between the header part and payload part in input data to the symmetric key generation apparatus 1 does not necessarily match with the partition in the format as an IP packet. Input data to the symmetric key generation apparatus 1 is only required to possess a header part and a payload part from a general viewpoint, that is, “information of a subject of transmission is the payload part, and information that is required for transmission and is in a cleartext state is the header part”. Therefore, an encrypted part corresponds to the payload part (because the reason for being encrypted is information of a subject of transmission) and a part that is in front of the payload part and that is in a cleartext state is the header part for the encrypted IP packet (260 and 270).

In the case of using either mode in FIG. 19, a symmetric key k is generated by utilizing pieces of information equivalent to the destination/source information k1, key material k2 and master key k3 shown in FIG. 4. While these pieces of information are described in detail later, the point where information included in an IP packet as a subject of encryption or decryption and information stored (or information generated from the stored information) in the symmetric key generation apparatuses 1a and 1b are used for generating a symmetric key k is common to the examples shown in FIGS. 16 and 17.

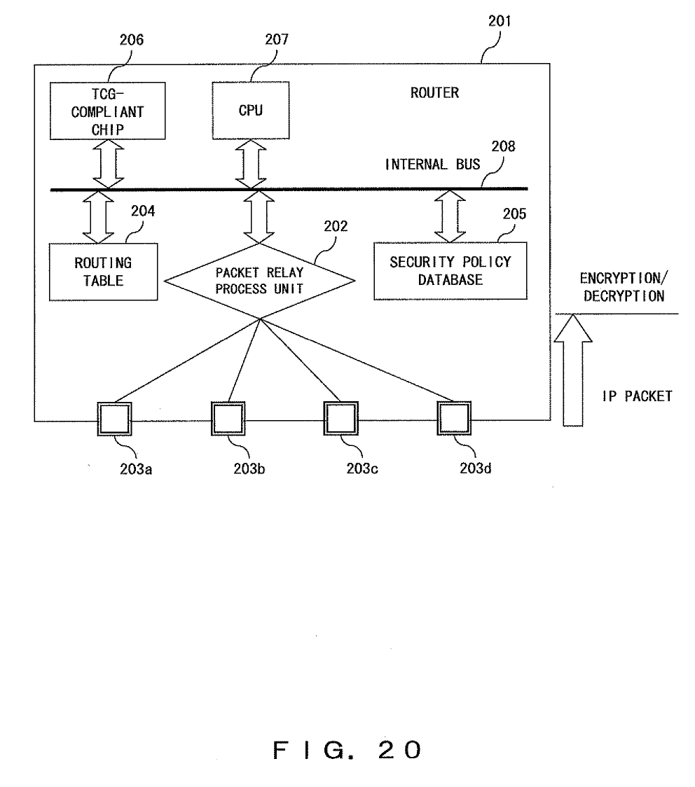

The next is a description of a configuration of the router 201 to which the present invention is applied, by referring to FIG. 20.

The router 201 comprises a plurality of ports 203a through 203d for transmitting and receiving an IP packet (250, 260 and 270). The router 201 further comprises a packet relay process unit 202 connected to each of the ports 203a through 203d by way of an interface for transmitting and receiving an IP packet, a routing table 204, a security policy database 205, a TCG-compliant chip 206 and a CPU 207, with these components being interconnected by an internal bus 208.

The packet relay process unit 202 determines a destination of an IP packet received from either of the ports 203a through 203d and transmits the IP packet by way of either of the ports 203a through 203d for relaying the IP packet. Referring to FIG. 19, the router 201a relays, to the router 201b, an IP packet transmitted from the PC 4a to PC 4d, and the router 201b relays the IP packet to the PC 4d for example. As such, relaying the IP packet by the respective routers 201a and 201b determining appropriate relay destinations is a routing process.

And a table referred to by the packet relay process unit 202 when performing the routing process is the routing table 204 that stores information for determining a relay destination of the IP packet based on the destination of a received IP packet.

The router 201 is an apparatus for generating a symmetric key k by means of the present invention and utilizing the symmetric key k for an encrypted communication in accordance with the IPsec and therefore the packet relay process unit 202 comprises the functions of generating the symmetric key k and carrying out various processes related to the IPsec. The IPsec is designed to allow a utilization of only an authentication function by means of an AH (Authentication Header) without encryption for example, and also provides an anti-replay function (i.e., the function of discarding the same packet, if received it, in order to counter a replay attack that intercepts a packet and replays it). The present embodiment is configured such that the packet relay process unit 202 also carries out these various processes related to the IPsec (named as “IPsec process” hereinafter).

The security policy database 205, being a database referred to by the packet relay process unit 202, stores a security policy specifying what kind of process is applied to what kind of IP packet. The packet relay process unit 202 judges whether a received IP packet is to be discarded, simply relayed without carrying out an IPsec processor applied by it based on the security policy. Determining to apply the IPsec process as a result of the judgment, the packet relay process unit 202 carries out a generation of a symmetric key k, encrypts or decrypts, adds a header, as appropriate, and the like, determines a relay destination of the IP packet and transmits it to the relay destination by way of either of the ports 203a through 203d.

The TCG-compliant chip 206 and CPU 207 are similar to the TCG-compliant chip 105 and CPU 106 that are shown in FIG. 7.

The packet relay process unit 202 can be implemented by hardware, software, firmware or a combination of these. The CPU 207 may be employed as a part of hardware for implementing the packet relay process unit 202. And hardware for implementing the routing table 204 and security policy database 205 is rewritable nonvolatile memory and magnetic disk for example.

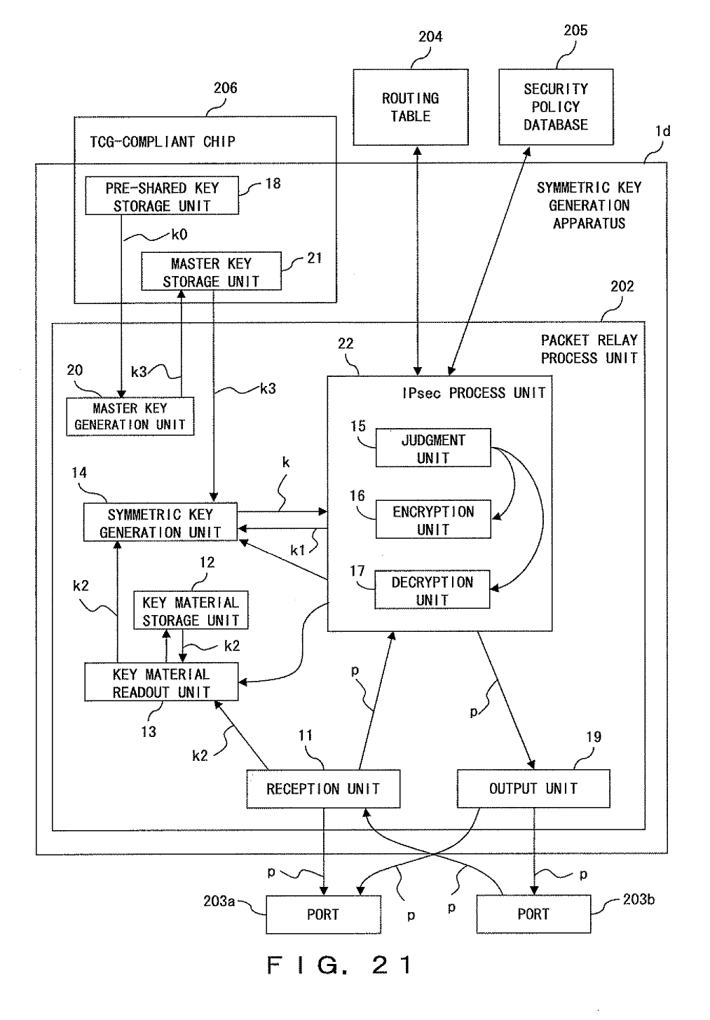

FIG. 21 is a functional block diagram describing a relationship between FIGS. 20 and 5. The configuration shown in FIG. 21 has many common parts with that of FIG. 8 and a description is properly omitted. Signs attached to arrows are the same as in FIG. 8 with an exception of using the sign “p” in place of “f” for indicating an IP packet being transmitted in the direction indicated by the arrow in FIG. 21. Note that the present embodiment is configured such that specific pieces of information equivalent to the destination/source information k1 and key material k2 differ with mode, and in the first stage or second stage as described later. FIG. 21 uses generic signs such as “k1” and “k2” in order to describe common aspects independent of the aforementioned minute difference. An arrow unattached with a sign indicates a flow of control.

Meanwhile, the present invention does not have a direct relationship with a case where an IP packet is discarded or an IPsec process is not carried out as a result of the packet relay process unit 202 referring to the security policy database 205. FIG. 21 accordingly shows only constituent components related 35 to the case of carrying out the IPsec process (i.e., the case of needing to generate a symmetric key k for performing encryption or decryption).

The symmetric key generation apparatus 1d shown in FIG. 21 corresponds to a part of the packet relay process unit 202 and TCG-compliant chip 206. The symmetric key generation apparatus 1d comprises a reception unit 11, a key material storage unit 12, a key material readout unit 13 and symmetric key generation unit 14 likewise the symmetric key generation apparatus 1 of FIG. 5.

That which carries out the routing process and IPsec process at the router 201 shown in FIG. 20 is the packet relay process unit 202. Of the packet relay process unit 202, FIG. 21 shows a block, as an IPsec process unit 22, judging a necessity or not of applying an IPsec process by referring to the security policy database 205 and carrying out encryption or decryption based on the judgment. In more detail, the IPsec process unit 22 comprises a judgment unit 15, an encryption unit 16 and a decryption unit 17.

The packet relay process unit 202 is connected to a plurality of ports (i.e., FIG. 20 shows the ports 203a through 203d, while FIG. 21 shows only ports 203a and 203b of those ports) by way of interfaces for transmitting and receiving an IP packet as described above. The reception unit 11 applies the interface process and transmits a received IP packet (in either case of being encrypted or not encrypted) to the IPsec process unit 22.

The judgment unit 15 judges a necessity or not of an IPsec process, at the IPsec process unit 22, the judgment of which is also that of a necessity or not of a generation of a symmetric key k. In FIG. 21, the judgment unit 15 judges as either one of the following four stages:
The first stage, requiring a generation of a symmetric key k for encryption
The second stage, requiring a generation of a symmetric key k for decryption
The third stage, requiring only a relay of an IP packet without applying an IPsec process
The fourth stager requiring a discarding of the received IP packet

In the first or second stage, the IPsec process unit 22 issues an instruction to the key material readout unit 13 and symmetric key generation unit 14 to generate a symmetric key k. In this event, it gives the symmetric key generation unit 14 destination/source information k1 necessary for generating the symmetric key k. The operations of the key material storage unit 12, key material readout unit 13 and symmetric key generation unit 14 related to the generation of the symmetric key k are similar to those of FIGS. 5 and 8, and thus generated symmetric key k is transmitted from the symmetric key generation unit 14 to the IPsec process unit 22.

In the first stage, the encryption unit 16 comprised by the IPsec process unit 22 encrypts, by using the symmetric key k, the IP packet received by way of the reception unit 11 and outputs the encrypted IP packet to either of the ports by way of the output unit 19. In the second stage, the decryption unit 17 comprised by the IPsec process unit 22 decrypts, by using the symmetric key k, the encrypted IP packet received by way of the reception unit 11 and outputs the decrypted IP packet to either of the ports by way of the output unit 19. Note that the output unit 19 also carries out an interface process between itself and a plurality of ports (203a and 203b) likewise the reception unit 11.

Note that FIG. 21 exemplifies a case of the TCG-compliant chip 206 including the pre-shared key storage unit 18 and master key storage unit 21, the master key generation unit 20 generating a master key k3 based on the pre-shared key k0 preset in the pre-shared key storage unit 18 and storing it in the master key storage unit 21. The master key k3 pre-stored as described above is read by the symmetric key generation unit 14 in the first stage or second stage. Meanwhile, the pre-shared key storage unit 18 and master key storage unit 21 are comprised within the TCG-compliant chip 206 and therefore neither the pre-shared key k0 nor the master key k3 is fraudulently read from the outside.

Another preferred embodiment may be configured to generate a master key k3 at every time of generating a symmetric key k, in which case the IPsec process unit 22 is required to issue an instruction to the master key generation unit 20 for generating a master key k3 because it is the first or second stage (i.e., an arrow for a control needs to be delineated from the IPsec process unit 22 to the master key generation unit 20 in the showing of FIG. 21 in this case).

Yet another preferred embodiment may be configured to generate a master key k3 by utilizing a master key array C as in the case of FIG. 17. In such a case, the master key storage unit 21 is replaced by a master key array storage unit (not shown herein) for storing a master key array C constituted by M pieces of candidate values. And a master key array generation unit (not shown herein) generates a master key array C and stores it in the master key array storage unit (not shown herein) at the time of setting a pre-shared key k0 or turning on the power to the router 201. In the first or second stage, the IPsec process unit 22 issues an instruction to the master key generation unit 20 so as to select a master key k3 from the M pieces of candidate values and output it to the symmetric key generation unit 14. The master key k3 may be selected by using a method similar to the above expression (6) for example, in which case the IPsec process unit 22 controls the key material readout unit 13 so as to output a key material k2 to the master key generation unit 20.

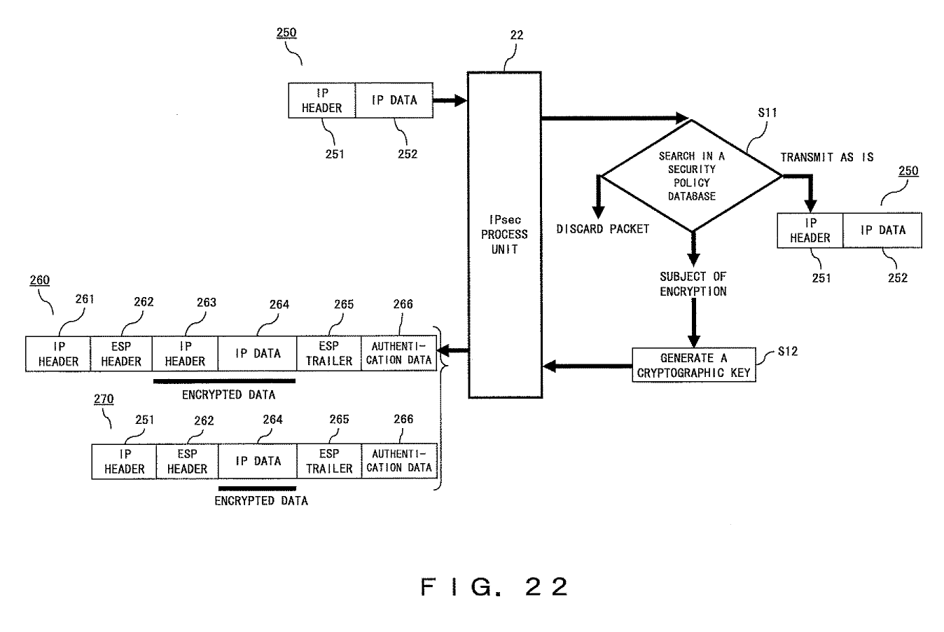

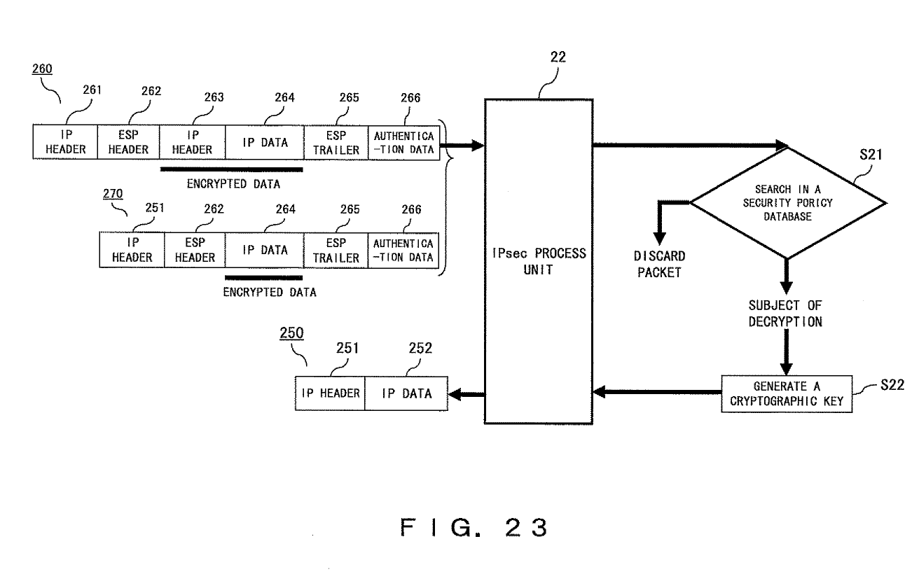

FIGS. 22 and 23 each is a diagram describing an operation of the IPsec process unit 22 when an unencrypted IP packet 250 (FIG. 22), or encrypted IP packet (260 or 270) (FIG. 23), is received. Note that a reference to a value of a protocol 309 field (to be described later in association with FIG. 24) within the IP header (251 or 261) at the head of a received IP packet makes it possible to discern whether the received IP packet is an unencrypted normal IP packet 250 or an encrypted IP packet (260 or 270).

Referring to FIG. 22, having received an IP packet 250 by way of either of the ports 203a through 203d, the IPsec process unit 22 searches in the security policy database 205 based on the source and destination IP addresses which are included in the IP header 251 in the step S11. Based on the security policy obtained by a result of the search, the IPsec process unit 22 performs an operation of either one of the following three to:
discard the IP packet 250;
transmit the IP packet 250 as is, without encrypting it; or
determine the IP packet 250 to be a subject of encryption and proceed to the step S12

In the step S12, a symmetric key k is generated. In the case of the configuration shown in FIG. 21, the key material storage unit 12, key material readout unit 13, master key storage unit 21 and symmetric key generation unit 14, in addition to the IPsec process unit 22, have respective relationships with the step S12.

Having generated a symmetric key k in the step S12, the symmetric key generation unit 14 outputs the symmetric key k to the IPsec process unit 22. The encryption unit 16 comprised by the IPsec process unit 22 encrypts the IP packet 250 by using the symmetric key k. The facts of the encryption coverage and the format of an ESP packet 400 differing depending on either of the tunnel mode and transport mode have already been described. The IPsec process unit 22 generates an appropriate encrypted IP packet (260 or 270) in accordance with the mode, determines a relay destination, and outputs the encrypted IP packet from an appropriate port (either of the 203a through 203d) by way of the output unit 19.

Now turning to FIG. 23, having received an encrypted IP packet (260 or 270) by way of either of the ports 203a through 203d, the IPsec process unit 22 searches in the security policy database 205 based on the source and destination IP addresses in the step S21. The source and destination IP addresses used for the search is ones included in the IP header 261 in the case of the tunnel mode, or ones included in the IP header 251 in the transport mode. Based on the security policy obtained by a result of the search, the IPsec process unit 22 performs an operation of either one of the following two to:
discard the encrypted IP packet (260 or 270); or
determine the encrypted IP packet (260 or 270) being a subject of decryption, and proceed to the step S22.

In the step S22, a symmetric key k is generated. In the case of the configuration shown in FIG. 21, the key material readout unit 13, master key storage unit 21 and symmetric key generation unit 14, in addition to the IPsec process unit 22, have respective relationships with the step S22.

Having generated a symmetric key k in the step S22, the symmetric key generation unit 14 outputs the symmetric key k to the IPsec process unit 22. The decryption unit 17 comprised by the IPsec process unit 22 decrypts the encrypted IP packet (260 or 270) by using the symmetric key k to generate an IP packet 250, followed by determining a relay destination and outputting the IP packet 250 from an appropriate port (either of the 203a through 203d) by way of the output unit 19.

FIGS. 24 through 26 each is a diagram describing a specific example of information used for generating a symmetric key k. The next is explanations of these diagrams followed by describing a specific generation method for a symmetric key k.

FIG. 24 is a diagram showing a format of an IP header. Although an IP version 6 (IPv6) has been instituted as the next generation standard, the currently widely used is the IP version 4 (IPv4), and FIG. 24 accordingly shows a header according to the IPv4. Note that FIG. 24 shows it by dividing into plural lines for a convenience of the showing. Both of the IP header 251 and IP header 261 which are shown in FIG. 19 are in the format of FIG. 24.

As shown in FIG. 24, the IPv4 header includes individual fields, i.e., a 4-bit of version 301, a 4-bit of THL (Internet Header Length; a length of a header) 302, an 8-bit of TOS (Type of Service) 303, a 16-bit of total length 304, a 16-bit of ID 305, a 3-bit of flags 306, a 13-bit of fragment offset 307, an 8-bit of TTL (Time to Live) 308, an 8-bit of protocol 309, a 16-bit of header checksum 310, a 32-bit of source IP address 311, a 32-bit of destination IP address 312, a variable length of options 313, and a variable length of padding 314.

The protocol 309 expresses an upper layer protocol included in the IP data 252. For example, numbers represents as follows; 6: TCP, 50: IPsec ESP, and 51: IPsec AH. Therefore, a router compliant to the IPsec is enabled to judge whether a received IP packet is a normal IP packet 250 or an encrypted IP packet (260 or 270) based on a value of the protocol 309 of the IP header when receiving the IP packet.

The IP provides a fragmentation function that uses the three fields, i.e., the ID 305, flags 306 and fragment offset 307. The mechanism of division and reassembly of the IP packet by using these fields is known and resembling the above described fragmentation function of a frame, and therefore a description of the fragmentation function is omitted here.

Incidentally, the IP headers 251 and 261 are the same in terms of the two being constituted by the fields shown in FIG. 24; there are, however, some fields with different contents. The next is a description of fields related to the present invention, among the fields.

The most significant difference between the IP headers 251 and 261 are the source IP address 311 and destination IP address 312. When the PC 4a transmits an IP packet 250 to the PC 4d for example in the configuration of FIG. 19, the source IP address 311 is the IP address of the PC 4a and the destination IP address 312 is the IP address of the PC 4d for the IP header 251. Comparably, the source IP address 311 is the IP address of the router 201a and the destination IP address 312 is the IP address of the router 201b for the IP header 261.

In addition, a further difference between the IP headers 251 and 261 is the ID 305. The ID 305 within the IP header 251 is set up for its value at the source host and the value does not change while the IP packet is relayed in the network. If the source host is the PC 4a for example in FIG. 19, the value of the ID 305 set by the PC 4a is not changed while the IP packet is relayed in the telecommunication path constituted by the network 3a, router 201a, network 3b, router 201b, network 3c and PC 4d. In the case of the tunnel mode, the ID 305 is of course transmitted by being included in the IP header 263 in the state of being encrypted in a part of the telecommunication path (i.e., between the routers 201a and 201b), the content itself represented by the data is not changed, however.

Comparably, the IP header 261 is added by the router 201a shown in FIG. 19 for the example described above in the case of the tunnel mode. A value of the ID 305 within the IP header 261 is assigned by the router 201a independent of the value of the ID 305 within the original IP header 251. The value is not changed while the encrypted IP packet 260 for the tunnel mode is relayed in the telecommunication path constituted by the router 201a, network 3b and router 201b.

That is, in the case of the transport mode, it is possible to refer to the ID 305 of the same value (i.e., without requiring a process of decryption and such) always in a telecommunication path between the source and destination. In the tunnel mode on the other hand, the router 201b existing in the telecommunication path is unable to read a value of the ID 305 set by the PC 4a directly from a received encrypted IP packet 260 (because it is encrypted). What is possible for the router 201b to read directly from the received encrypted IP packet 260 is the ID 305 within the IP header 261 set by the router 201a.

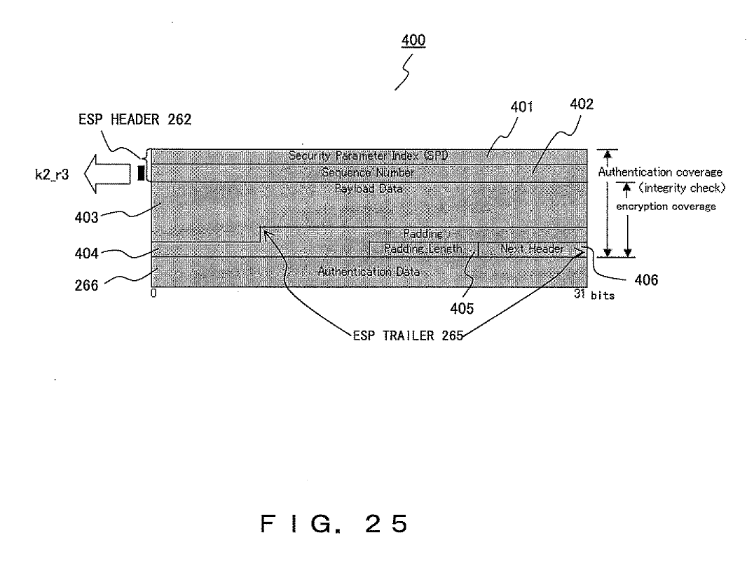

FIG. 25 is a diagram showing a format of the ESP packet 400.

The ESP packet 400 is constituted by an ESP header 262, an ESP payload 403, an ESP trailer 265 and authentication data 266.

The ESP header 262 is constituted by a 4-byte of SPI (Security Parameter Index) 401 and a 4-byte of sequence number 402. According to the IPsec, a source and a destination agree on a cryptographic algorithm and such to be used in both parties in advance of carrying out an encrypted communication. The agreement is called an SA (Security Association) and a value assigned to each SA for identifying the SA is the SPI 401. The sequence number 402 is assigned by a value of a counter that is incremented at every time of generating an ESP packet 400. If the anti-replay function is set as valid, the sequence number 402 is used for discarding a replayed IP packet by discerning it; a counter value, however, is assigned to the sequence number 402 even if the anti-replay function is set as invalid.

The ESP Payload 403 is a part of variable length data indicated by “Payload Data” in FIG. 25 and corresponds to an encrypted IP packet. In the tunnel mode, the ESP payload 403 is a result of encrypting both of the IP header 251 and IP data 252 of an original IP packet. In the case of the transport mode, the ESP Payload 403 is a result of encrypting the IP data 252 of an original IP packet.

The ESP Trailer 265 is constituted by a 0-through 255-byte of padding 404, a 1-byte of padding length 405, and a 1-byte of next header 406. The next header 406 expresses an upper layer protocol.

The authentication data 266 is a value calculated for an integrity check based on a part starting from the SPI 401 to the next header 406.

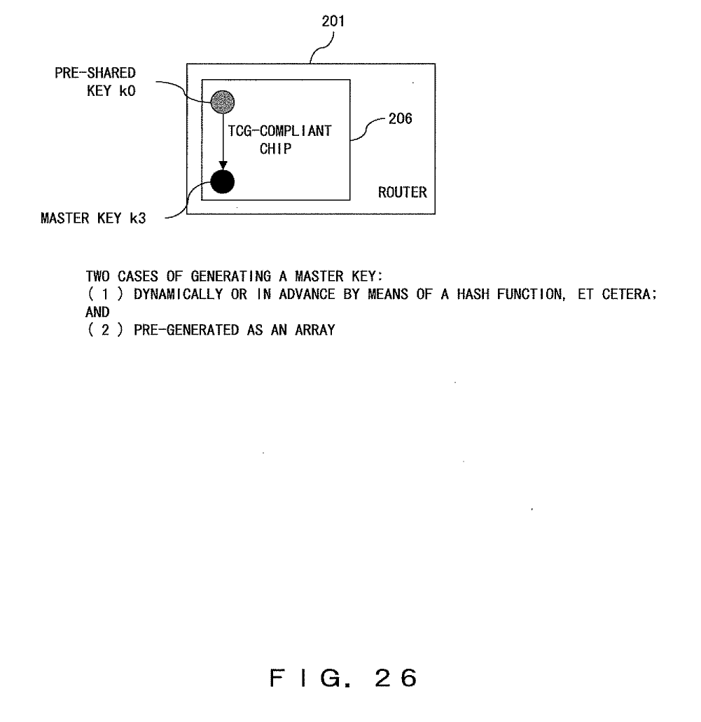

FIG. 26 is a diagram describing a generation of a master key k3. FIG. 21 is configured such that the master key generation unit 20 reads the pre-shared key k0 stored in the pre-shared key storage unit 18 within the TCG-compliant chip 206 and generates a master key k3 and stores it in the master key storage unit 21 within the TCG-compliant chip 206. Meanwhile, FIG. 26 is a diagram focusing on the aspect of generating a master key k3 based on the pre-shared key k0 and that of storing both of the pre-shared key k0 and master key k3 within the TCG-compliant chip 206 regardless of the process of generating the master key k3.

As described in association with FIG. 21, one master key k3 may be generated based on the pre-shared key k0 in advance of a process or at every time of generating a symmetric key k, or alternatively a master key array C may be generated in advance and a master key k3 may be selected from the master key array C at every time of generating a symmetric key k.

The method for generating a master key k3 is similar to the case of applying the present invention to the L2 relay apparatus 101, and a discretionary method can be adopted from the methods shown in the above expressions (5) through (15). Note that an expression utilizing a firm character string fs such as the expression (7) can also be applied to FIG. 26 by changing a definition of the firm character string fs to a definition other than the above description. In the above description, the firm character string fs is a character string defined by the firmware of the L2 relay apparatus 101. Comparably, FIG. 26 defines that “a firm character string fs is a unique character string defined by the firmware of the router 201 shown in FIG. 26”. Also, the assumption is that the router 201 is so configured that the master key generation unit 20 (not shown in FIG. 26; refer to FIG. 21) is capable of referring to the firm character string fs. Thus changing the definition of the firm character string fs enables an application of the above expression (7), and such, also to FIG. 26.

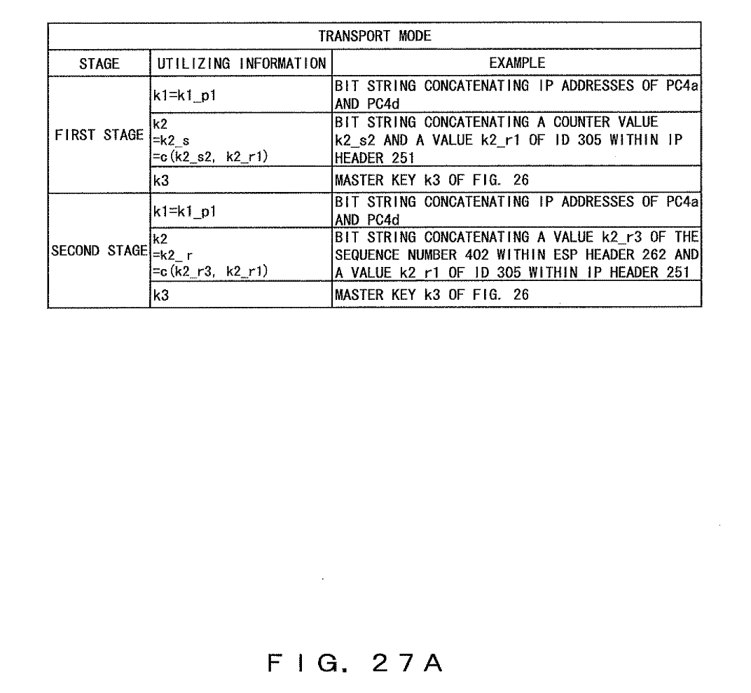

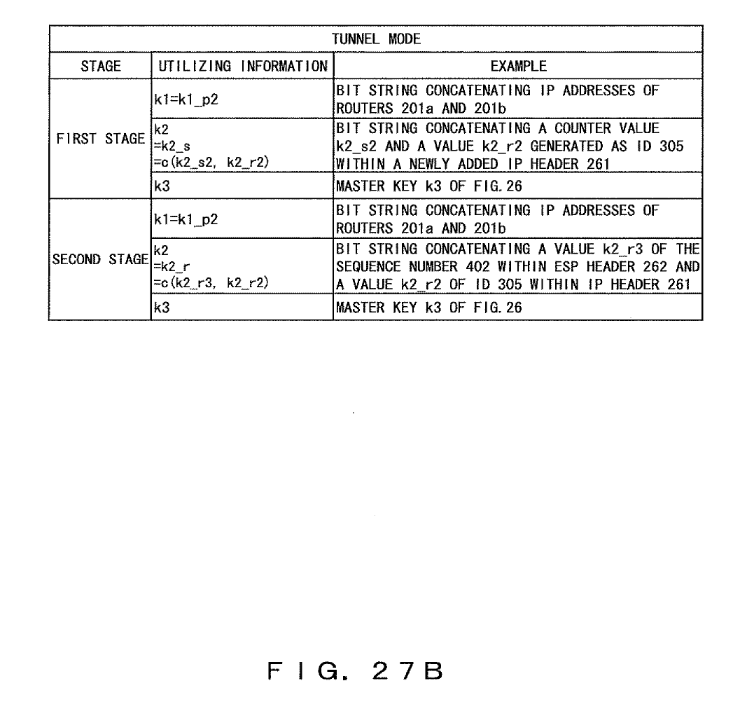

The next is a description on a correlation of individual pieces of information shown in FIG. 4 with FIGS. 24 through 26 by referring to FIGS. 27A and 27B that show the cases of the transport mode and tunnel mode, respectively.

As for the master key k3, the correlation is apparent from the description for FIG. 26 and there is no difference between the modes, and therefore the following descriptions are only concentrated on the destination/source information k1 and key material k2. The first description is on the transport mode because it is simpler.

In the transport mode, IP header information k1_p1 (refer to FIG. 19) that is information constituted by the source IP address 311 and destination IP address 312 within the IP header 251 is utilized as destination/source information k1 both in the first and second stages as shown in FIG. 27A. In the transport mode, an IP packet 250 that is the input data for the first stage (i.e., the stage for generating a symmetric key k for encryption) and an encrypted IP packet 270 that is the input data for the second stage (i.e., the stage for generating a symmetric key k for decryption) respectively include the IP header 251. Besides, of the IP header 251, the source IP address 311 and destination IP address 312 are not subjects of rewriting in the telecommunication path. Therefore, the IP header information k1_p1 of the same value from the IP header 251 can be obtained in both of the first and second stages.

When the PC 4a transmits an IP packet 250 to the PC 4d for example in the configuration shown in FIG. 19, as the router 201a receives the IP packet 250, the symmetric key generation apparatus 1a carries out an operation of the first stage, that is, refers to the IP header 251 of the IP packet 250 and obtains the IP header information k1_p1 from the respective IP addresses of the PC 4a and PC 4d included in the IP header 251.

Note that the IP header information k1_p1 is discretionary, provided that information can be obtained based on at least either of the two IP addresses. For example, the IP header information k1_p1 may be obtained by concatenating bit strings expressing the two IP addresses, or a part of the IP address may be utilized.

And, in the example of the PC 4a transmitting an IP packet 250 to the PC 4d in FIG. 19, as the router 201b receives an encrypted IP packet 270, the symmetric key generation apparatus 1b carries out an operation of the second stage, that is, to refer to the IP header 251 of the encrypted IP packet 270 and obtain the IP header information k1_p1 from the respective IP addresses of the PC 4a and PC 4d included in the IP header 251. The symmetric key generation apparatuses 1a and 1b can obtain the IP header information k1_p1 of the same value.

The next is a description on a key material k2 in the transport mode. The aspect of utilizing the sequence number stored in the key material storage unit 12 (refer to FIG. 21) comprised by the symmetric key generation apparatus 1d in the first stage and that of utilizing the sequence number included in input data (i.e., an encrypted IP packet 270) in the second stage are the same in the cases of FIGS. 16 and 17. The difference lies in combing yet an other value and utilizing it as a key material k2.

As shown in FIG. 27A, a key material k2 in the first stage is represented by the sign “k2_s” that is specifically generated by the expression (16). Although the function c of the expression (16) may be discretionary, the simplest example is represented by the expression (17):
k2=k2=c(k2_{—}s2,k2_{—}r1) (16)
c(x1,x2)≡x1&x2 (17)

Here, the sign “k2_s2” indicates the sequence number stored in the key material storage unit 12 (i.e., a counter), and the sign “k2_r1” indicates the ID 305 within the IP header 251 (refer to FIG. 19). That is, a key material k2 is generated based on information read from both of the key material storage unit 12 and input data by the key material readout unit 13 in the first stage. Note that if the present invention is applied to the IPsec, the key material storage unit 12 is a 4-byte long counter, and the sequence number stored therein is utilized as a sequence number 402 within the ESP header 262 when generating an ESP packet 400.

Likewise, a key material k2 in the second stage is represented by the sign “k2_r” which is specifically generated by the following expression (18):
k2=k2_{—}r=c(k2_{—}r3,k2_{—}r1) (18);

where the sign “k2_r3” indicates the sequence number 402 within the ESP header 262.

When the PC 4a transmits an IP packet 250 to the PC 4d in FIG. 19, a sequence number k2_s2 stored in a key material storage unit 12 (not shown in FIG. 19) within the symmetric key generation apparatus 1a is set as the sequence number 402 within the ESP header 262 of an encrypted IP packet 270. Then, in the router 201b having received the encrypted IP packet 270, the key material readout unit 13 comprised by the symmetric key generation apparatus 1b reads the sequence number k2_r3 from the sequence number 402 field within the ESP header 262. The key material readout unit 13 also reads an ID k2_r1 from the ID 305 field within the IP header 251 and generates a key material k2 by means of the expression (18) Therefore, the key material readout units 13 of both of the symmetric key generation apparatuses 1a and 1b respectively generates key materials k2 of the same value by using the same function c as shown in the expressions (16) and (18).

The next is a description of the reason for generating a key material k2 from the two pieces of information as described above.

As shown in FIG. 25, the sequence number 402 is 32 bits (=4 bytes), and therefore 2³² pieces of numbers are utilizable. Assuming that a router encrypts 1 G pieces of IP packets 250 per second, likewise the above-mentioned preferred embodiment related to encryption of a frame, then the time for returning to the same number is:
2³²/10⁹≈4.3 (seconds)

As compared to the sequence number 1714 shown in FIG. 12 having a length of 8 bytes, the 4-byte is short and the time for returning to the same number is short as that much. The fact of the shorter time is not a favorable characteristic.

However, many an IP packet 250 actually is of the order of 1 K bytes and therefore an actual event of 1 G pieces of IP packets 250 per second being encrypted is not practical. Another calculation by assuming 1M pieces of IP packets 250 per second being encrypted modifies the above noted time to be considerably extended to:
2³²/10⁶≈4295 (seconds)≈1.2 (hours)

This is still shorter than the illustratively calculated value related to the sequence number 1714 of FIG. 12, that is, about 585 years; it is r however, possible to accomplish (independent of a cycle) an aspect of generating different symmetric keys k for consecutive IP packets 250 by properly configuring the symmetric key generation unit 14. Also, a parallel utilization with the IP header information k1_p1 as described above eliminates a possibility of using the same symmetric key k in the same cycle as a sequence number (k2_s2 or k2_r3) if there is a cyclicality therein. Therefore, a 4-byte of sequence number (k2_s2 or k2_r3) is not faced with a practical problem in many usage aspects.

However, there is a case of requiring more robust security. A required security level is determined by considering various factors; if, however, there is a relatively simple method for raising a security level, such a method may also be adopted.

Accordingly, a 2-byte of ID 305 is utilized in addition to the 4-byte sequence number (k2_s2 or k2_r3) in order to raise a security level by a simple method without changing the widely-used format of the ESP packet 400. Applying the expression (17) to the expressions (16) and (18) obtains a value of 6 bytes (=48 bits) as a key material k2 as a result of concatenating the sequence number (k2_s2 or k2_r3) and ID k2_r1. It is of course possible to generate a 6-byte of key material k2 based on a 4-byte of sequence number and a 2-byte of ID by a method other than the expression (17). Divisions of the sequence number and ID into pluralities of blocks, respectively, and a rearrangement of these blocks in a predetermined sequence result in obtaining a 6-byte of value.

In the case of using a 6-byte key material k2 generated as described above, a calculation by assuming 1M pieces of IP packets 250 per second being encrypted (i.e., a calculation by the same assumption as the above-mentioned one) results in:
2⁴⁸/10⁶=2.81×10⁸ (seconds)≈8.92 (years)

This cycle is much longer than the 1.2 hours calculated above and practically sufficiently long. In brief, a relatively simple method of utilizing the ID k2_r in addition to the sequence number (k2_s2 or k2_r3) greatly improves the security level.

A key material k2 is generated based on two pieces of information such as the expressions (16) and (18) based on the above reason.

The next is a description of the case of the tunnel mode by referring to FIG. 27B. In the tunnel mode, what is utilized as destination/source information k1 is IP header information k1_p2 that is information constituted by the source IP address 311 and destination IP address 312 within the IP header 261 which has been prefixed to (or which is to be prefixed to) an encrypted IP packet 260 in both of the first and second stages as shown in FIG. 27B.

In the case of the PC 4a transmitting an IP packet 250 to the PC 4d for example in the configuration shown in FIG. 19, the source IP address 311 within the IP header 261 is the IP address of the router 201a and the destination IP address 312 within the IP header 261 is the IP address of the router 201b. That is, the IP header information k1_p2 is not obtained from the source (i.e., PC 4a) or destination (i.e., PC 4d) per se. The symmetric key generation apparatus 1a carrying out an operation of the first stage obtains the IP header information k1_p2 based on contents (i.e., the IP addresses of the routers 201a and 201b) which are to be set in the IP header 261 for generating an encrypted IP packet 260 instead of the IP packet 250 that is the input data. Comparably, the symmetric key generation apparatus 1b carrying out an operation of the second stage obtains IP header information k1_p2 based on the IP header 261 of the encrypted IP packet 260 that is input data.

Incidentally, the fact of a method for obtaining the IP header information k1_p2 from the two IP addresses being discretionary is similar to the case of the transport mode.

As such, the operation for the tunnel mode is irregular as compared to other examples described above, with a reason as follows.

The basis of utilizing destination/source information k1 for generating a symmetric key k is that the use thereof is beneficial for making the symmetric key k more random. The reasons for the benefit is that there is a large number of combinations between a destination and a source and that it is quite irregular as to when a telecommunication is carried out from which source to which destination. Therefore, information based on the addresses of terminals (i.e., the PC 4a through PC 4f according to FIG. 19) that are a destination and a source is preferred as destination/source information k1.

In the tunnel mode, however, the IP addresses of the destination and source included in the state of being encrypted in the encrypted IP header 263 cannot be obtained unless the encrypted IP packet 260 is decrypted, and therefore IP header information k1_p1 similar to the transport mode cannot be obtained. Consequently, it is not possible to utilize the IP header information k1_p1 for generating a symmetric key k in order to decrypt the encrypted IP packet 260. Therefore, IP header information k1_p2 within the IP header 261 in a cleartext state is utilized as destination/source information k1 for the tunnel mode, in place of the IP header information k1_p1 used for the transport mode.

The next is a description on a key material k2 for the tunnel mode. As is comprehensible from the comparison between FIGS. 27A and 27B, an ID k2_r2 that is a value of the ID 305 field within the IP header 261 is utilized in the tunnel mode, in place of the ID k2_r1 used for the transport mode. The other aspects are the same as in the case of the transport mode. That is, in the case of the tunnel mode, key materials k2 in the first and second stages are respectively represented by the following expressions (19) and (20):
k2=k2_{—}s=c(k2_{—}s2,k2_{—}r2). (19)
k2=k2_{—}r=c(k2_{—}r3,k2_{—}r2). (20)

The reason for utilizing the ID k2_r2 in place of an ID k2_r1 is the same as utilizing the IP header information k1_p2 in place of IP header information k1_p1. That is, because an ID 305 included in the encrypted IP header 263 in the state of being encrypted cannot be obtained at the symmetric key generation apparatus 1b unless the encrypted IP packet 260 is decrypted in the case of the PC 4a transmitting an IP packet 250 to the PC 4d in FIG. 19.

In order to generate a symmetric key k by using the information shown in FIGS. 27A and 27B, the symmetric key generation unit 14 is only to operate in accordance with expressions substituting the sign “k1_f” with a sign “k1_p1” or “k1_p2” for the above described expressions (1) through (4). Also, in the case of a preferred embodiment selecting a master key k3 by utilizing a mater key array C, the symmetric key generation unit 14 is only to operate as in the case of employing the present invention for encrypting a frame. In such a case, the fact of the expression (1) being replaced by the following expression (21) for the transport mode and that of being replaced by the expression (22) for the tunnel mode are apparent from the above description:

$$\begin{matrix}\begin{matrix}k = f ( k1\_p1 , k2 , k3 ) \\ = k 3 XOR ( k1\_p1 + c ( k2\_s2 , k2\_r1 ) ) \\ = k 3 XOR ( k1\_p1 + c ( k2\_r3 , k2\_r1 ) ) \end{matrix} & ( 21 ) \\ \begin{matrix}k = f ( k1\_p2 , k 2 , k 3 ) \\ = k 3 XOR ( k1\_p2 + c ( k2\_s2 , k2\_r2 ) ) \\ = k 3 XOR ( k1\_p2 + c ( k2\_r3 , k2\_r2 ) )\end{matrix} & ( 22 )\end{matrix}$$

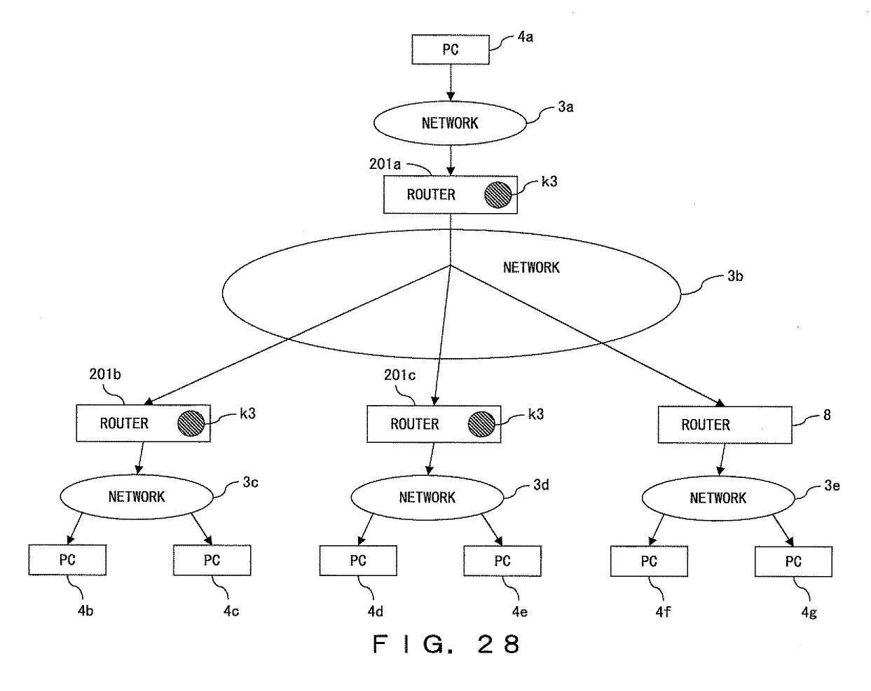

FIG. 28 is a diagram showing an example of employing a router comprising a symmetric key generation apparatus of the present invention for a broadcast. The conventional IPsec is a symmetric cryptographic system and therefore is not suitable to a multicast having a plurality of destinations. An application of the present invention (i.e., employing a router comprising the symmetric key generation apparatus 1 of the present invention) to the IPsec, however, makes it possible to carry out a multicast easily by using a mechanism of the IPsec.

In the configuration shown in FIG. 28, the PC 4a that is the source of the multicast is connected to the router 201a by way of the network 3a. Destinations of the multicast are PCs 4b, 4c and 4d. The PCs 4b and 4c are connected to the router 201b by way of the network 3c, and the PCs 4d and 4e are connected to the router 201c by way of the network 3d. Note that each of the routers 201a, 201b and 201c comprises the symmetric key generation apparatus 1 according to the present invention and respectively store master key k3 of the same value. In addition, PCs 4f and 4g are connected to a conventional router 8 by way of a network 3e. The routers 201a, 201b, 201c and 8 are interconnected by way of the network 3b.

When the PC 4a transmits an IP packet to the PCs 4b, 4c and 4d by means of a multicast, the IP packet is encrypted at the router 201a and relayed to the routers 201b and 201c by way of the network 3b. That is, the encrypted IP packet is copied by the router 201a or a router (not shown herein) existing in the network 3b and then transmitted to both of the routers 201b and 201c. The router 201b decrypts the encrypted IP packet and copies it for transmitting to the PCs 4b and 4c. The router 201c decrypts the encrypted IP packet and transmits it to the PC 4d.

Here, each of the routers 201a, 201b and 201c comprises the symmetric key generation apparatus 1 according to the present invention and respectively store master key k3 of the same value and therefore the routers 201b and 201c each also generates a symmetric key ka of the same value as one generated as a symmetric key ka for an IP packet to be multicast at the symmetric key generation apparatus 1 comprised by the router 201a. In addition, if the PC 4e transmits an IP packet to the PC 4c independent of the multicast in parallel with the aforementioned multicast for example, symmetric keys kb for that transmission are generated at the routers 201c and 201b respectively, and the IP packet is transmitted within the network 3b in the state of being encrypted.

What must be managed at each of these routers 201a, 201b and 201c is a master key k3 only (or a pre-shared key k0 as a raw material for the master key k3). The router 201c for example is not required to manage a plurality of keys such as use for a multicast, use for a communication with the router 201a or with the router 201b. That is, an application of the present invention to the IPsec provides benefit such as making it possible to respond to a multicast and encrypt by using a different symmetric key for each IP packet while eliminating a necessity of a complex management of keys.

Note that the present invention can be variously modified in lieu of being limited to the preferred embodiments described above. The following describes some examples.

The configuration of FIG. 11 regards the data part 153 including such as the type as a subject of encryption. Alternatively, that part down to the type, LLC header and SNAP header may be regarded as the header part and excluded from the subject of encryption. In such a case, a position of the cryptographic header 171 in the encrypted frame 170 may be placed immediately after the TCI 162 as in the case of FIG. 11, or the TCI 162 may be followed by the type, cryptographic header 171, and encrypted data part. In the latter case, the aspect of an order of header part excluded from a subject of encryption, followed by the cryptographic header 171 and encrypted data part is similar to the configuration of FIG. 11.

The preferred embodiments described above are configured to generate a symmetric key k based on k=f (k1, k2, k3). However, what is mandatory for generating a symmetric key k is only a key material k2. Therefore, a symmetric key k may be generated by calculating such as k=h(k2) by utilizing a hash function h for example.

The utilization of the destination/source information k1 and master key k3 together with the key material k2 is preferable in terms of the aspect of strength of the symmetric key k. Besides, the utilization of the destination/source information k1 and master key k3 that are elements other than the key material k2 is desirable for speeding up the process by simplifying the calculation as in the case of FIG. 17.

Also, the above described embodiments are configured to utilize also the ID 305 within the IP header for generating a symmetric key k in the case of applying the present invention to the IPsec; the ID 305 may not necessarily be utilized, however. Conversely, other pieces of information (i.e., information included in an encrypted IP packet in a cleartext state, and of which a value is not changed in the middle of a telecommunication path) such as the SPI 401 may additionally be utilized.

Also, the function f may be functions other than the ones exemplified in the above description.

Also, FIG. 18 is configured to adopt the mechanism of utilizing the fragment offset 1716; a fragmentation function, however, may be implemented by adopting a cryptographic header 171 of a different format than FIG. 12. For example, recording information of “how many fragment frames there are in total” and that of “what a sequence number this fragment frame is in all the fragment frames” in the cryptographic header 171 and a reassembly may be carried out based on these pieces of information instead of reassembling based on the reserved field 1713 and fragment offset 1716.

The above descriptions have exemplified the cases of incorporating the symmetric key generation apparatus of the present invention as a part of the Layer 2 or Layer 3 relay apparatus. In these examples, the symmetric key generation apparatus incorporates the encryption unit 16 and decryption unit 17 therein as shown by FIGS. 8 and 21. The symmetric key generation apparatus 1 according to the present invention, however, may not necessarily incorporate a judgment unit 15, encryption unit 16 or decryption unit 17 therein as shown in FIGS. 8 and 21.

In the configuration of FIG. 21, asymmetric key generation apparatus 1d may be modified to comprise only the reception unit 11, key material storage unit 12, key material readout unit 13 and symmetric key generation unit 14 for example. In such a case, the IPsec process unit 22 and symmetric key generation apparatus 1d are implemented in mutually different pieces of hardware that are interconnected by a bus for example in order to transmit and receive a control signal and input and output data.

In the aforementioned configuration, the IPsec process unit 22 instructs, by way of the above connection, the symmetric key generation apparatus 1d to generate a symmetric key k when it judges as a necessity of an IPsec process. In this event, the IPsec process unit 22 sends information (e.g., information indicating which stage, destination/source information k1 and a key material k2 in the case of the second stage) necessary for generating the symmetric key k to the symmetric key generation apparatus 1d. The symmetric key generation apparatus 1d generates a symmetric key k in compliance with the instruction and transmits it to the IPsec process unit 22 by way of the above noted connection. In the case of the first stage, a value of the key material k2 is also transmitted to the IPsec process unit 22. The IPsec process unit 22 encrypts or decrypts an IP packet based on the received symmetric key k (the received key material k2 is also used in the case of the first stage).

Also, the above description exemplifies the IPsec in compliance with the IPv4 as an example of applying the present invention to the IPsec; the present invention, however, is applicable also to the IPsec in compliance with the IPv6.

Also, the above description premises that the key material readout unit 13 increments the key material storage unit 12 by one (“l”), if it is a counter, in the first stage; this increment, however, may be a decrement instead, or incrementing/decrementing a value of the key material storage unit 12 by a predetermined number of “d” in stead of “1”.

What is claimed is:

1. A symmetric key generation apparatus generating a symmetric key used for a symmetric key cryptographic system, comprising:
a reception unit for receiving input data having a header part in a state of a cleartext and a payload part;
a key material storage unit for storing a key material;
a key material readout unit for reading the key material from the key material storage unit and updating the key material stored in the key material storage unit in a first stage of generating the symmetric key for encrypting the input data, and reading the key material from a predetermined part of the header part in a second stage of generating the symmetric key for decrypting the input data; and
a symmetric key generation unit for generating the symmetric key based on the key material read by the key material readout unit.

2. The symmetric key generation apparatus according to claim 1, wherein
said key material is a number, and
said key material is updated by said key material readout unit adding or subtracting by “1” in said first stage.

3. The symmetric key generation apparatus according to claim 1, wherein
said input data is a frame of a data link layer.

4. The symmetric key generation apparatus according to claim 3, further comprising
a judgment unit for judging as to which of a plurality of stages including said first stage, said second stage, or a third stage, in which a symmetric key needs not to be generated in correspondence with said frame, based on virtual local area network (VLAN) identifier information if said frame includes the VLAN identifier information identifying a VLAN.

5. The symmetric key generation apparatus according to claim 1, wherein
said input data is a packet in a network layer.

6. The symmetric key generation apparatus according to claim 5, wherein
said symmetric key is utilized as a symmetric key for an Internet Protocol security.

7. The symmetric key generation apparatus according to claim 1, further comprising
a judgment unit for judging as to which of a plurality of stages including said first stage or said second stage.

8. The symmetric key generation apparatus according to claim 7, wherein
said reception unit comprises a plurality of interfaces, and
said judgment unit judges based on whether the reception unit received said input data by way of either of the plurality of interfaces.

9. The symmetric key generation apparatus according to claim 1, further comprising
an encryption unit for generating encrypted output data having a second header part including said key material and a second payload part that is a result of encrypting said payload part of said input data based on said symmetric key in said first stage, and
a decryption unit for generating decrypted output data having a third payload part that is a result of decrypting the payload part of the input data based on the symmetric key in said second stage.

10. The symmetric key generation apparatus according to claim 1, wherein
said symmetric key generation unit generates said symmetric key by using a hash function.

11. The symmetric key generation apparatus according to claim 1, wherein
the symmetric key generation apparatus is placed on a telecommunication path,
said input data is received by said reception unit when the input data is transmitted by way of the symmetric key generation apparatus along the telecommunication path from a transmission source to a transmission destination, and
said symmetric key generation unit generates said symmetric key based on at least either of an address of the transmission source or transmission destination.

12. The symmetric key generation apparatus according to claim 1, wherein
two of the symmetric key generation apparatuses set up with the same value as a pre-shared key are placed on a telecommunication path,
said input data is transmitted from a transmission source to a transmission destination on said telecommunication path by way of the symmetric key generation apparatus on a transmission side and one on a reception side,
the input data is received by said respective reception units of the two symmetric key generation apparatuses when it is transmitted by way thereof, and
said respective symmetric key generation units of the two symmetric key generation apparatuses respectively generate said symmetric keys based on the pre-shared key.

13. The symmetric key generation apparatus according to claim 12, further comprising
a random value generation unit for generating a random value by giving a value to a random function as a seed, wherein
said value given as the seed is calculated based on said pre-shared key and a character string specified uniquely by firmware of the symmetric key generation apparatus,
said random function generates the same value from the same seed, and
said symmetric key generation unit generates the symmetric key based on the random value.

14. The symmetric key generation apparatus according to claim 12, further comprising
a hash value calculation unit for calculating a hash value by using a value as an argument of a hash function, wherein
said value used as the argument is calculated based on said pre-shared key and a character string specified uniquely by firmware of the symmetric key generation apparatus, and
said symmetric key generation unit generates said symmetric key based on the hash value.

15. The symmetric key generation apparatus according to claim 12, further comprising
a candidate value generation unit for generating M pieces of values as candidate values, where M is an integer equal to or larger than two (“2”), based on said pre-shared key, and
a candidate value storage unit for storing M pieces of the candidate values, wherein
said symmetric key generation unit selects one candidate value from among the M pieces thereof based on said key material, reads it from the candidate value storage unit, and generates said symmetric key based on the candidate value.

16. The symmetric key generation apparatus according to claim 15, wherein
said candidate value generation unit calculates a random value for each of M different pieces of index values, thereby generating M pieces of the candidate values,
the random value is calculated by giving a seed to a random function that generates the same value from the same seed, and
the seed is calculated based on a character string specified uniquely by firmware of the symmetric key generation apparatus, said pre-shared key and the index value.

17. The symmetric key generation apparatus according to claim 15, wherein
said candidate value generation unit calculates the candidate value for each of different M pieces of index values, thereby generating M pieces of said candidate values,
each candidate value is calculated by giving a value to a hash function as an argument, and
the value given to the hash function is calculated based on a character string specified uniquely by firmware of the symmetric key generation apparatus, said pre-shared key and the index value.

18. A symmetric key generation method for generating a symmetric key used for a symmetric key cryptographic system, comprising:
a reception step for receiving input data having a header part in a state of a cleartext and a payload part;
a key material readout step for reading the key material from a key material storage unit storing the key material and updating the key material stored in the key material storage unit in a first stage of generating the symmetric key for encrypting the input data, and reading the key material from a predetermined part of the header part in a second stage of generating the symmetric key for decrypting the input data; and
a symmetric key generation step for generating the symmetric key based on the read key material.
